(19) United States
(12) Patent Application Publication
(10) Pub. No.: US 2015/0199846 A1
(43) Pub. Date: Jul. 16, 2015

(54) Systems, Methods and Computer Program Products for Developing and Sharing an Ecological Vision For A Geographical Location

(71) Applicant: Wildlife Conservation Society, Bronx, NY (US)

(72) Inventors: Eric Wayne Sanderson, Bronx, NY (US); Kim Fisher, Astoria, NY (US)

(21) Appl. No.: 14/596,891

(22) Filed: Jan. 14, 2015

Related U.S. Application Data
(60) Provisional application No. 61/927,821, filed on Jan. 15, 2014.

(51) Int. Cl. G06T 17/05

(52) U.S. Cl. CPC G06T 17/05

(57) ABSTRACT

An ecosystem vision-making application includes a web server that delivers data from a database for a geographic model together with JavaScript scripts that implement the model, both being delivered to a JavaScript-enabled web browser on a client. Using tools defined by the vision-making application, vision parameters are defined for a vision applicable to a geographic location. Execution of the JavaScript scripts by the web browser enables calculation of an environmental performance indicator which includes metrics for ecologically significant performance indicators for the vision applied to the geographic location. Other performance metrics may be calculated, such as social metrics, economic metrics and livability metrics. These metrics may also be calculated for baseline visions and for visions from other users, thereby enabling comparison with the user-defined vision, and so as to provide for evaluation, change, improvement, commentary, distribution and sharing of the vision.

### CROSS REFERENCE TO RELATED APPLICATION

This application claims priority from U.S. Provisional Application No. 61/927,821, filed Jan. 15, 2014, the contents of which are incorporated by reference herein as if set forth in full.

### FIELD

The present disclosure relates to development, evaluation, and distribution of user-defined visions of ecosystem properties and other geographic properties such as lifestyle and climate properties, as applied to a geographic location such as a city, such as for use in environmentally conscious planning and development.

### BACKGROUND

There is increasing awareness of the need to modify land usage policies and lifestyles so as to obtain a more sustainable and beneficial environmental outcome, especially given a changing climate. For example, there is increasing awareness of the need to reduce carbon footprint, increase efficiency of water use, control runoff and waste production, adapt to increasingly severe weather patterns, and so forth.

### SUMMARY

Despite this increased awareness, few tools are available to land use and city planners, or to an informed citizenry, for evaluating the integrated impacts (positive or negative) of changes to land use, lifestyles and climate scenarios, for enabling comparisons of the advantages and disadvantages of one vision versus other visions, or for sharing those visions broadly over computer networks. As one example focusing on the ecological impact of land use in New York's Manhattan Island, development in a former inter-tidal zone in lower Manhattan created jobs and economic opportunity, but could subject people and property to risk during a severe storm event; whereas building taller buildings a few blocks further inland, together with a restoration of coastal ecosystems, might provide economic and ecosystem benefits while reducing storm-related risk.

Moreover, in geographic areas where current land use is diverse, such as contemporary large cities, it is also difficult to discern how changes to smaller areas, such as areas smaller than that of a typical city block, might effect an ecological impact on larger areas or on the city as whole. For example, it is often difficult to determine how the addition of one planted roof with vegetation (i.e., a “green roof”) might affect water flow dynamics of a city block or neighborhood.

These difficulties are compounded by the general inability of computer models to model diverse ecologies. For example, while some computer models might be adept at modeling natural ecosystems, those same computer models perform poorly on anthropogenic ecosystems, and vice versa.

The foregoing is addressed by the provision of tools for the development, evaluation, distribution and/or sharing of ecological visions. The tools may include an application data structure, a vision ecosystem data structure, raster painting tools and a calculation engine. These tools allow a user to define an ecological vision for proposed land use, to evaluate an environmental performance indicator (EPI) for the proposed ecological vision, and to modify and obtain feedback of the vision such as by referring to the EPI of one vision versus other visions or modification to the vision. The user is thus able to author an ecological vision, or to modify existing visions, and to compare and evaluate the EPI for one vision against that of another.

In addition, preferred embodiments are deployed in distributed network environments, allowing collaboration amongst users or amongst groups of users. The user may choose to share an authored vision with others over computer networks in a structured way. Collaborative efforts thus allow the benefit of crowd sourcing for fine-tuning of various visions, operating in particular use scenarios.

One aspect described herein involves development of an ecological vision for a geographic location, and calculation of evaluation metrics such as an environmental performance indicator for such a vision. A vision for the geographic area is defined, such as by selection and modification of a predefined vision for the geographic area, or by authoring a new vision. Based on the vision and a database of ecosystem data, an environmental performance indicator (EPI) for the vision is calculated, wherein the environmental performance indicator includes metrics for ecologically significant performance indications.

In addition to an environmental performance indicator (EPI) which includes metrics for ecologically significant performance indications, other metrics for the vision may also be calculated, evaluated and compared. For example, in some embodiments, there may be social metrics for socially significant performance indications such as population, population density and housing; economic metrics for economically significant performance indications such as commerce, job availability and income distribution; and livability metrics for significant performance indications relating to enjoyment, health and safety such as cultural diversity, artistic expression, public health, biodiversity, crime and social equity.

An ecological vision, as defined by a user, may include ecosystem properties for application to the geographic location, and may include other geographic properties for application to the geographic location. For example, in some embodiments, the vision may include lifestyle properties for the geographic location, such as urban versus suburban and high versus low conservation efforts, and/or may include climate properties such as climate change scenarios and precipitation events.

The geographic location may be a region, neighborhood, city, census metropolitan area (CMA), state or any recognizable location whose boundaries are definable, typically by topography, population or commerce.

The visions may be shared in a distributed network environment, and collaboration may be permitted in the definition of the vision. The vision may further be stored for future use and/or for retrieval in accordance with search query parameters.

The vision may include parameters for one or more of a geographic boundary, a distribution of ecosystems, lifestyle and climate scenarios. Tools may be provided for defining the geographic extent of the vision, the distribution of ecosystems within the vision, a selection of a lifestyle for the selected region, or a selection of climate scenarios.

The geographic extent of visions may be subdivided into working regions whose size may correspond roughly to that of a city block.

Tools may be provided for defining the nature of the ecosystem for each pixel of a selected region, such as tools for painting with landscapes, buildings and so forth, including modifications of existing ecosystems. These cells, once selected, may be modified on a cell-by-cell basis.

Environmental performance indicators (EPIs) and other performance metrics may be calculated based on any one or a combination of vision parameters and modified vision parameters associated with any one of a combination of a distribution of ecosystems, a distribution of ecosystem modifiers, a distribution of ecosystem number of stories, a lifestyle selection, a climate selection, and a precipitation event selected in thematic areas which currently include geography, water, carbon, biodiversity and population.

This brief summary has been provided so that the nature of this disclosure may be understood quickly. A more complete understanding can be obtained by reference to the following detailed description and to the attached drawings.

### BRIEF DESCRIPTION OF DRAWINGS

FIG. 1 is a representative view of a distributed networking environment applicable to one embodiment described herein.

FIG. 2 is a detailed block diagram showing internal architecture of computing equipment shown in FIG. 1.

FIG. 3 is a detailed block diagram showing internal architecture of a representative client shown in FIG. 1.

FIG. 4, comprising FIGS. 4A and 4B, is a view for explaining data stored in a database such as database 20 of FIG. 1.

FIG. 5 is a view for explaining pixel rendering within an area of interest, which in this case is a city-block-sized set of pixels.

FIG. 6 is a flow diagram for explaining pixel rendering and explains computations for each pixel in the view.

FIG. 7 is a view for explaining an example of calculating cell pixel sized dimensions based on geographic origin coordinates.

FIG. 8 is a view for explaining a dashboard display at a client machine for a user.

FIG. 9 is a flow diagram for explaining calculation of metrics for environmental performance indicators (EPIs) responsive to a user request for recalculation based on a user-defined ecological vision.

FIGS. 10 to 30 are examples of a user interface displayed on a display at a client machine, based on different usage scenarios by a user.

### DETAILED DESCRIPTION

### Overview

Described herein is a vision-making application that allows users to create, evaluate, and share plans (“visions”) for the environment of a geographic location. Integrated tools allow the user to create a vision, evaluate the vision and compare it against other visions, and share and collaborate on visions. The user's vision ordinarily would comprehend the environment and ecology of the geographic location, including aspects such as land use, lifestyle and climate scenarios.

A vision may be created by giving the user ecosystem “painting” tools that interact directly with data overlaid on a web map, changing cell-based raster values, which are tied to extensive parameterization of ecosystem properties; the user can also shape his/her vision by making choices from a set of pre-parameterized lifestyles, climate scenarios, and precipitation events.

A vision may be evaluated through an extensive and extensible set of metrics for the user's vision, as contrasted against alternative visions, including in some cases the current state of the site within the user's vision extent (the polygonal boundaries of the user's vision), historic versions of that site, and/or visions of other users. The metrics may include ecological metrics as well as other metrics by which a vision may be evaluated and compared, such as social metrics, economic metrics and livability metrics.

A vision may be shared by mechanisms to save, store, and enable sharing via the website and social media tools like Facebook and Google+.

The vision-making application combines a scientifically robust calculation or evaluation of metrics given a unified set of natural and anthropogenic ecosystems with the democratic, crowd-sourcing features of the Internet.

In one embodiment, an online forum enables the public to develop and share their own climate-resilient designs for geographic locations based on rapid and realistic model assessments of carbon, water, biodiversity and population, using stock and flux models. In the embodiment described herein, the geographic location is New York's Manhattan Island.

According to one aspect, users are invested with a sense of the geographic location's ecological self. That sense, and the sensibility that emerges from it, is necessary to engage the public in imagining a sustainable form of geographic locations like New York City over the long-term. The visions may be interpreted as an envisioned future for the geographic location, not necessarily meant as a literal date, but as a figurative point in the distant future, far enough away to free imaginations of short-term worries and constraints, but near enough to be relevant to the way people live today. The user chooses the time point to which his or her vision refers.

According to embodiments described herein, users are given a beautiful, data-driven, forum for democratic exploration and discovery focused on long-term sustainability. Sustainability has many aspects, including livability, economic vitality, cultural diversity, artistic expression, and environmental performance, all of which are expressed in various forms at different geographic locations today. Ecological performance in particular is a problem of many places, especially in contrast to the remarkable livability, vitality, diversity, and natural expression of historic ecology.

In many instances, nature has been depleted, disdained, and largely ignored by past generations. As such, many of our contemporary cities and other places have inherited a series of interconnected problems of ecological performance including, but not limited to, stormwater management; climate change adaptation and mitigation; brownfield remediation; air, water, noise, and soil pollution; invasive species and disease; and habitat deterioration and destruction. These ecological problems limit the quality of life while unaddressed and may have catastrophic future consequences, which is why millions of dollars per year is currently being spent to address them by public and private entities. In the case of New York, like other contemporary cities, the primary drivers of these changes are anticipated climate change, including sea level rise, and expected growth in population; the primary response to them will be changes in the physical structure of the city and the lifestyles of the city's residents. While daunting, these challenges are also a lens through which users may come to recognize and embrace the special ecology of each individual geographic location, such as New York's archipelago-like nature, thus opening new avenues for design, development, art, science, economy and sustainability.

It is easy to understand that the former landscape of many pre-colonial geographic locations, clothed in forests, wetlands, and streams, was a place where carbon cycled through, water flowed, and habitat was provided for a diverse set of species, including for people. Ecologically all these cycles have been modified but not extinguished by the modern form of the city, but city form and the urban lifestyle focused elsewhere have made these aspects of city life less visible to the public at large than they might be. Hence, one aspect described herein makes these aspects visible.

Like in other geographic locations, these attributes are multi-dimensional, expressed over different spatial scales and temporal lags, influenced by climate change, and are affected by human activities, including both the distribution of ecosystems and lifestyle decisions; as such, the embodiment herein responds to the same factors too. Having focused attention on these ecosystem cycles, a further aspect teaches how ecology works in an urban setting, taking as a whiteboard the city-sized blocks where people live and work. Through data, maps, and clarity, a further aspect is obtained: to unleash the creativity of an informed citizenry and city planners alike, in designing novel and sustainable visions for geographic locations in the future.

A main audience for users is currently thought to be segmentable into three focal groups: those who are actively involved in developing geographic locations (architects, designers, urban farmers, green roof purchasers, park advocates, etc.); those who will live in the geographic locality in the future (particularly school children and their teachers, but also university students and informal science learners); and residents in general who love their home and want to see it last. A fourth, implicit audience is the local government experts and officials who manage geographic locations, such as (in the case of New York City) the Office of Long Term Planning and Sustainability, and also the various city managers in the Departments of City Planning, Transportation, Health and Human Services, Housing, Education, Emergency Preparedness, and others. Users are provided with tools to do their jobs more efficiently, while collecting data which will help them have constructive dialogues with the public.

In one example embodiment, the ecological vision-making application described herein includes a website for which the server is based on the Django Python framework, backed by a PostGIS-enabled PostgreSQL database. Parameter and entity values and application data are stored in a suite of parameter value tables and written to a data file that is downloaded with the rest of the HTML, cascading style sheets (css), images, and JavaScript on application initialization. Data for parameters, vision and metrics such as the environmental performance indicator metric (EPI, which is the results of calculations on a particular vision) are retrieved from the server database as GeoJSON via API calls. The application itself may be JavaScript-based and may run in the user's HTML5-compliant browser client. Sections below elaborate on the application data structure, vision ecosystem data structure, raster painting, and calculation engine.

The website for the vision-making application includes a web map that allows users to draw or paint a vision of a geographic location on top of current street/building and satellite data, and to compare the calculated consequences of that vision in terms of carbon, water, population, and biodiversity to conditions in comparison or baseline visions, such as a first baseline vision depicting a pre-colonial or development set of natural ecosystems, and a second baseline vision depicting current anthropogenic ecosystems (i.e., a “today” view). Comparisons may also be made as against visions of other users. User visions can be saved and shared on the website; additional links will enable sharing through social media. Additional areas of the website will provide support and context for the web map including a home page, account/profile maintenance area, vision search/browse, explanation/documentation areas, curriculum, contact and acknowledgments.

The atomic unit of user interaction and analysis in this embodiment is city-block-sized, preferably corresponding to contemporary boundaries defined by actual city blocks. Blocks may be defined using the centerlines of the streets, or in parks and waterways, through arbitrary subdivision (e.g. welikia.org/explorer). The user can work with as many blocks in one vision as he or she likes; these multiple blocks allow the user to investigate solutions at different spatial scales. In one embodiment the interface includes a feature to measure the carbon, water, biodiversity, and population characteristics of an individual block, a set of blocks, or an extrapolation to larger geographic regions, such as an extrapolation from a vision encompassing a few city blocks in Manhattan to Manhattan as a whole.

Users can interact with the map interface in multiple ways including: by changing the ecosystems on the map; by choosing from a pre-defined set of lifestyle scenarios; and by choosing from a pre-defined set of climate scenarios and precipitation events. The combination of the map, the lifestyle and climate and precipitation events will provide all the parameters by which the vision-making application makes calculations (described below) of metrics by which the vision may be evaluated and compared. In this embodiment, these calculations are made responsive to a command from the user, for calculation of metrics which may include metrics for population, carbon, water, and biodiversity.

The term “ecosystem” is used broadly in this case: it includes buildings, streets, sidewalks, utility yards, parks, agriculture, and green roofs, as well as forests, wetlands, beaches, and estuary waters. One example list of ecosystems provided is given in Table 1. In this embodiment, ecosystems are mapped on a 100 m² grid (10 m cells), which provides 40-60 grid cells for most blocks in Manhattan. Historic ecosystems are mapped for the pre-European island based on the Mannahatta Project data (Sanderson 2009) and for the current city from the Map-PLUTO database (Department of City Planning, 2012) and numerous other data layers on the same grid. As the user changes the map by painting ecosystems, the website measures the areal changes in ecosystem extent within an area of interest. The area of interest in this embodiment is the block, set of blocks, or Manhattan as a whole, as selected by the user on the interface.

TABLE 1
Ecosystem types

| Ecosystems - | Ecosystems - | Ecosystems - | Ecosystems - |
|---|---|---|---|
| Nature's | Buildings | Transportation | Others |
| Estuary | Cottages/Mobile home | Sidewalk | Camp |
| Beach | Single family home\hat{ } | Alley | Agricultural field/ |
| | | | vegetable garden |
| Salt marsh | Apartment building\hat{ } | Street (collector) | Orchard |
| Freshwater marsh | Retail building\hat{ } | Boulevard (arterial) | Ornamental garden |
| Hardwood swamp | Office building\hat{ } | Highway | Grass/lawn |
| Pond | Mixed use: retail/ | Traffic Slowed street | Outdoor pool |
| | residential building\hat{ } | | |
| Disturbed Land | Mixed use: retail/ | Pedestrian street/plaza | Paved ball field/court |
| | office building\hat{ } | | |
| Meadow | Hotel\hat{ } | Elevated train | Cemetery |
| Shrub land | Hospital\hat{ } | Streetcar line | Water treatment plant |
| Oak hickory forest | School or university\hat{ } | Subway | Sewage treatment plant |
| Hemlock - northern | Factory\hat{ } | Parking lot | Solid waste transfer plant |
| hardwood forest | | | |
| Cliffs and rock | Public assembly hall\hat{ } | Airfield | Waste energy power plant |
| outcrops* | | | |
| Trail* | Warehouse\hat{ } | Light rail line | Natural gas power plant |
| Stream* | Computer data center\hat{ } | Train line | Diesel power plant |
| Eelgrass meadow* | Greenhouse\hat{ } | Bike share* | Wind farm |
| Oyster bed* | Garage\hat{ } | Street trees* | Tidal energy facility |
| | Stadium\hat{ } | Bike lane* | Solar energy facility |
| | Cistern* | | Steam generation plant |
| | Graywater recycling* | | Landfill |
| | Green roof* | | Utility yard |
| | PV solar panels* | | Gas station |
| | Solar heating panels* | | Compost bin* |
| | Geothermal pump* | | Pier* |

Footnotes to Table 1:
*Ecosystem modifiers. These ecosystem types cannot be used on their own; they are used only to modify selected other ecosystems, such as buildings (in the case of green roofs, solar panels and cisterns), sidewalks (in the case of bike share and street trees), or upland natural ecosystems (in the case of trails.) See Appendix 13 for more details.
\hat{ }Floor-to-area ratio controllable by user via “number of stories” field

Users also choose a lifestyle (Table 2). Lifestyle choices reflect how the way people live in the city influences ecosystem cycles of population, carbon, water, and biodiversity. For example, lifestyle choices affect how much food a person eats, the amount of space required per person, the number of trips taken by various modes of transportation, and fuel sources consumed to generate electricity. Some of these lifestyle choices reflect personal, individualized choices; others are choices made collectively at as social groups, typically reflecting policy decisions made by governments or other large institutions (e.g. power companies, transportation agencies and so forth).

TABLE 2
Lifestyle profiles
Lifestyle profiles

Lenape Person
Average New Yorker
Average American
No-Impact Man/Woman
Average Earthling

Climate scenarios (Table 3) are defined by scientific predictions of future climate states, and in this embodiment they are derived from Horton et al. 2009. They include a baseline climate scenario, as well as historical climatic conditions and climatic predictions for various time points. In embodiments described herein these points in time include 1609, 2000, 2020, 2050 and 2080. The climate scenario defines changes in mean annual temperature, precipitation, and mean sea level. A dotted line on the user interface may be used to show the location of the projected mean sea level for different climate scenarios as relevant to the geographic location in question. In this embodiment, these future sea level lines are derived from Lin et al. 2012 and New York State Sea Level Rise Task Force (2010).

TABLE 3
Climate scenarios
Climate scenarios

Past Climate 1859-1970
Past Climate 1970-2010
Future Climate in 2020s
Future Climate in 2050s
Future Climate in 2080s
Footnote for Table 3: Based on Horton et al. (2009) and Central Park weather record

A user selection of one or more blocks opens a dashboard window that provides estimates of quantified metrics such as metrics for an environmental performance indicator (EPI), social metrics and livability metrics. In this embodiment, the metrics may include the cycles of population, carbon, water, and biodiversity. These metrics are listed in Appendix 1 and the methods for calculating them are described below, in the section labeled “Quantitative Methods”. Parameters are listed in Appendix 2. As the user makes changes to the ecosystems in the map view, or selects different climate scenarios or lifestyle profiles, the dashboard updates the metrics and displays the updated metrics to the user. The metrics of the user's vision are displayed in contrast against a display of metrics for the same area in the afore-mentioned pair of baseline visions, i.e., first baseline vision depicting a pre-colonial or development set of natural ecosystems, and a second baseline vision depicting current anthropogenic ecosystems (i.e., a “today” view). A display may also be made for comparison as against metrics for visions of other users. In the top-level dashboard, users can select metrics they want to see for the performance indicators they are investigating: as one non-limiting example, the carbon flux in tons of carbon per year, water balance in thousands of gallons per year, number of species, etc. Double-clicking on any metric will open another window that shows details of inputs and outputs and other contextual information to understand the flows.

Sometimes users may attempt changes that the interface allows, but which will have dramatic consequences for one or more of the metrics. In a selected set of cases, these changes may trigger notifications to the users, such as “think again” alerts in the mapping window.

After manipulating the map, users will be able to save and name their visions and give permission (or not) for their visions to be shared with others. Users will be able to browse visions of other users and share their idea or comments on others via integrated support for social media, such as Facebook and Google+.

Although certain aspects of the disclosure herein might appear to bear superficial resemblance to games built around city design (such as Sim City), they are nevertheless distinctly different. By virtue of the contribution made by this disclosure, various embodiments constructed in accordance with this disclosure reveal data and approach, linked to actions made by the user, thereby revealing the fascinating structure of the geographic location through data, depth, clarity, and democratic exploration.

### <Architecture>

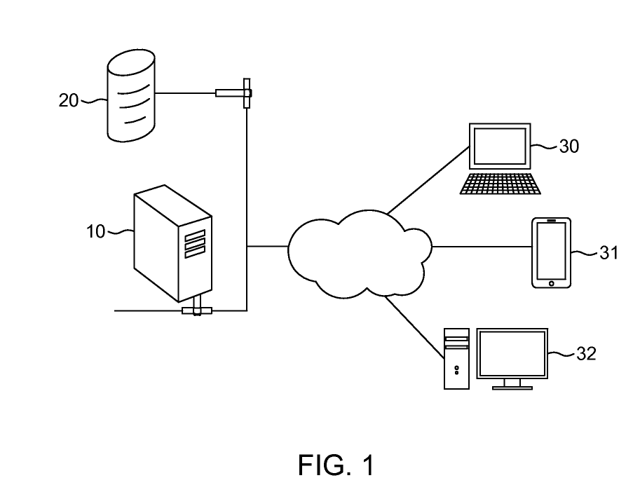

FIG. 1 is a representative view of a distributed networking environment applicable to one embodiment described herein. As seen in FIG. 1, computing equipment 10 hosts an ecosystem vision-making application, and includes a network interface to a networked database 20. In general, database 20 stores various ecological visions, model entities and parameter values, organized as tables, such as model entities for lifestyle, climate and precipitation events, and parameters such as climate, lifestyle and ecosystem, as described in more detail below.

Computing machine 10 may in some embodiments include a display screen, a keyboard for entering text data and user commands, a pointing device, and so forth, although such equipment may be omitted.

Multiple clients such as clients 30, 31 and 32 interface to computing machine 10 via a network such as the Internet. Each of the multiple clients includes a JavaScript-enabled web browser for accessing computing machine 10 via a uniform resource locator (URL), and for receiving web page information from computing machine 10 in hypertext transport markup language (HTML) and JavaScript Object Notation (JSON), using a hypertext transport protocol (HTTP).

The architecture in this example embodiment includes wired and wireless network interfaces for a distributed networking environment. It will be understood that other embodiments contemplated herein include embodiments having cloud storage for storage of data, and/or cloud hosting for hosting of application programs and execution thereof.

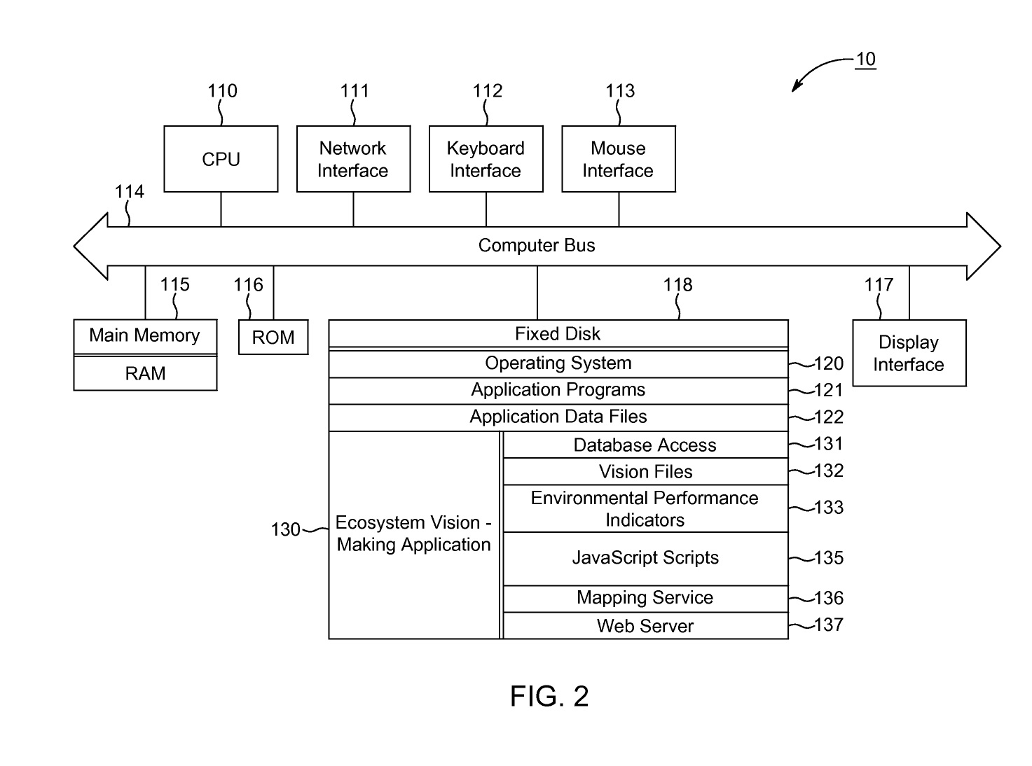

FIG. 2 is a detailed block diagram showing internal architecture of server-side computing equipment 10. As shown in FIG. 2, server-side computing equipment 10 includes central processing unit (CPU) 110 which interfaces with computer bus 114. Also interfaced with computer bus 114 are network interface 111 for interface to networked devices such as database 20, keyboard interface 112 and mouse interface 113 (if required), random access memory (RAM) 115, read only memory (ROM) 116, display interface 117, and fixed disk 118. RAM 115 interfaces with computer bus 114 so as to provide information stored in RAM 115 to CPU 110 during execution of instructions in a computer software product such as an operating system, application programs, and so forth. More specifically, CPU 110 first loads computer-executable process steps from fixed disk 118 or other non-transitory storage device into a region of RAM 115. CPU 110 then executes the stored process steps from RAM 115 in order to execute such process steps.

Fixed disk 118 shown in FIG. 2 is one example of a non-transitory computer-readable memory medium which stores computer-executable process steps in the form of computer program products. Computer-executable process steps stored on fixed disk 118 include an operating system 120, and application programs 121 which rely on application data files 122 for execution parameters and output of data.

In one example embodiment, fixed disk 118 stores a computer program product for the server side of an ecosystem vision-making application 130, containing computer-executable process steps. The ecosystem vision-making application includes multiple modules including modules for database access 131, files 132 for visions created by users, environmental performance indicators (EPI) 133 and other performance metrics calculated in correspondence to user visions, JavaScript scripts for delivery to client-side web browsers, mapping service 136 and web server 137. With respect to module 131 for database access, database 20 is accessed via network interface 111, which may reside on a separate server instance such as an Amazon RDS instance.

In other embodiments, the server-side of the vision-making application may use one Amazon Machine Instance (AMI) for the application and web servers, and one AMI for the database. In such an embodiment, there may be no actual physical entities with interfaces such as a keyboard interface and so forth. The AMI architecture allows for all or many of such entities to be virtualized. Other embodiments may be implemented with traditional hardware as depicted herein or as a mixture of traditional hardware and virtualized hardware. It should also be understood that similar alternates may be available on the client side of the vision-making application. In addition, embodiments may also be constructed in which the client side and/or the server side are virtualized or in which the client side and/or the server side are implemented with distributed or grid computing.

The modules shown in Figure are described in greater detail below.

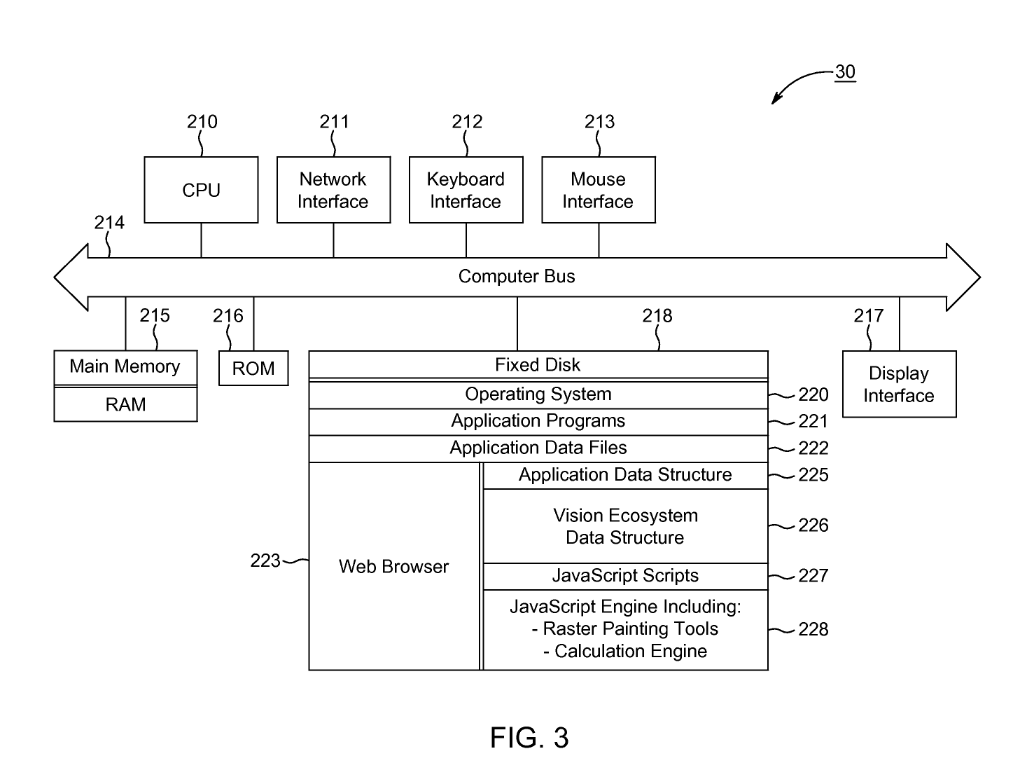

FIG. 3 is a detailed block diagram showing the internal architecture of a representative client, here, client 30. As shown in FIG. 3, client 30 includes CPU 210, network interface 211, keyboard interface 212 and mouse interface 213, all interfaced to computer bus 214. Also interfaced to computer bus 214 are RAM 215, ROM 216, display interface 217 and fixed disk 218. Fixed disk 218 is one example of non-transitory computer readable storage medium which stores computer program products in the form of computer-executable process steps, such as process steps for an operating system 220 or application programs 221 with associated application data files 222. Fixed disk 218 further stores computer-executable process steps for a JavaScript-enabled web browser 223, which receives data from web server 137 of server-side computing equipment 10. The data received from computing equipment 10 includes data for application data structure 225, data for vision ecosystem data structure 226, and JavaScript scripts 227. A JavaScript engine 228 executes the JavaScript scripts received from the server side of the vision-making application, so as to implement various aspects of the vision-making application, such as raster painting tools and a calculation engine for calculating metrics such as environmental performance indicators (EPIs) for display to the user and for storage on the server. On the client side whenever the user commits a change to the vision, those changes are transmitted back to the server in JSON form for storage and retrieval later. These features are discussed in greater detail below.

### <Application Data Structure>

The database 20 maintains a separate table for each entity, defined as an object by which a parameter (defined in a parameter table) varies. Parameter values are stored in tables corresponding to the number of axes represented by the relevant entities; for example, the parameter “vehicle occupancy” varies by the entities “transportmode” and “lifestyle”:

These data are stored in the database in tables with a consistent naming convention; for example, ‘p_transportmode_lifestyle’ holds a value for every possible combination of entities from ‘e_transportmode’ and ‘e_lifestyle’.

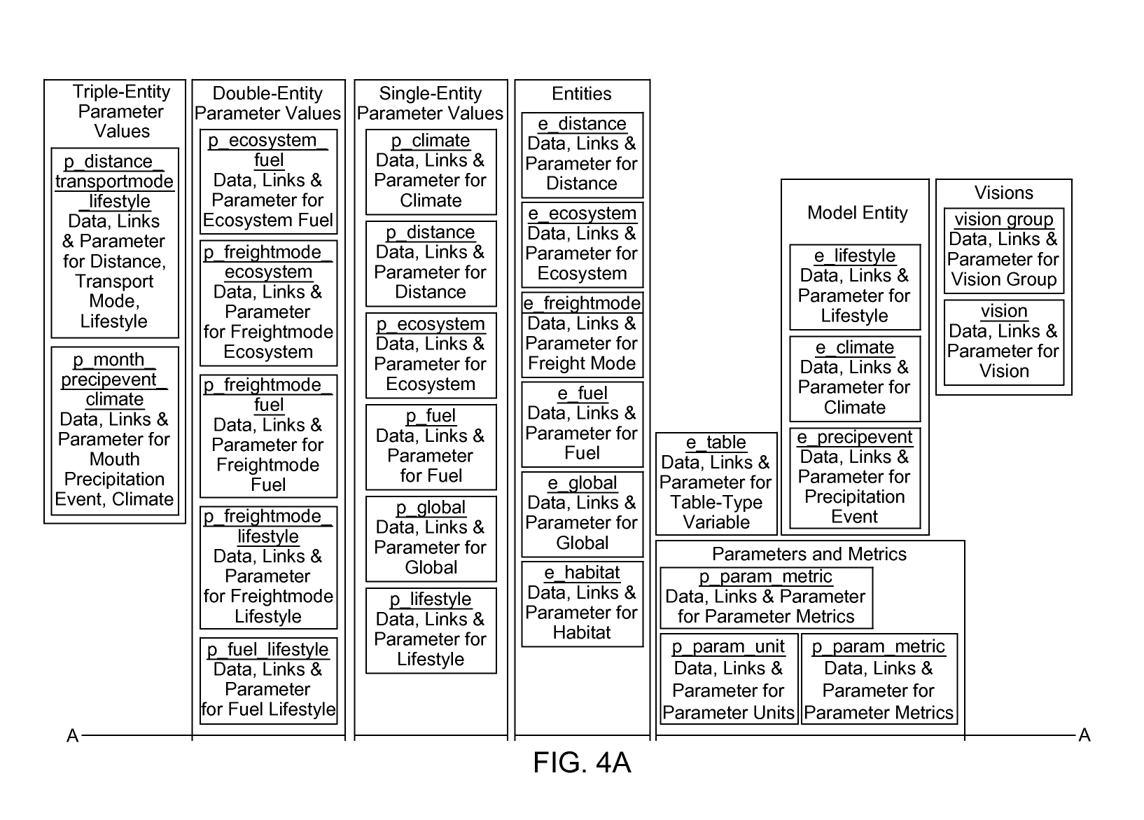

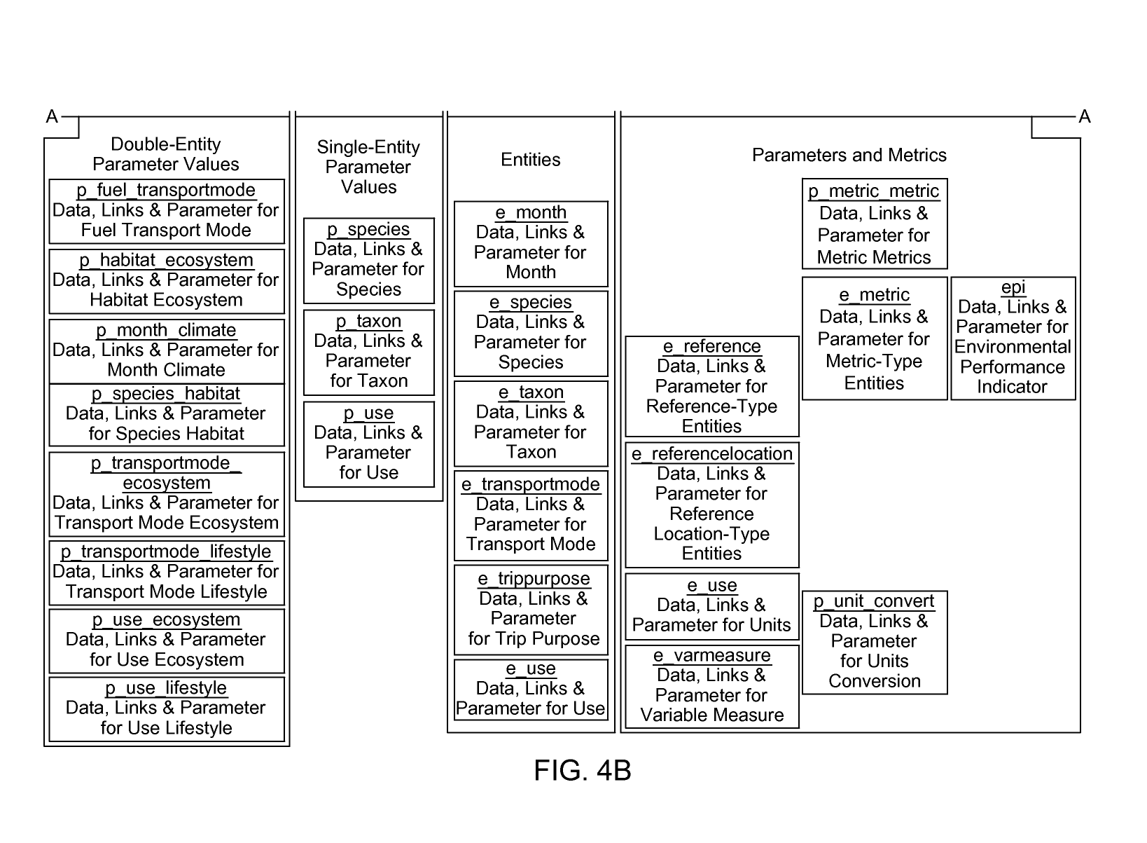

A simplified view of the full database structure is depicted in FIG. 4, and a more complete view is seen in the afore-mentioned U.S. Provisional Patent Application No. 61/927,821, which is incorporated by reference herein. As seen in FIG. 4, the database structure includes collections for Visions, Model Entities, Parameters and Metrics, Entities, Single-entity parameter values, Double-entity parameter values, and Triple-entity parameter values. The Visions collection includes Vision_Group and Vision, which respectively include data, links and parameters for vision groups and for each individual vision. The methods and equations described below, in the section on Quantitative Methods, use these Model Entities, Entities, and combinations of Single-entity parameter values, Double-entity parameter values, and Triple-entity parameter values in the equations to estimate Metrics.

The Model Entities collection includes e_lifestyle, e_climate, e_precipevent, which respectively include data, links and parameters for lifestyle, climate and precipitation events.

The Parameters and Metrics collection includes base forms for parameters and metrics, as well as conversion between units, such as p_param_metric, p_param_unit, p_unit_convert, which respectively include data, links and parameters for parameter metrics, units and units conversion

The Entities collection includes e_distance, e_ecosystem, e_freightmode, e_fuel, e_global, e_habitat, e_month, e_species, e_taxon, e_transportmode, e_trippurpose, e_use, which respectively include data, links and parameters for distance, ecosystem, freight mode, fuel, global, habitat, month, species, taxa, transport mode, trip purpose and use.

Parameter values include parameter values for collections of Single-entity parameter values, Double entity parameter values and Triple-entity parameter values. The collection for Single-entity parameter values includes p_climate, p_distance, p_ecosystem, p_fuel, p_global, p_lifestyle, p_species, p_taxon, p_use, which respectively include data, links and parameters for climate, distance, ecosystem, fuel, global, lifestyle, species, taxa and use.

The collection for Double-entity parameter values includes parameter values for p_ecosystem_fuel, p_freightmode_ecosystem, p_freightmode_fuel, p_freightmode_lifestyle, freightmode lifestyle, p_fuel_lifestyle, p_fuel_transportmode, p_habitat_ecosystem, p_month_climate, p_species_habitat, p_transportmode_ecosystem, p_transportmode_lifestyle, p_use_ecosystem, p_use_lifestyle, which respectively include data, links and parameters for the doublets of [ecosystem fuel], [freightmode ecosystem], [freightmode fuel], [freightmode lifestyle], [fuel lifestyle], [fuel transportmode], [habitat ecosystem], [month climate], [species habitat], [transportmode ecosystem], [transportmode lifestyle], [use ecosystem] and [use lifestyle].

The collection for Triple-entity parameter values includes parameter values for p_distance_transportmode_lifestyle, p_month_precipevent_climate, which respectively include data, links and parameters for the triplets of [distance, transport mode, lifestyle] and [month, precipitation event, climate].

### <Vision Ecosystem Data Structure>

Vision properties are stored as columns in the vision database table, with string, numeric, and polygon data types holding name, foreign key, geographic origin, and vision extent data. The val column is a string holding a comma-separated JavaScript-valid array of cell definitions, where each cell is represented as either:

0: represents no cell value of any kind (null)

An integer: represents an ecosystem, with 1 story (FAR, or Floor-to-Area Ratio,=1), and no modifiers.

Example: [15] represents->base ecosystem=15; FAR=1; no modifiers

An array with two integers: represents an ecosystem and its FAR.

Example: [15, 2] represents->base ecosystem=15; FAR=2; no modifiers

An array consisting of an integer and an array of an arbitrary number of integers: represents an ecosystem, a FAR of 1, and a set of modifiers.

Example: [15,[3,7]] represents->base ecosystem=15; FAR=1; 2 modifiers (3 and 7)

An array consisting of two integers followed by an array of an arbitrary number of integers: represents an ecosystem, its FAR, and a set of modifiers.

Example: [15,2,[3,7]] represents->base ecosystem=15; FAR=2; 2 modifiers (3 and 7)

This data structure avoids the overhead associated with complex spatial data types, compresses well, and requires no translation or evaluation for consumption as JavaScript by the client application. The all-island Manhattan vision, most of which is the cell values, represents ˜12.5 MB of data uncompressed, but only ˜681 KB on disk. A full but small example of vision data as it is sent to the client in GeoJSON form, including its ecosystem cell values, follows:

{“id_vision”: 5448, “ide_climate”: 2, “ide_precipevent”: 1, “year”: 2013, “valxmin”: −8234444.744257766, “id_user”: 1, “name”: “2010: 63rd St & 64th St between Madison Ave & 5th Ave”, “ide_lifestyle”: 2, “col”: 24, “geom”: {“rings”: [[[−8234383.73595574, 4978092.5977229], [−8234435.0410489, 4978000.4657795], [−8234257.3819678, 4977901.59734495], [−8234206.92849366, 4977993.60687546], [−8234383.73595574, 4978092.5977229]]], “spatialReference”: {“wkid”: 102100}}, “descrip”: “None”, “valymax”: 4978094.231826613, “public”: true, “block”: [2411], “var”:[0,0,0,0,0,0,41,0,0,0,0,0,0,0,0,0,0,0,0,0,0,0,0,0,0,0,0,0,0,41,41,40,0,0,0,0,0,0,0,0,0,0, 0,0,0,0,0,0,0,0,0,0,0,41,[54,[53]],54,40,40,0,0,0,0,0,0,0,0,0,0,0,0,0,0,0,0,0,0,41,54,[19,23],[19,6],[19,6],[54,[53]],40,[40,[53]],0,0,0,0,0,0,0,0,0,0,0,0,0,0,0,0,[41,[53]],54,[19,23],[19,2 3],[19,6],[19,6],[19,6],54,40,40,0,0,0,0,0,0,0,0,0,0,0,0,0,41,54,[19,23],[19,23],[19,23],[19, 23],45,45,[19,5],54,[54,[53]],40,40,0,0,0,0,0,0,0,0,0,0,0,41,54,[19,13],[19,23],[19,23],[19, 23],45,[19,5],[19,5],[19,5],[18,4],54,54,40,0,0,0,0,0,0,0,0,0,41,54,[19,13],[19,13],[19,13],4 5,45,45,[19,5],[19,5],[18,5],[19,4],[19,4],[18,5],54,[54,[53]],[40,[53]],0,0,0,0,0,0,41,[54,[5 3]],54,[19,13],[19,13],[19,13],[19,13],45,[19,4],[19,5],[18,5,[53]],[19,4],[19,4],[18,5],[19,4],[18,4],[18,4],54,40,40,0,0,0,0,[41,[48]],[54,[48]],54,[19,13],[19,13],45,45,45,[19,4],[19,6],[45,[53]],45,45,[18,5],[19,4],[18,4],[18,4],[21,6],54,54,40,40,0,0,0,0,[40,[48,53]],54,[19, 13,[53]],[19,13],45,[19,4],[19,6],[19,6],[45,[53]],45,45,[19,4],[18,4],[18,4],[21,6],[21,4],[2 1,3],[21,3],54,41,41,0,0,0,0,0,[40,[48]],[54,[53]],54,[19,4],[19,6],[18,5],[19,5],[28,4],[28,4],[19,5],[18,4],[18,4,[53]],[21,6,[53]],[21,4],[21,3],[21,3],54,41,0,0,0,0,0,0,0,0,[54,[48]],[54,[53]],[19,5],[18,5],[19,5],[28,4],[28,4],[19,5],[19,5],45,45,[20,6],[20,6],54,41,0,0,0,0,0,0, 0,0,0,0,[40,[48]],[54,[48,53]],54,[28,4],[28,4],[19,5],[19,5],[19,5],45,[20,4],[20,4],[20,6],[54,[53]],41,0,0,0,0,0,0,0,0,0,0,0,0,[40,[48]],[54,[48]],[28,4],[19,5],[19,5],[21,5],45,[19,5],[1 9,5],[20,4],41,0,0,0,0,0,0,0,0,0,0,0,0,0,0,0,[40,[48,53]],54,[19,5],[21,5],[20,5],[20,5],[20,5],[54,[53]],41,0,0,0,0,0,0,0,0,0,0,0,0,0,0,0,0,0,[40,[48,53]],54,[20,5],[20,5],[54,[53]],41,0,0, 0,0,0,0,0,0,0,0,0,0,0,0,0,0,0,0,0,0,[54,[48]],54,[54,[53]],41,0,0,0,0,0,0,0,0,0,0,0,0,0,0,0,0,0, 0,0,0,0,[40,[48]],[41,[48]],0,0,0,0,0,0,0,0,0,0,0,0,0,0,0,0,0,0,0,0,0,0,0,0,0,0,0,0,0]}

The ecosystem cells of a vision are maintained in this JavaScript array by the client application. The ‘col’ attribute defines the number of columns in the vision, allowing the application to break up the single array into rows and columns that can be rendered as 10m cells on a map.

### <Raster Painting>

One feature of the ecosystem vision-building application on the client-side is a web map built on the ESRI JavaScript API. In some embodiments, it might be preferable to configure the web map such that the only web traditional map service consumed directly is that of the ESRI world imagery base layer. Shorelines, blocks, and vision extents are rendered from GeoJSON passed to the client either on application initialization or when a new vision is loaded.

Vision ecosystem values are rendered in the map by dividing the HTML5 canvas element into square cells with screen pixel dimensions as close to 10 m×10 m as possible, and filling each cell with a color or png image corresponding to its position in the JavaScript vision array described above. This is a radically different way of rendering raster imagery in a web map client than the traditional tiled map service, which often sends 256 px×256 px png images appropriate to the map's extent and zoom level.

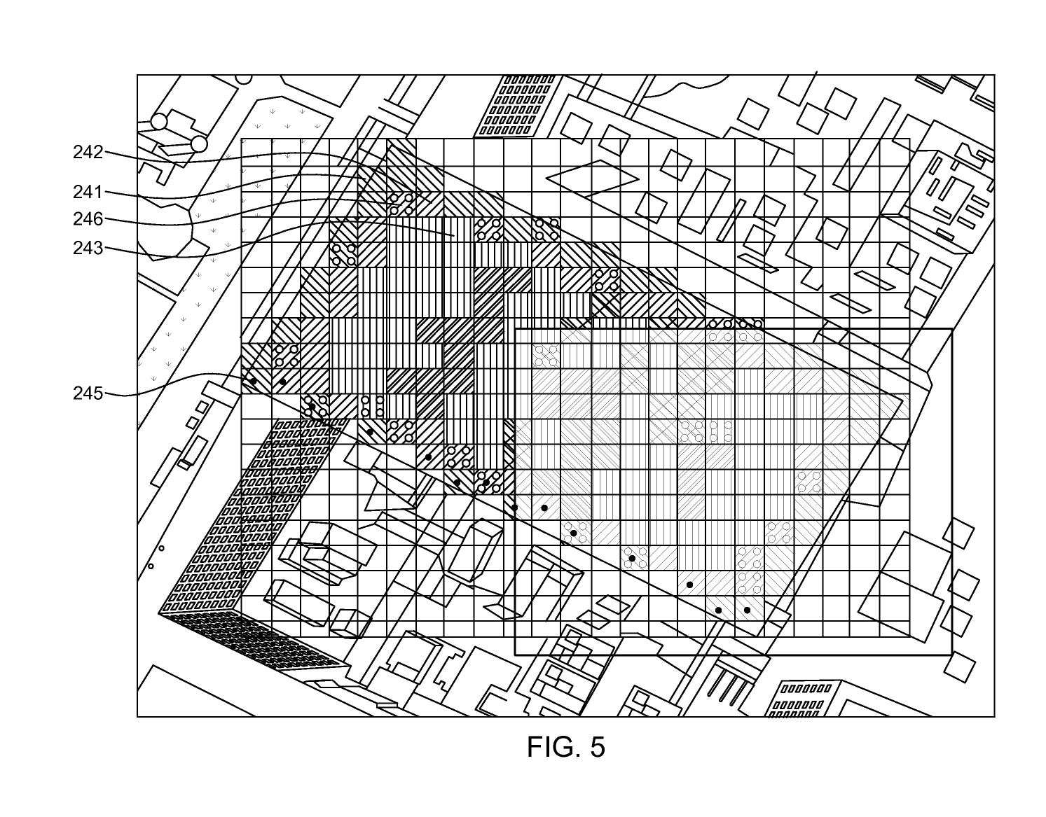

By contrast, in this embodiment of the ecosystem vision-making application, the client side separately renders each 10 m×10 m cell with its own color or image, positioned correctly in geographic space relative to the user's map extent, as shown in FIG. 5.

In more detail, FIG. 5 is a view for explaining pixel rendering within an area of interest, which in this case is a city-block-sized set of pixels. As seen in FIG. 5, each cell of the superimposed grid represents a 10 m×10 m cell in the geographic region of a city block. Each cell is painted with its own color or icon-based image representing the content of the cell, with the cells as a group being superimposed over the corresponding ESRI world imagery base layer.

Examples of the color or icon-based image include cross-hatching 241 for an indication of a street or arterial boulevard, cross-hatching 242 for an indication of a sidewalk or pedestrian walkway, and cross-hatching 243 for an indication of an apartment building or multi-story residential structure. Other colors or icon-based images may be used, such as colors or icon-based images for indicating multi-story commercial structures, grass, trees, parks, pedestrian plazas and so forth.

In addition to the color or icon-based image, each cell might include a color or icon-based image for a modifier to the basic content of the cell. As an example, cell 245 includes cross-hatching designating it as a street or arterial boulevard, but also includes a single dot pattern indicating that the street is modified by a bicycle path. As a further example, cell 246 includes cross-hatching designating it as a sidewalk or pedestrian walkway, but it also includes a quartet of open dots indicating that the sidewalk or pedestrian walkway is modified by trees.

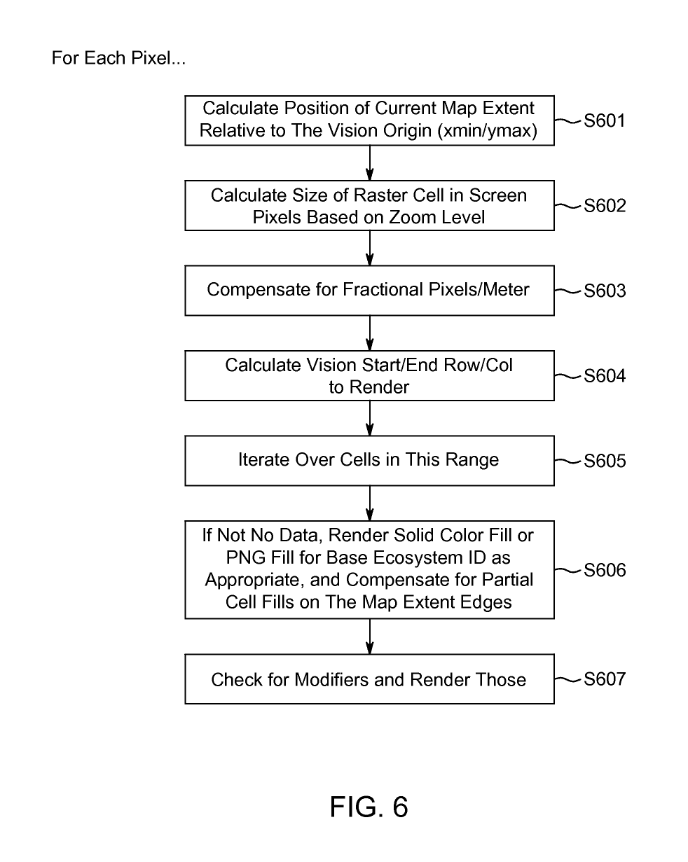

FIG. 6 is a flow diagram for explaining pixel rendering and explains computations for each pixel in the view. The raster rendering and painting sequence is, for each cell, commenced in step S601 in which the position of the current map extent is calculated relative to the vision origin (xmin/ymax). In step S602, the size of raster cell in screen pixels is calculated based on zoom level, which may be selected by the user. Step S603 compensates for fractional pixels/meter, and step S604 calculates the starting and ending rows and columns of the vision for which rendering is being performed.

Step S605 iterates over cells in this range. In particular, as seen in step S606, if not NO DATA for the current cell, a solid color fill or png fill is rendered for base ecosystem ID as appropriate, and partial cell fills are compensated for on the map extent edges. Step 607 checks for any modifiers and if modifiers are found, these modifiers are likewise rendered.

Thus, as understood from FIG. 6, the ecosystem vision-making application of this embodiment works with the vision cell value data structure, maintains a precise 10 m×10 m cell size, and it inserts modifier png images on top of base ecosystems (i.e. in the same cell). Furthermore, it keeps track of each cell's value and adds startPainting( ) and stopPainting( ) methods, which allows each cell to be rendered individually in response to the user's mouseOver event, and changes that cell's definition in the vision JSON object as the user paints.

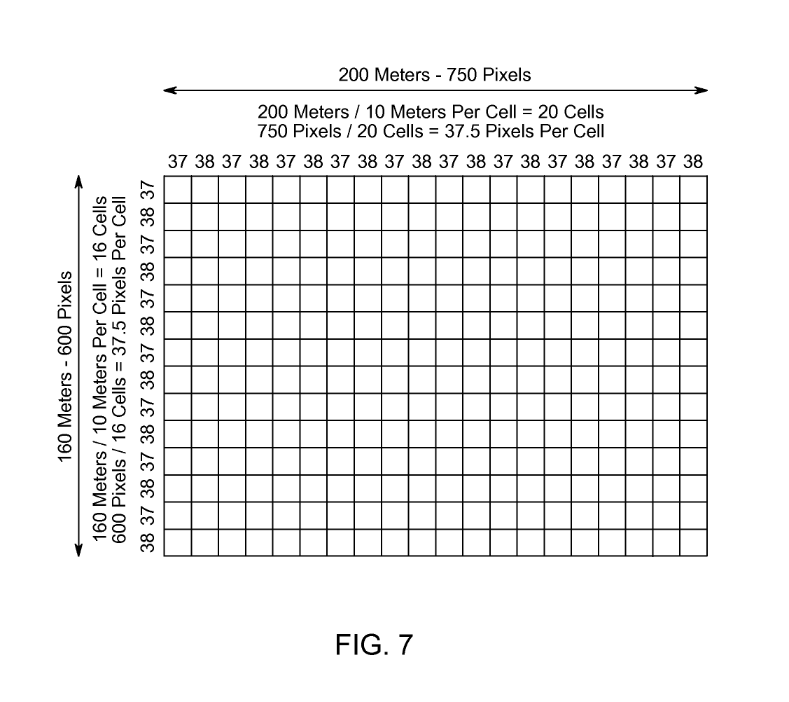

FIG. 7 is a view for explaining calculation of cell pixel sized dimensions based on geographic origin coordinates. As shown in FIG. 7, cell size pixel dimensions are calculated from geographic origin coordinates in 10 m increments, given a map size (in this example) of 750 px×600 px, represented by 20 cells×16 cells. Since these dimensions are intended to convey an actual surface area of 200 meters×160 meters, it will be seen that simple division would result in a situation where each cell would inconveniently include a fractional number of pixels, for example, 750 pixels/20 cells=37.5 pixels per cell. to avoid this inconvenient situation, the fractional part for each cell can be added to a next subsequent cell, resulting in this example in a pattern of cells represented by 37, 38, 37, 38, 37, 38, 37 . . . pixels per cell.

Below zoom level 17 (i.e. zoomed out too far), there are too many cells to render on a typical maximized browser on a 1920 px×1080 px monitor, and just below that, 10 m×10 m cells become smaller than screen pixels. To address these issues, at these zoom levels the application renders png image overlays created from the cell values, rather than the cells themselves. These images are regenerated every time the vision is saved to the server, such as by using an imaging library such as PIL (Python Image Library) or a PIL fork such as Pillow.

Thus, by use of the painting tools provided to the user, the user is able to develop an ecological vision for a geographic location, by defining vision parameters for the geographic location, such as on a cell-by-cell basis, starting with a blank vision, a baseline vision, or another user's vision. Thereafter, the user can cause calculation of metrics for the vision, based on the vision parameters and based on a database of ecosystem data, thereby allowing the user or other users to evaluate, change, improve, comment on, distribute and share the vision. Calculation of metrics is described in the following section.

### <Calculation Engine>

In response to clicking a button labeled ‘Recalculate’ or ‘Show details’ depending on whether or not the user's vision has changed since last calculation, a dashboard is displayed showing the user ecological metrics in various forms, the most complete of which is the ‘Data Summary’ tab.

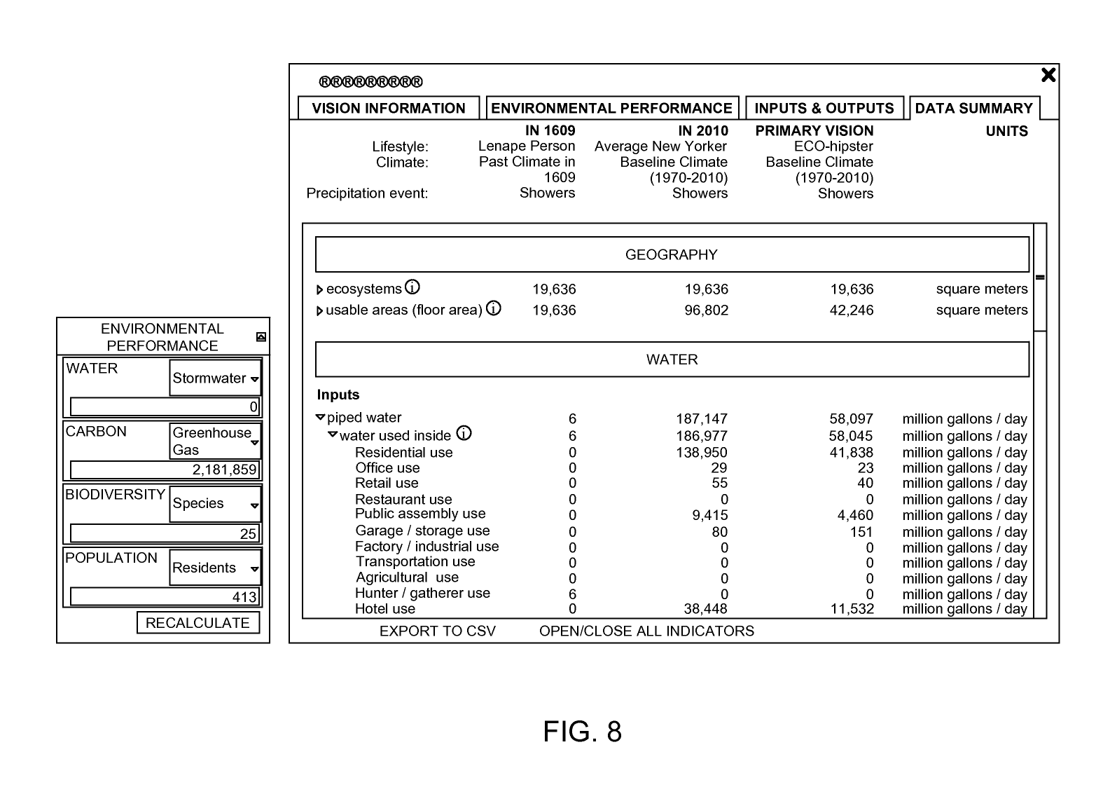

FIG. 8 is a view for explaining a dashboard display at a client machine for a user, with focus on the ‘Data Summary’ tab.

In this embodiment, the ecosystem vision-making application calculates metrics of geography, water cycle (a storm event model), carbon cycle (including energy use and transportation), and population. As appropriate each metric includes ecosystem-based, lifestyle-based, or climate-based parameters, held by the parameter database, and imported to the application. Metric calculation methods and parameter sourcing are revealed to the user through extensive hyperlinked documentation.

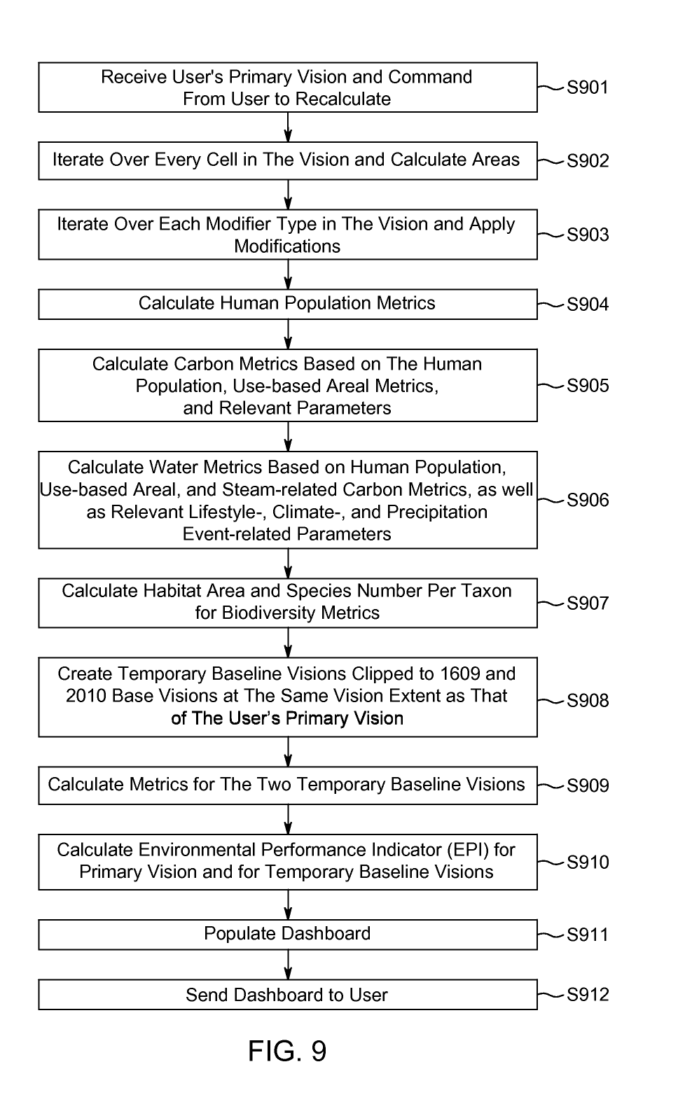

FIG. 9 is a flow diagram for explaining calculation of metrics for environmental performance indicators (EPIs) responsive to a user request for recalculation based on a user-defined ecological vision. The flow diagram of FIG. 9 provides calculation results with which the dashboard of FIG. 8 is populated, and is executed by the client's JavaScript engine 228 using JavaScript scripts received by web browser 223 from the server side web server 137.

The flow diagram of FIG. 9 also illustrates that in this embodiment, metrics other than an environmental performance indicator (EPI) are also calculated. Specifically, this embodiment calculates metrics for human population, carbon, water and biodiversity. These metrics are also displayed in the dashboard to the user, so as to facilitate the evaluation, change, improvement, commentary, distribution and sharing of the vision, by the user or by other users.

More generally, it should be understood that the environmental performance indicator (EPI) includes metrics for ecologically significant performance indications, and that other metrics for the vision may also be calculated, evaluated and compared. For example, in some embodiments, there may be social metrics for socially significant performance indications such as population, population density and housing; economic metrics for economically significant performance indications such as commerce, job availability and income distribution; and livability metrics for significant performance indications relating to enjoyment, health and safety such as cultural diversity, artistic expression, public health, biodiversity, crime and social equity.

Reverting to FIG. 9, calculations for metrics commence in step S901 in which an instruction is received from the user (such as by clicking a button on the user interface) to recalculate metrics and EPI for the user's primary vision. Step S902 iterates over every cell in the vision and calculate areas of ecosystems and modifiers, floor areas by use, average height (measured in number of floors) and average u-factors for shared wall ecosystems, and total area of vision (measured by 10 m cells rather than vision extent polygon). “Shared wall” ecosystems are buildings that potentially share a wall. The application groups all such ecosystem cells with shared wall type ecosystems and calculates the area of each shared wall patch.

Step S903 iterates over each modifier type in the vision and apply modifications to relevant parameters or areal metrics, depending on the modifier. Each modifier is customized to interact in specific ways with the environmental performance metrics below.

Step S904 calculates human population metrics based on the floor use areas calculated above and relevant parameters. For example, the number of residents is calculated by multiplying the floor area of residential use by a lifestyle-specific parameter of residential density. In this way, the lifestyle of the user's vision interacts with the ecosystem description, including the height of the buildings.

Step S905 calculates carbon metrics based on the human population and use-based areal metrics calculated above and relevant parameters. The carbon model includes estimates of building energy requirements, transportation demand, transportation modal distribution, ecosystem carbon cycling through vegetation and soil, food demand and waste generation.

Step S906 calculates water metrics based on human population, use-based areal, and steam-related carbon metrics calculated above, as well as relevant lifestyle-, climate-, and precipitation event-related parameters. The water model includes estimates of indoor and outdoor water use; precipitation specific to the climate and storm event selections of the user; routing of outdoor water to impervious and pervious water storage pools and eventually to stormwater systems, streams, or floods.

Step S907 calculates habitat area and species number per taxon for biodiversity metrics. Habitat areas are based on a reclassification of the ecosystem areas and species number are estimated from species specific species-area relationships.

Steps S908 and S909 calculate comparison values for metrics and EPI for the afore-mentioned pair of baseline visions, i.e., a first baseline vision depicting a pre-colonial natural ecosystem (herein referred to as the “1609 vision”) and a second baseline vision depicting a “today” view (herein referred to as the “2010 vision”). The 1609 and 2010 base visions are ‘clipped’ to the same vision extent as that of the user's vision, so that every non-null cell in the user's vision has a counterpart in the same geographic position in a temporary vision with the cell definition from 1609 and one with the cell definition from 2010. Metrics for these two temporary baseline visions are then calculated.

Step S910 calculates EPI for the user's primary vision and for the two baseline visions of 1609 and 2010. Then in steps S911 and S912, the dashboard is populated with calculated values of metrics and EPI, and the dashboard is displayed for output to the user, with the 1609 and 2010 temporary baseline visions being displayed in the dashboard for comparison alongside the metrics and EPI for the user's primary vision.

In this embodiment, the calculation of metrics is performed in the user's JavaScript-enabled web browser using JavaScript scripts received from the web server. It should be understood, however, that this is a non-limiting example, and the calculations in other embodiments may be performed by the client machine without using JavaScript scripts obtained from the web server, such as by application software installed on client machine 30. In addition, the calculation of metrics may be performed by machines other than client machine 30, such as server-side calculation, calculations by third-party computers, cloud computing, or distributed or grid computing, with the calculated metrics being returned to the client for display to the user in the dashboard.

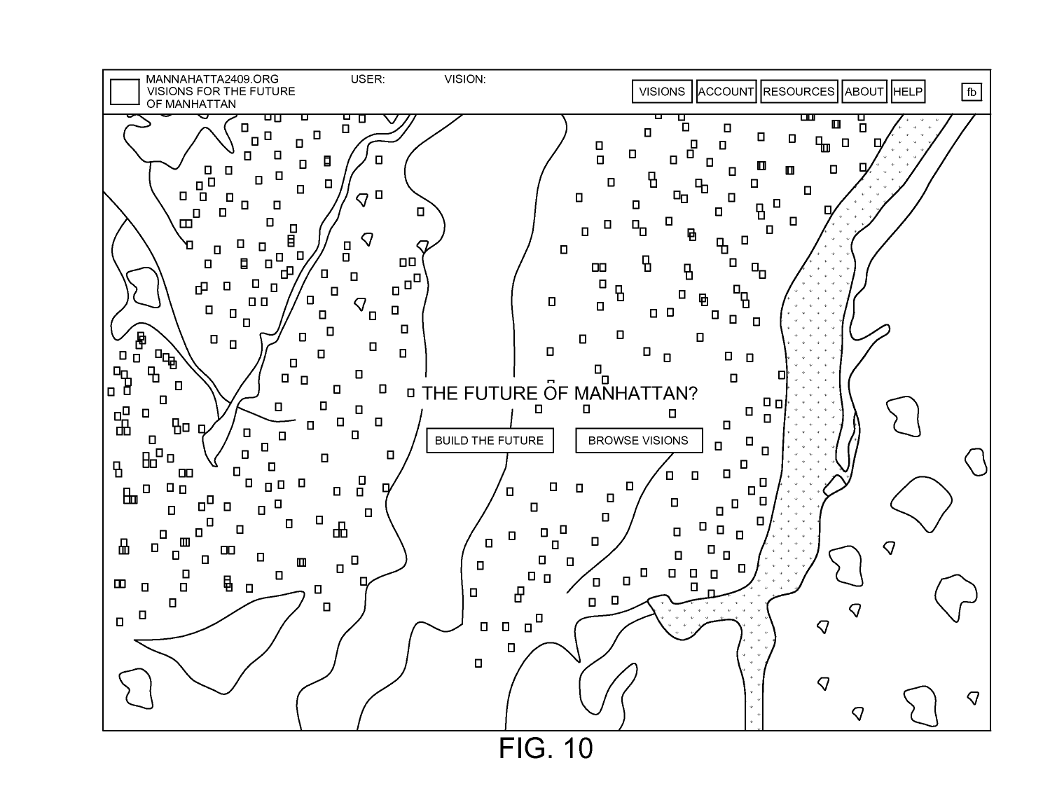

FIGS. 10 to 30 are examples of a user interface displayed on a display at a client machine, based on different usage scenarios by a user. Each figure is described below.

FIG. 10 shows an introductory splash screen made up of full screen imagery of a curated selection of user visions and their titles and credits. The selection may be displayed to the user using a slideshow effect so as to rotate through multiple visions and their titles and credits.

An option is provided to “browse visions”, without authentication, so as to provide an anonymous usage mode. Default visions may be provided including a reference image for precolonial natural ecosystems as well as modern and anthropogenic ecosystems.

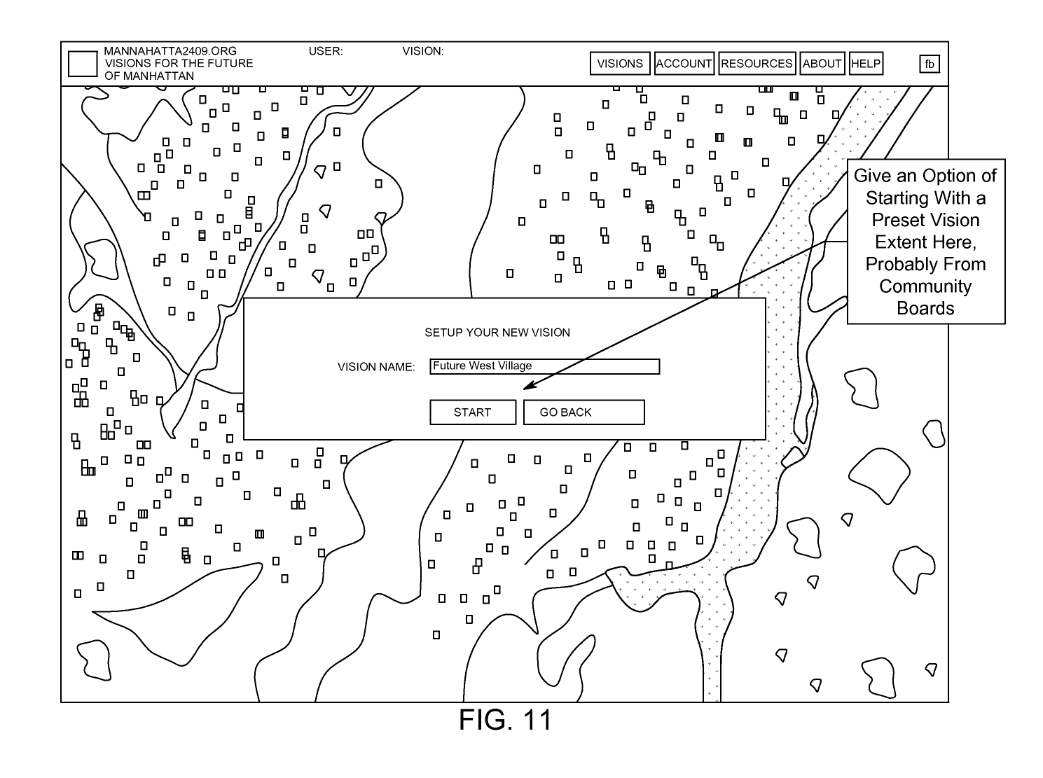

FIG. 11 is a screen showing a setup operation for an ecological vision defined by the user. The user interface includes an opportunity for the user to name the vision, as well as an opportunity to define a vision extent. In the case that the user is not yet registered or authenticated, then the user interface of FIG. 11 is preceded by an account management or login screen which is described below.

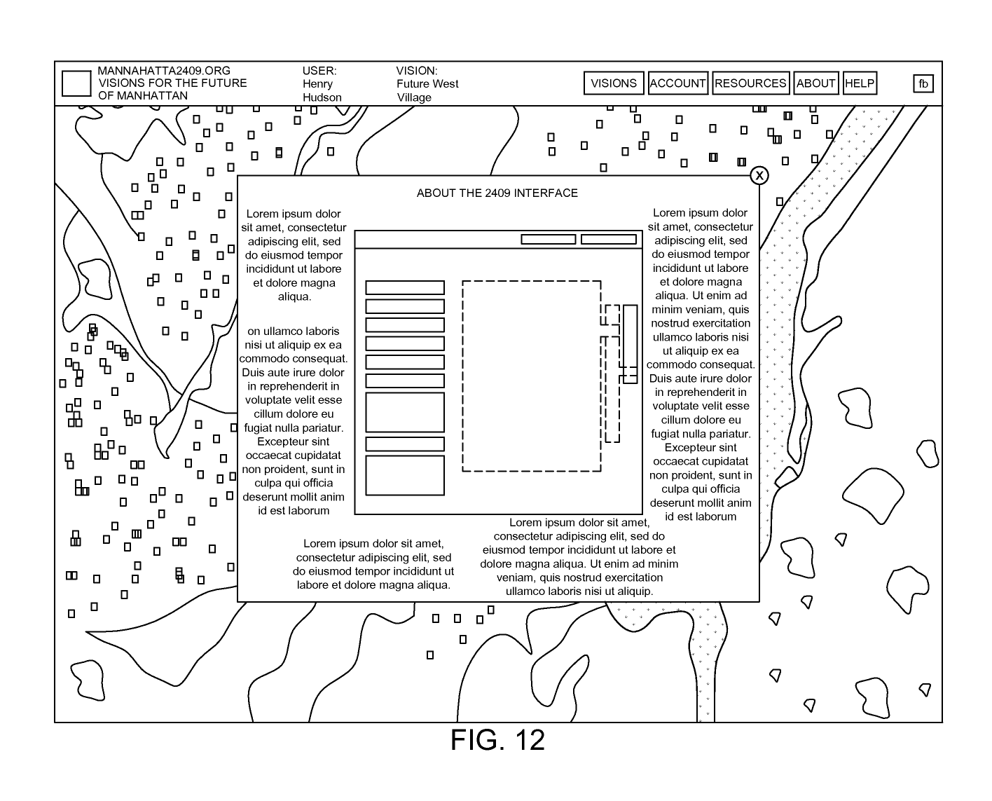

FIG. 12 is a view for a user interface for explaining to the user an overall roadmap of the user interface. Thus, immediately following the vision set up process described in FIG. 11, an overview screen of the user interface is presented, superimposed over a map. The overview screen shows notes on the general use of various tools and notes on reporting menus. In general, a user is able to access the interface overview via a “help” function in a main screen.

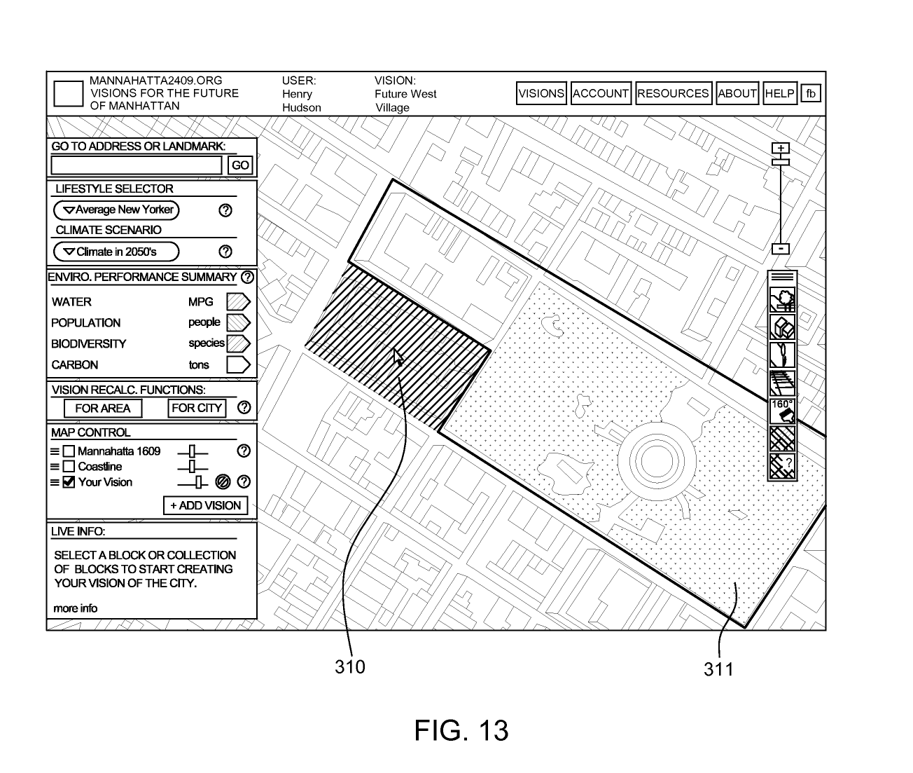

FIG. 13 is a user interface showing usage of a block selection tool. More particularly, as described above, the atomic unit for user interaction and analysis in this embodiment is a city-sized block. Thus, as the cursor of a user passes over different blocks, a polygon 310 automatically highlights the edges of the block. As a block is clicked, it is added or subtracted from the user's selection. In this process, the selected group of blocks is shown with an outline 311 using a color selected to differentiate it from other ongoing operations. This graphic designation is maintained throughout the usage of the block selection tool, so as to build the working area for the user's ecological vision. As shown in FIG. 13, the block selection tool is shown as a floating menu screen so as to provide a visual cue that the tool is in an “active” state.

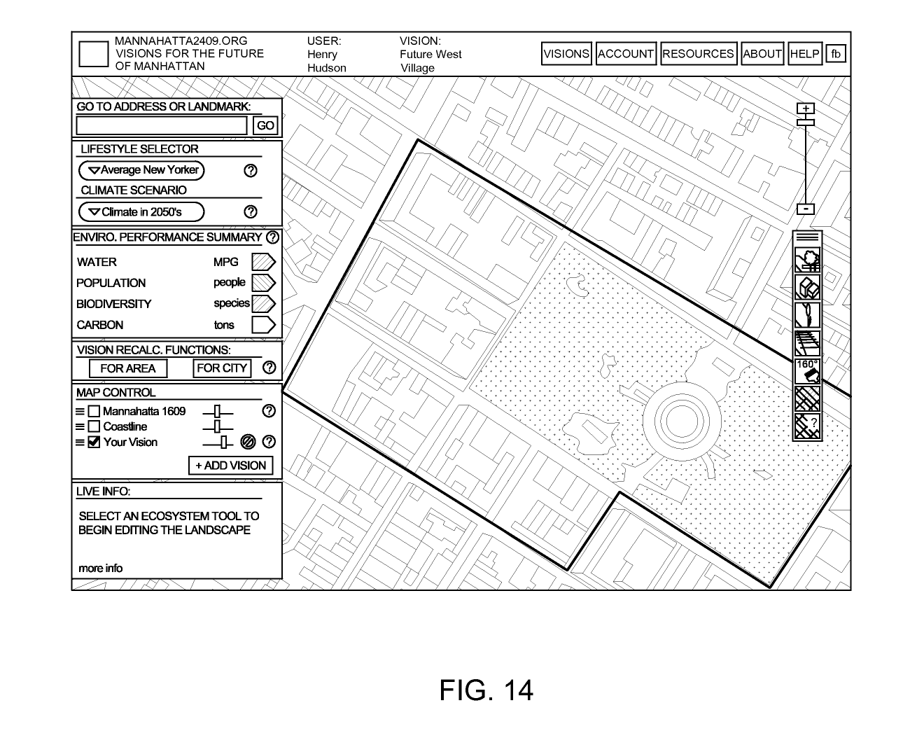

FIG. 14 is a further view of a user interface showing block selection. In FIG. 14, the block highlighted in FIG. 13 has been added to the overall selection of blocks, thus completing a selection of vision extent.

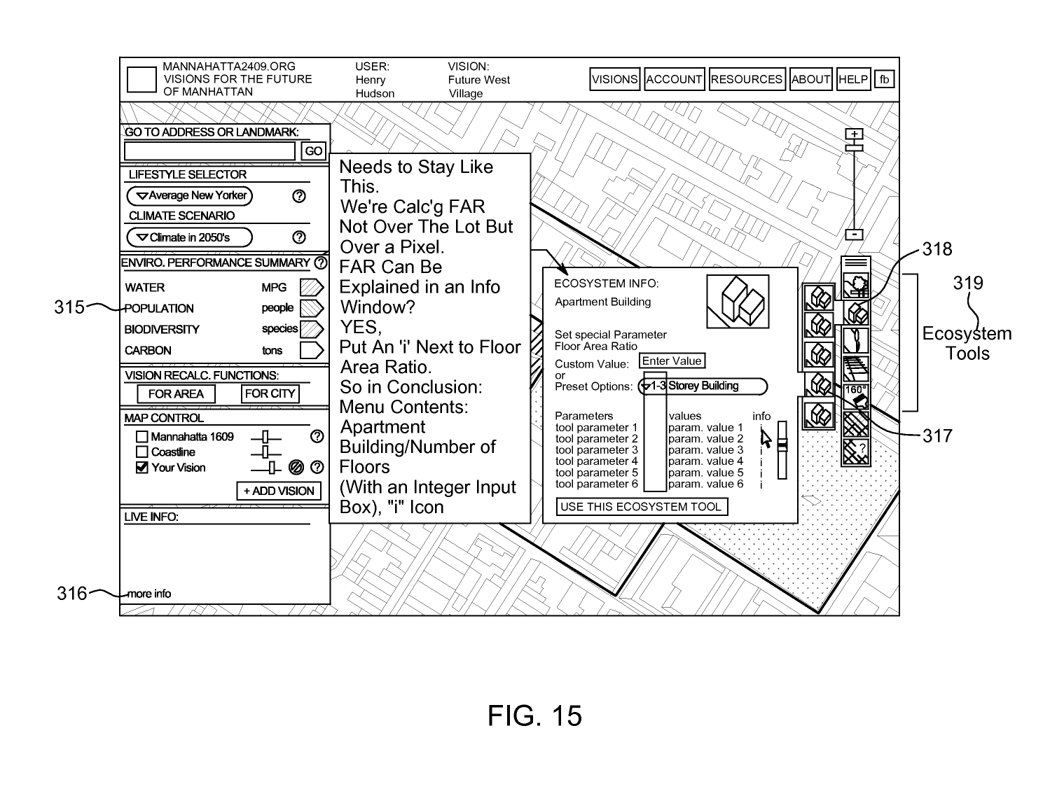

FIG. 15 is a view showing a user interface for an overview of the ecosystem toolbar. The ecosystem tools are shown in general at 319, as a floating menu with fly-out side menus. For example, as shown at 318, a “buildings” ecosystem category has been selected, which expands to show a fly-out menu 317 showing an assortment of specific shelter ecosystems. A user may select a specific shelter ecosystem, such as “apartment building ecosystem”, and the details of this ecosystem are thereafter displayed.

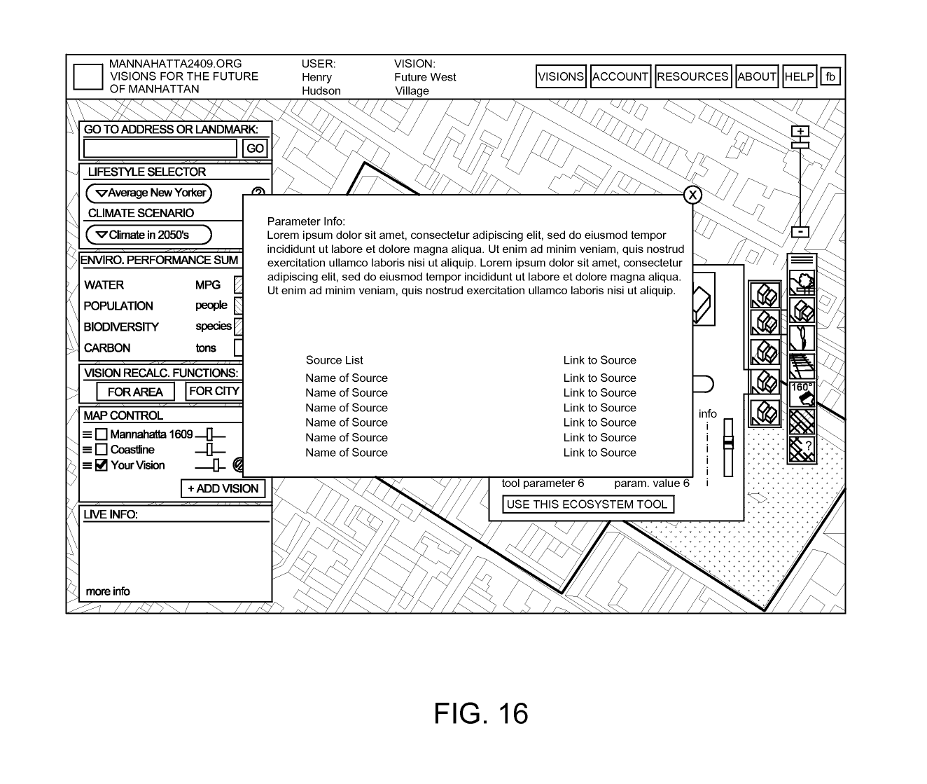

As further shown in FIG. 15, using the details of the selected ecosystem, a user may select the tool and apply it to the map, or learn more about how this ecosystem will interact with the landscape. As one example, clicking an “info” link in the user interface will launch a helper screen providing the requested information, as shown below in FIG. 16.

Controls 315 allow a user to select a lifestyle scenario and a climate scenario.

Controls 316 allow a user to control visibility of different visions in superimposition, one over the other. For example, controls 316 allow the user to select or deselect visibility and opacity for a natural ecosystem, a pre-designated anthropogenic ecosystem, or the user's vision of an ecosystem.

FIG. 16 is a view of a user interface showing a parameter information screen, as part of the explanation of an ecosystem tool. The parameter information screen includes an explanation of what the parameter measures, including links to a collection of resource source material to which the user is invited to visit.

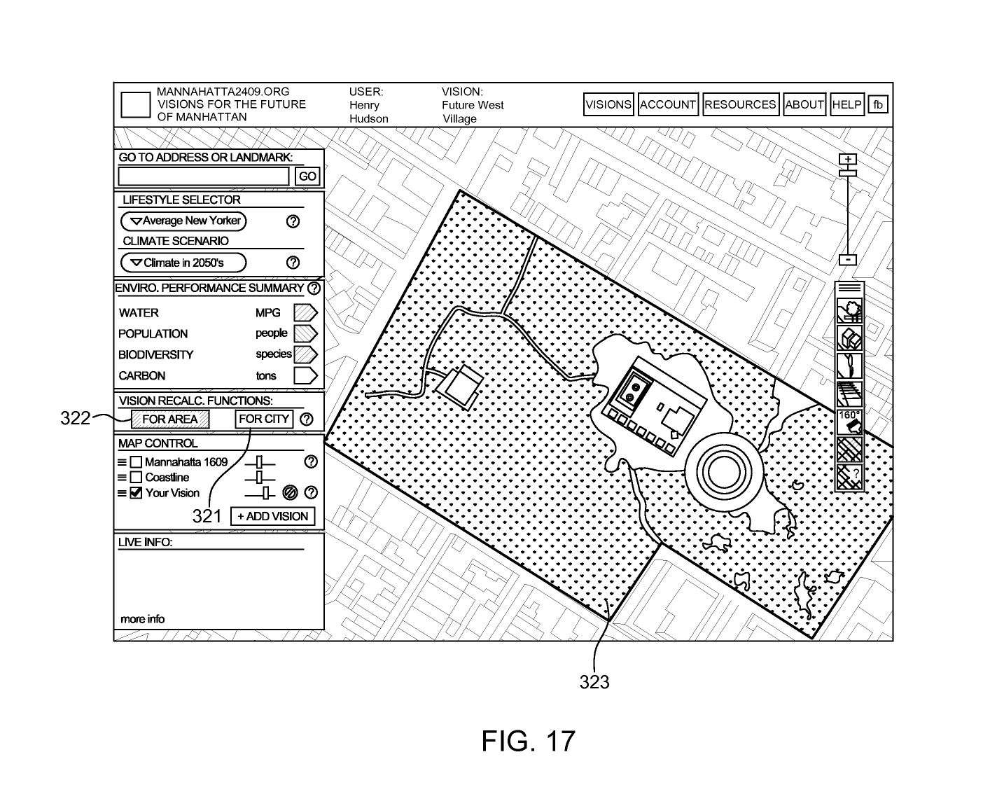

FIG. 17 is a view for explaining a user interface for a vision recalculation menu, based on results of the use of the ecosystem tool. As shown in FIG. 17, with the ecosystem still superimposed as a menu over the screen, the user has completed her selection of a modified ecological vision, in her selected block area. In this case, as shown at 323, having made changes to the landscape using various ecosystem tools, a “live info” window prompts the user to update the model. In addition, as shown at 323, a control for vision recalculation functions also offers the user the ability to recalculate the vision, either at the user's selected area, or as shown at 321, at a city scale. The recalculation process was explained above, in connection with FIG. 9 and its accompanying text.

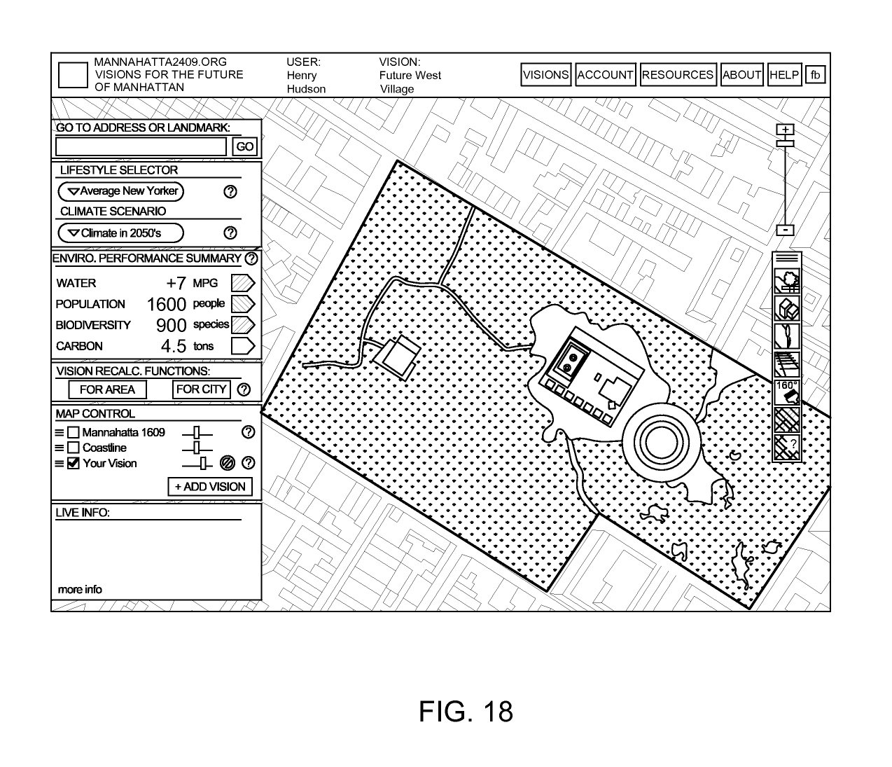

FIG. 18 is a view of a user interface, which is designated herein as a “dashboard”, showing metrics calculated for the vision using the model, such as metrics which include an environmental performance indicator (EPI), social metrics for socially significant performance indications, economic metrics for economically significant performance indications such as commerce, job availability and income distribution, and livability metrics for significant performance indications relating to enjoyment, health and safety such as cultural diversity, artistic expression, public health, crime and social equity. Aspects of these metrics may measure water, population, biodiversity and carbon footprint. A summary bar indicates one representative metric for each indicator. Clicking on an indicator launches stock and flux for that indicator and a modal model information box. Upon recalculation, the dashboard refreshes to show the summary values of the user's vision, for each indicator, and in comparison to various referenced states such as a natural ecological system or other anthropogenic visions.

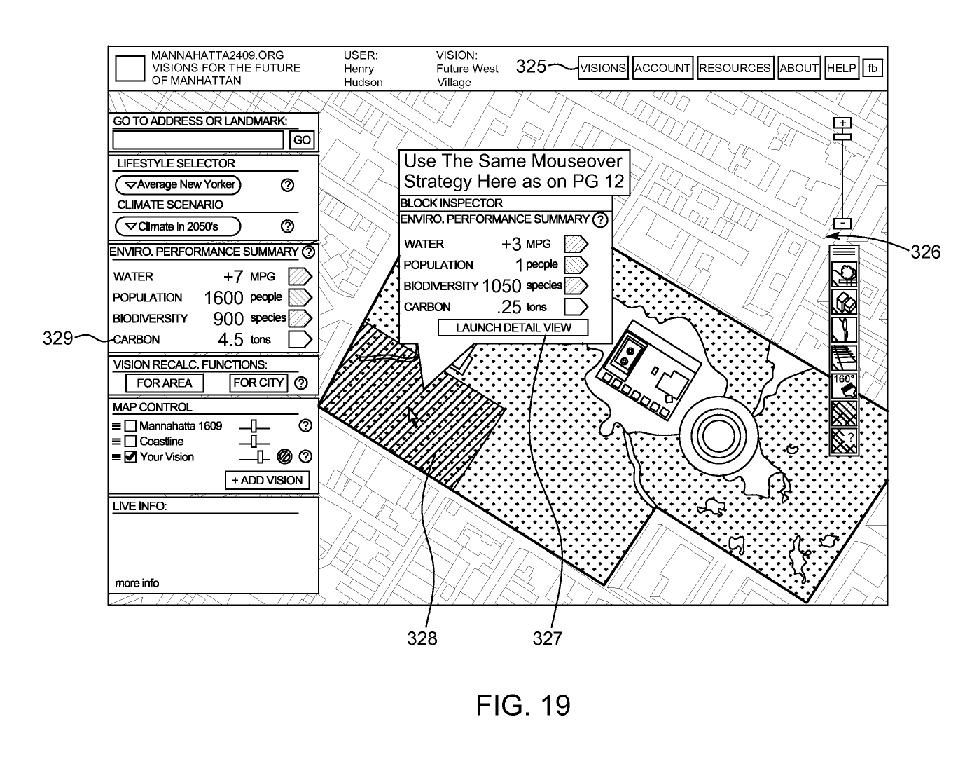

FIG. 19 is a view of a user interface showing a screen for inspecting a block for environmental performance indicators (EPIs). A pen tool may be shown at 326, so as to allow a user to click and drag the landscape until a desired city block is visible. Thereafter, by clicking a block such as the city block shown at 328, a call is sent to the server for values for the block including values pertaining to the user's ecological vision as well as values for baseline visions such as a pre-colonial natural ecosystem or other anthropogenic visions for other users. JavaScript calculations on the client's side thereafter result in a block inspector such as that shown at 327, showing EPIs for the selected block. A detail view may be launched so as to show a detailed dashboard for the selected block. The block inspector thus allows a comparison as between the EPI for a selected block as opposed to the EPI at 329 for the user's overall ecological vision. As appropriate, all menus may be dockable or collapsible, and colors and highlighting may be provided so as to provide visually distinguishing features to aid user navigation.

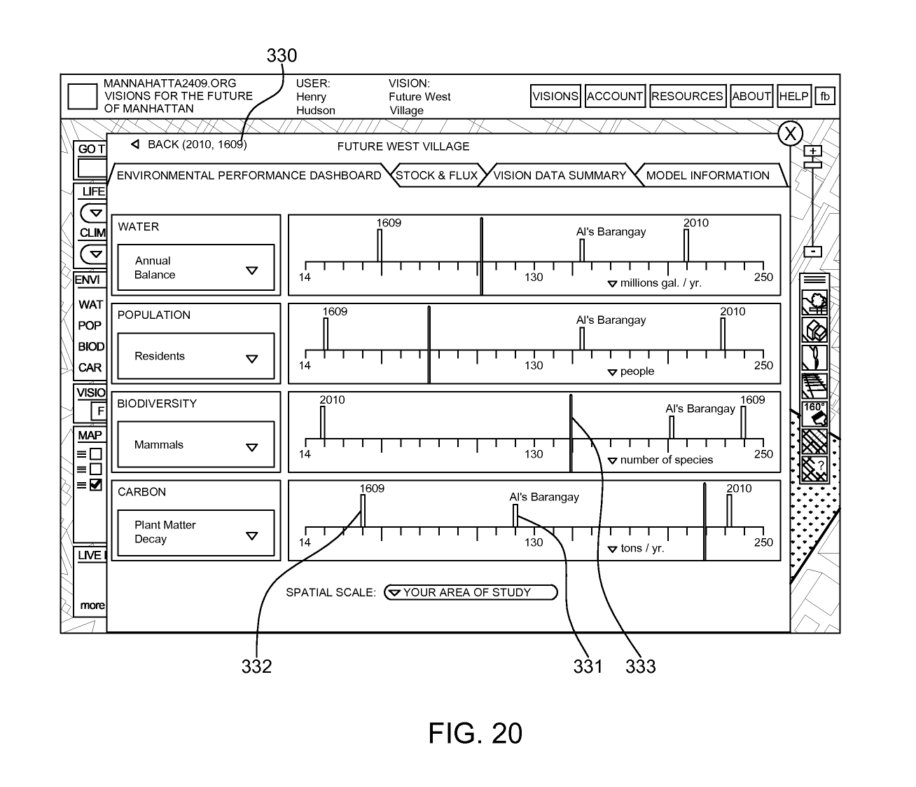

FIG. 20 is a view of a user interface showing a detailed view of an EPI dashboard. As shown in FIG. 20, metrics are shown for each indicator, and are switchable by the user. Dashboard 330 includes an environmental performance dashboard showing metrics for water, population, biodiversity and carbon. Details are provided, with comparison against other visions, such as a pre-colonial anthropogenic vision shown at 332, the current vision shown at 333, and another user's vision shown at 331. In addition, the dashboard includes tabs so as to allow the user to select stock and flux, a summary for vision data, and model information. It will be understood that other design solutions for displaying this information may be provided in other embodiments.

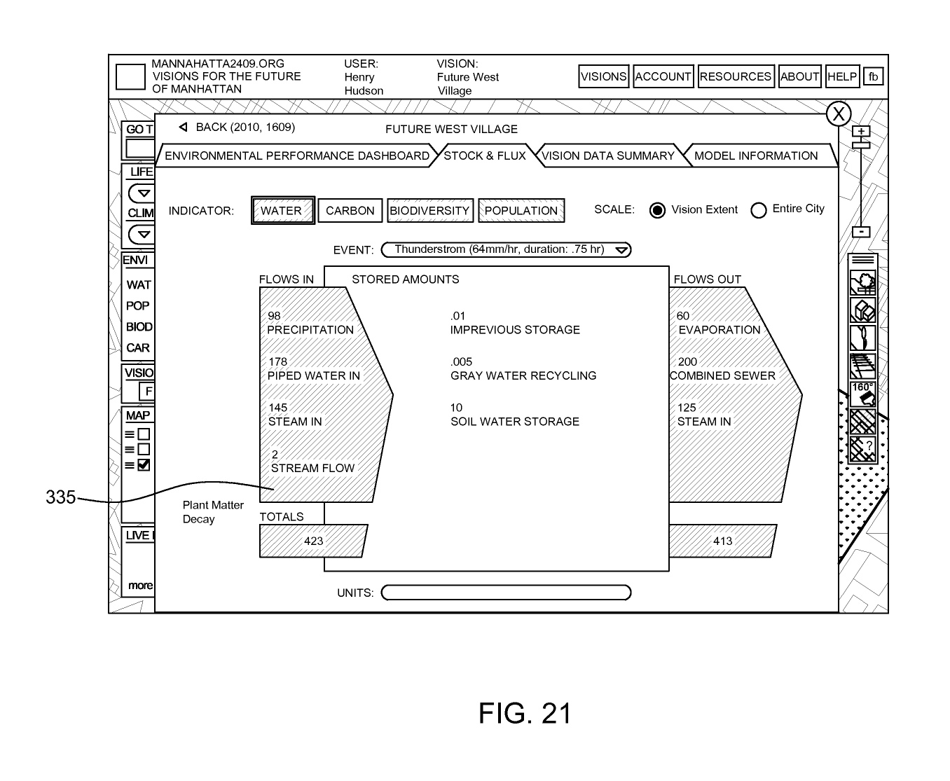

FIG. 21 shows a user interface for the dashboard when the stock and flux tab has been selected. The stock and flux screen preferably is reconfigurable, with controls for indicator, spatial scope and units and so forth, so as to display all parameters diagrammatically. Metrics include those shown at 335, such as precipitation, water piped-in, steam in and steam flow. In all cases, the metric name may be a link to another layer of superimposed information blocks explaining the nature of the metric. Values for the metrics are calculated based on the vision extent. The metrics are shown in consideration of amounts flowing in, stored amounts, and amounts flowing out, such as evaporation and so forth, based on simulations of events such as thunderstorms. Additional information may be displayed based on mouse-over events.

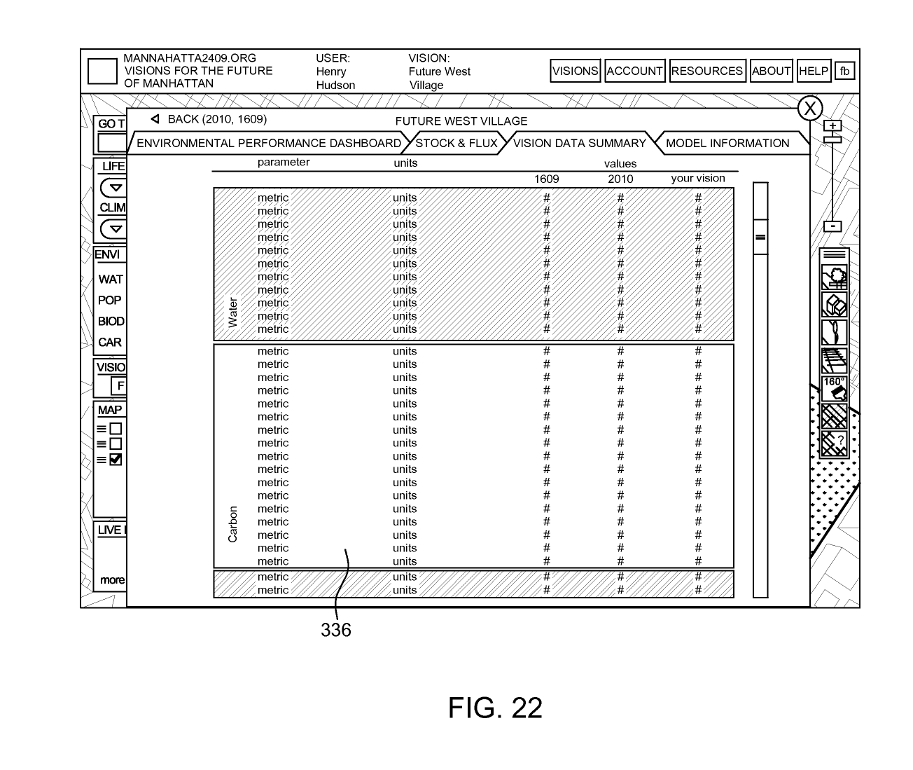

FIG. 22 is a view of a user interface in which the vision data summary tab is selected from the dashboard. Generally speaking, the vision data summary is displayed in tabular form as an exhaustive list of all metrics, grouped by indicator. The user can optionally export this data to other formats, such as to an Excel.xls format or a file of comma-separated values (.csv). The metrics are preferably divided into categories, such as metrics for water, carbon and so forth. In the case of carbon, a drop-down option for units may provide pre-programmed options to result in reporting a variety of units across the indicator, such as megagrams, CO2 equivalents or native units per metric.

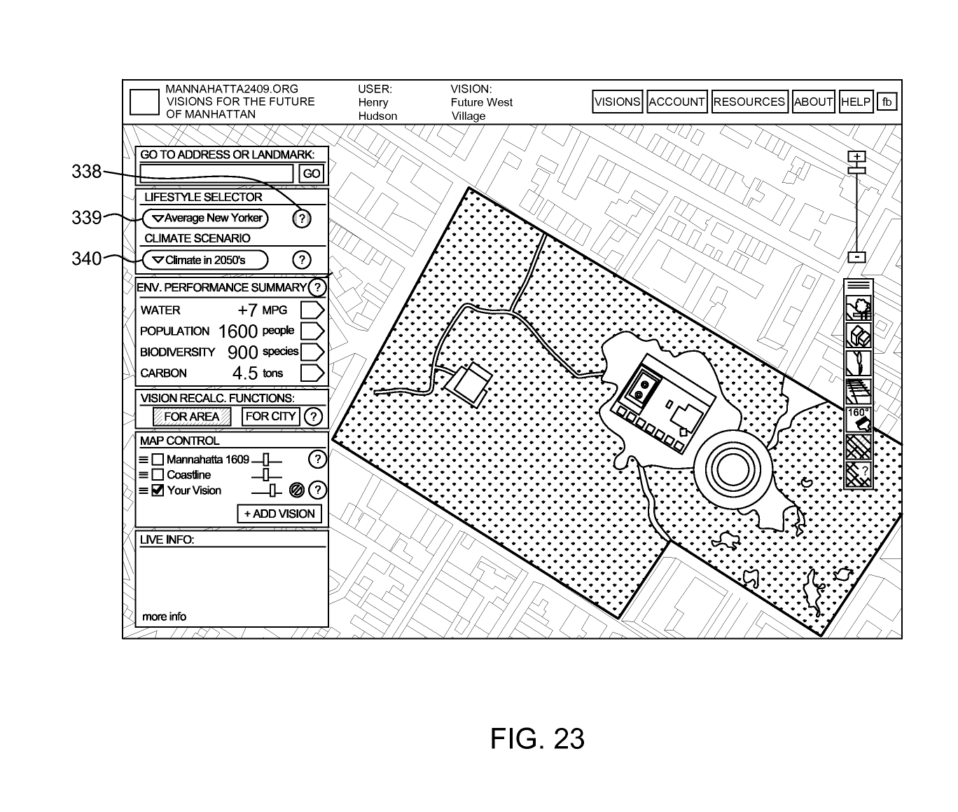

FIG. 23 is a view showing an example user interface for selectors of lifestyle and climate scenarios. The lifestyle selection toolbar (which is similar to the climate scenario selector) uses a simple dropdown approach but also includes an information icon which links to a detailed view of the parameters associated with each of the built-in lifestyle definitions. With regards to methods of interaction with the user, one embodiment provides essentially three aspects of an environmental model that the user can affect: a climate scenario, a lifestyle scenario, and a landscape (using ecosystem tools). By selecting a control shown at 338, an information icon launches a detailed lifestyle selector interface, and at 339, a drop down control allows a user to select a particular one of pre-programmed lifestyles. Likewise, at 340, a climate scenario drop down control allows a user to select from a variety of different pre-programmed climate scenarios, such as scenarios that provide for the possibility of climate change.

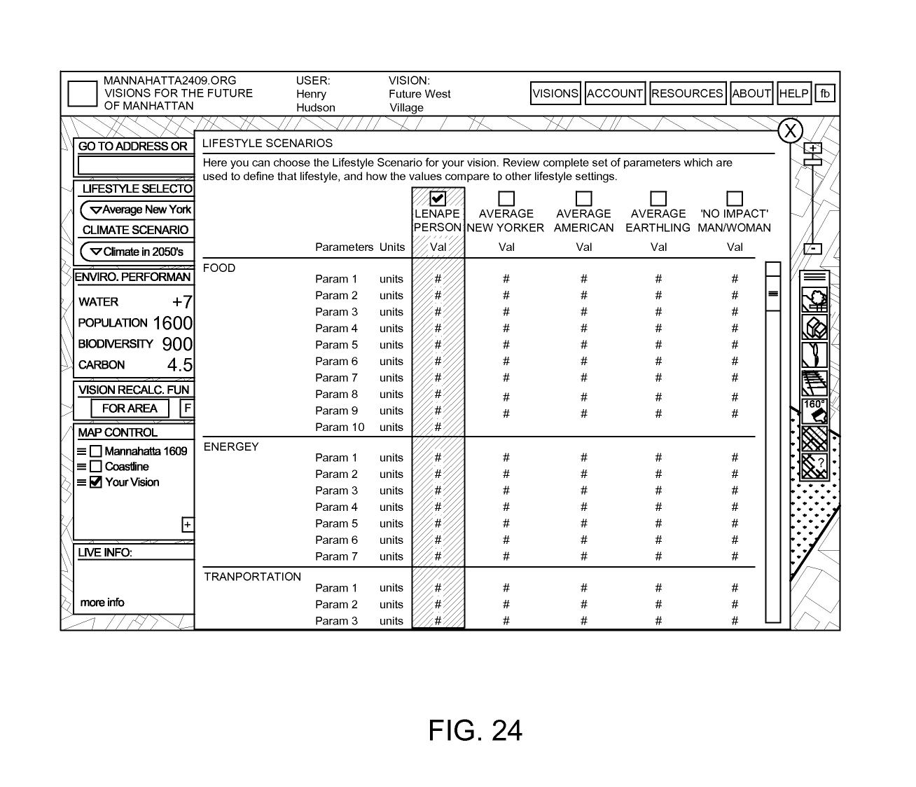

FIG. 24 is a view of an example user interface showing a detail screen on lifestyle selector. The lifestyle scenarios are organized as a table, divided into groupings such as food, energy and transportation. The table organizes the parameter data side-by-side for an in-depth comparison between the lifestyle presets. In a manner similar to that of the ecosystem tool, each row might include links to pop-up explanations and research related links, inviting the user to view underlying resources for the scenarios. It will be understood that in this embodiment, a lifestyle is a significant factor in calculation of EPI, such that if not selected by the user, then a default lifestyle (such as a lifestyle for an average New Yorker) is used.

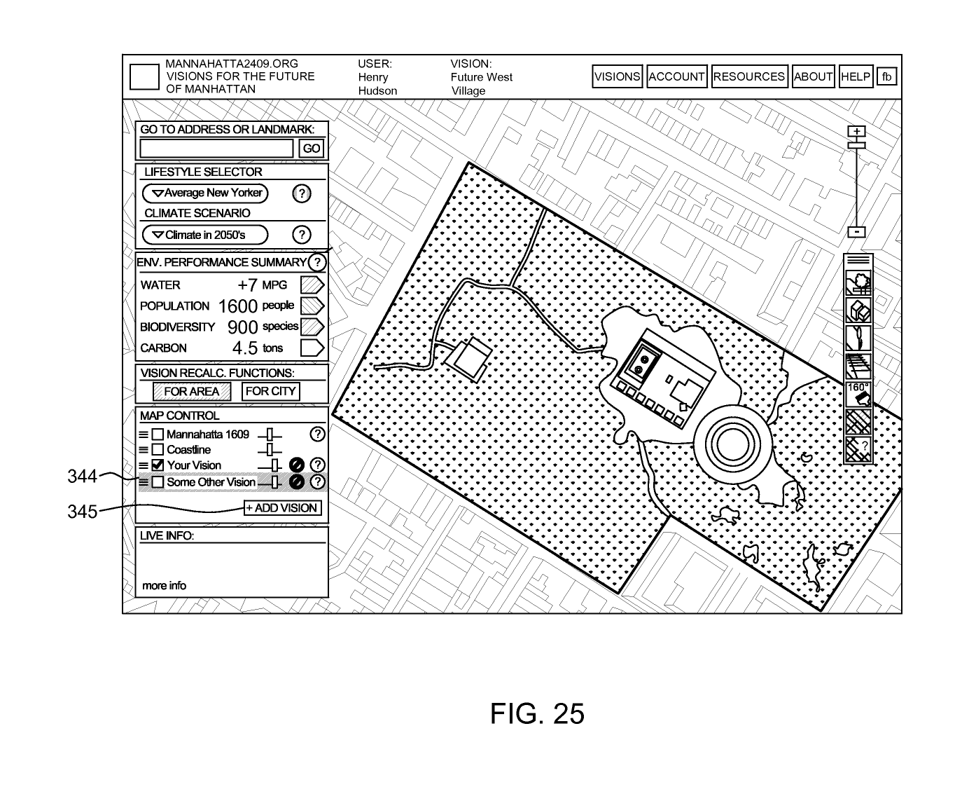

FIG. 25 is a view of an example user interface showing a map control menu. The map control allows a user to select layers that are or are not displayed, together with opacity for the layers. The layers may include the current user's ecological vision, or baseline visions such as a natural and/or anthropogenic vision, as well as the possibility for comparing against visions of different users. Thus, as shown at 334, a slider bar is provided for opacity, and check boxes are provided to select the layers available for display. In addition, visions may be added using control button 345.

According to the map control user interface, in addition to selecting whether particular visions are or are not displayed, as well as opacity of the layer, it is also possible to delete layers from display and to reorder. Additionally, each layer includes an information icon which launches a vision summary screen for that layer. Certain layers might have more restricted access, such as a coastline layer. The coast line layer might also be available by default, allowing visitors constant access to historical location of the coastline as opposed to current and proposed future dates for the coastline.

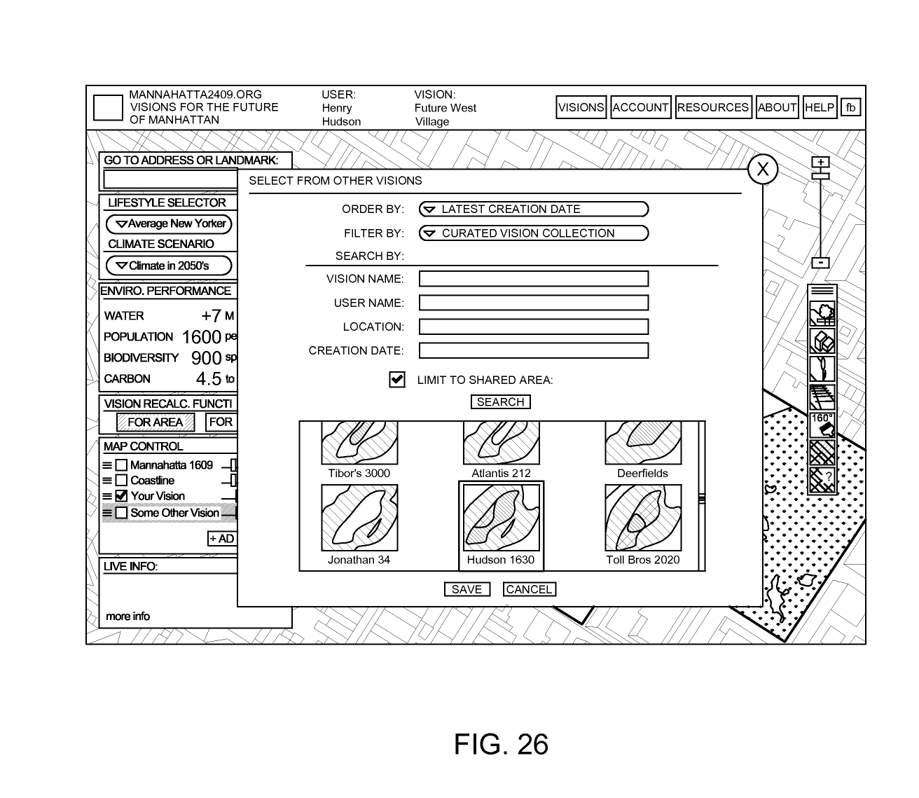

FIG. 26 is a view of an example user interface allowing a user to add a new vision. Vision selection is assisted with a small set of filtering and search operations, such as the ability to search by shared areas of interest. Search results may be shown graphically in a preview window, which shows previews of the visions that turned up in the search.

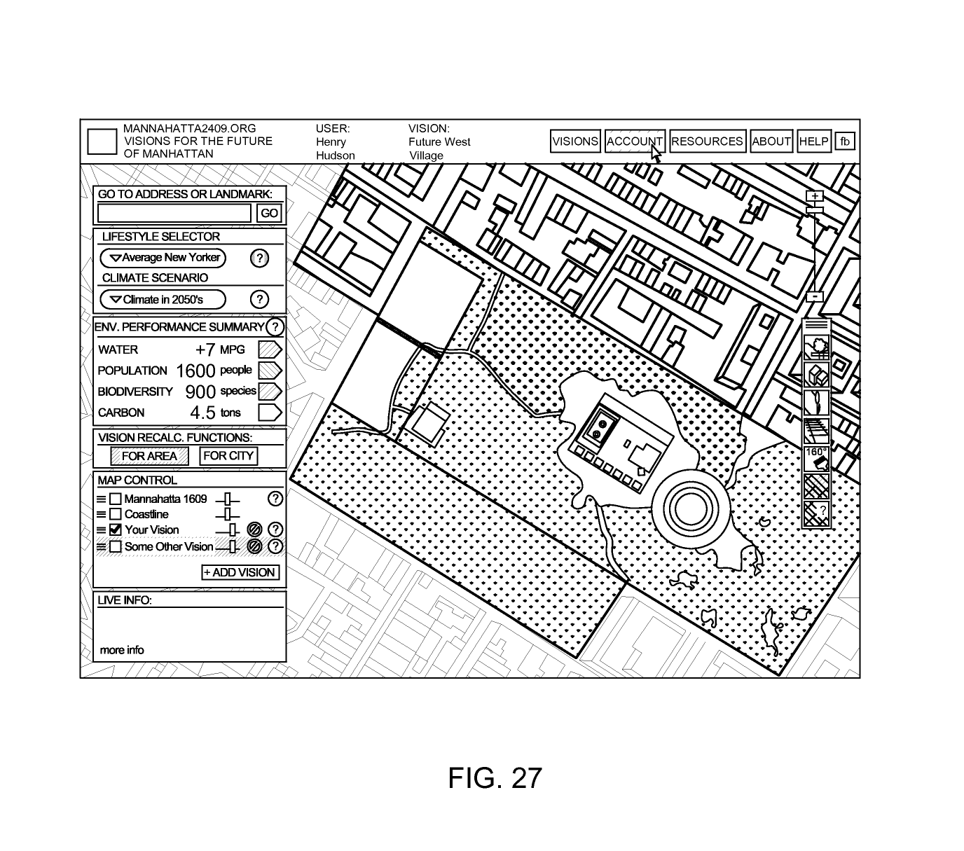

FIG. 27 is a view showing an example user interface showing a view when another user's vision is added. With the addition of each new vision to the current view, the floating ecosystem toolbar is modified so as to add an additional button for commanding a painting of the new vision. Each new vision is added into the map control menu and is visible overlaid onto the active vision, in accordance with the selected opacity settings.

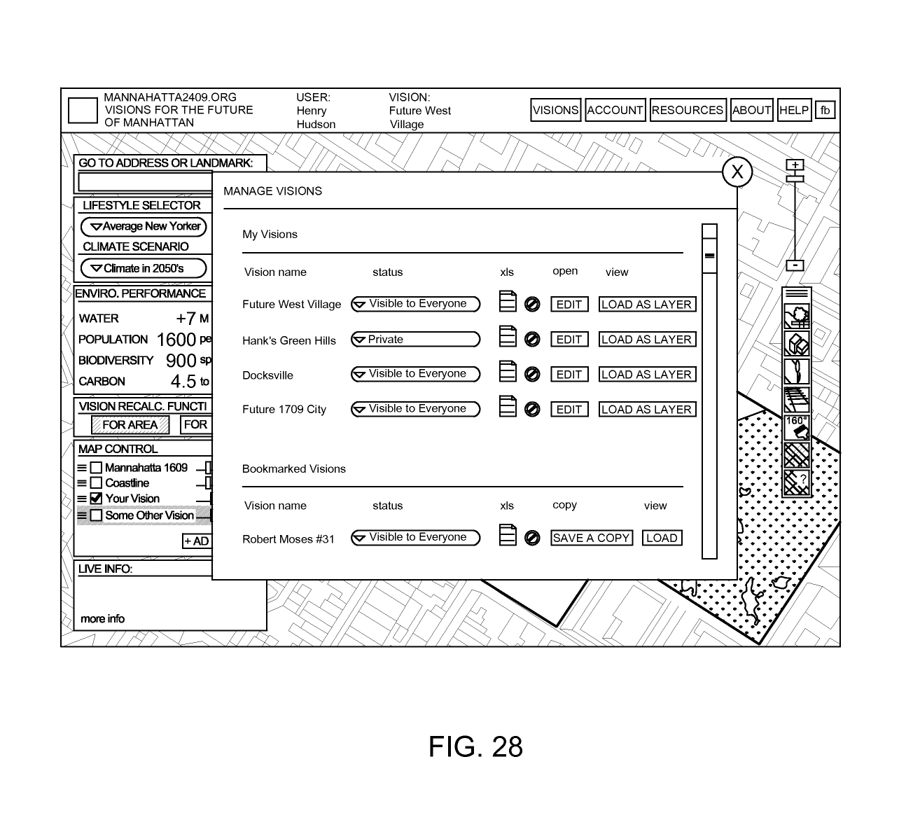

FIG. 28 is a view showing an example user interface of vision management. In particular, it is possible for a single user to author multiple different visions. Each different vision has different access authorizations for other users, such as whether the vision is visible to other users or is private, and whether the vision is open for edits by others or is read-only. In addition, each particular user might have bookmarks of visions of other users, which are also displayed in the vision management interface.

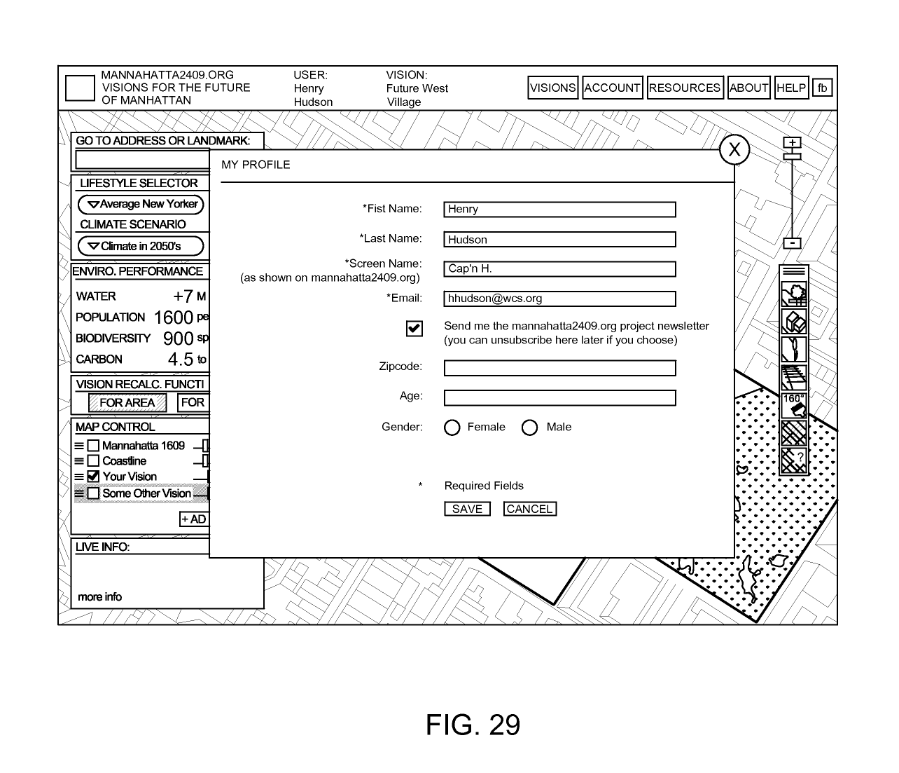

FIG. 29 is a view showing an example user interface for account management.

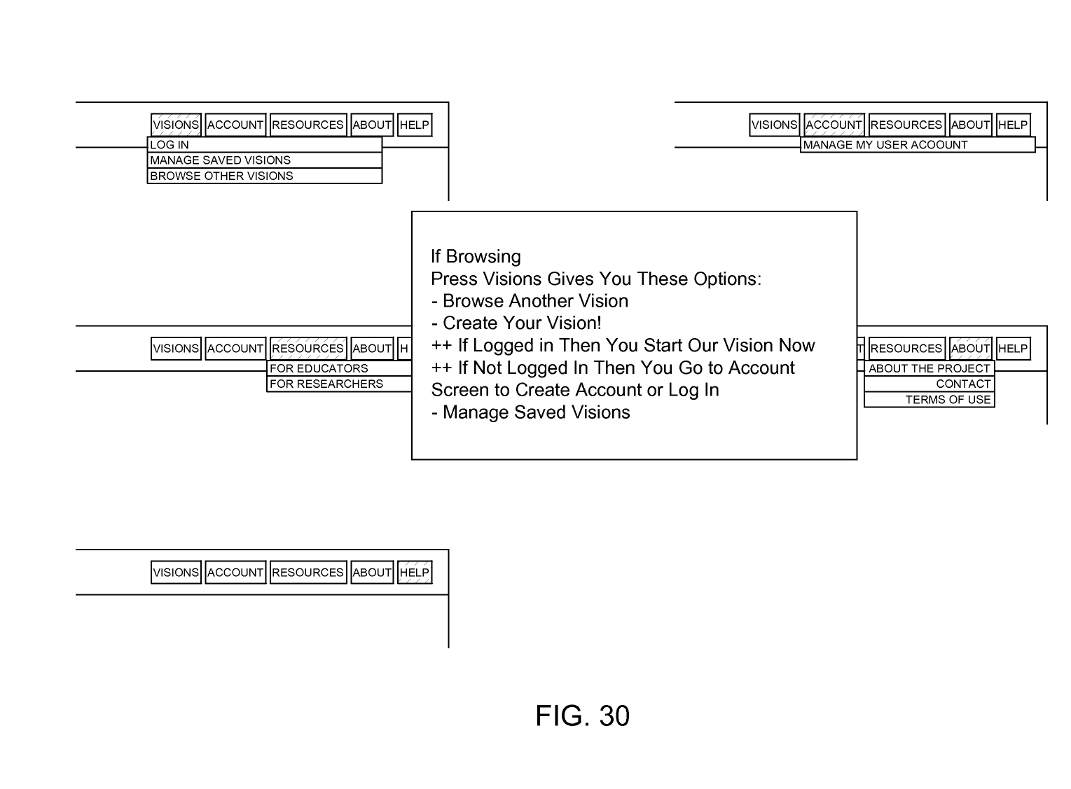

FIG. 30 is a view showing samples of a variety of different user interfaces concerning top navigational details. In these views, there are shown, for example, login information provisions, account information, resource information, version information, and help information.

### <Quantitative Methods>

Relationships define the human population, carbon, water and biodiversity characteristics of a geographic location. These different aspects of a location's ecology are conceived of as standard stock and flux dynamical models. These methods thus estimate how these stocks and fluxes of population, carbon, water and biodiversity change as the user changes the map of the geographic location and makes lifestyle choices, and as the climate changes. One driver is the change in the area of ecosystems within the user's self-described area of interest, that is, the one or more blocks selected by the user.

The provisional estimation methods are adapted from existing methods either already in use by the city (particularly helpful is the City Environmental Quality Review Technical Manual-MOEC 2010) or described in the scientific literature, or in the case of the biodiversity estimations, developed de novo. Limitations on the methods are noted.

In the method statements below, the metrics are labeled by underlined regular type (e.g. Resident population (stock)). Brief descriptions of each method statement are provided along with one or more equations describing how the estimate(s) will be made. The full parameterization of these relationships is on-going and will not be completed until June 2012. In the following methods, the subscript “e” means “varies by ecosystem type”; the subscript “1” means “varies by lifestyle profile”; and the subscript “c” means varies by climate scenario. The subscript “u” is also used to represent different use cases, “h” to represent different habitat types, and “t” to represent different biological taxa.

### Population

Population refers to how many people live, work, or visit the area of interest. Sub-categories under Population include the following: Residential population (stock), Residential households (stock), Worker population (stock), Visitor population (stock), Daytime population density (stock), and Nighttime population density (stock). Each is described below in turn.

### Residential Population (Stock)

The residential population rate is the number of people living in the area of interest. It is estimated as a function of the floor area of an ecosystem type, the percentage uses of an ecosystem type (i.e. the amount of floor space typically dedicated to various use cases—see Appendix 3), residential density (residents/square foot), and the city-wide residential vacancy rate.

Floor to area ratios (FARs) and use proportions are parameterized for each ecosystem type based on an analysis of the Map-PLUTO data. Floor area is calculated by multiplying the FAR by area of that ecosystem type, set by the user. (For the current city, FAR is provided on a per building basis in Map-PLUTO; for 1609 FAR=1.) Residential floor area is summed across the area of interest. Residential densities will be estimated from data available from the census program at the Department of City Planning analyzed with the Map-PLUTO data. (Hereafter the calculation across areas of ecosystem types is referred to as “estimated on summed area basis.”)

Residential population=Σₑ (area of ecosystem type (m²)*FARₑ*proportion of residential useₑ*residential density (residents/floor area,m²))*(1−residential vacancy rate) (Eq 1)

Units: number of people

Note: Σₑ means summed across the ecosystem types within the area of interest.

Note: Unless explicitly listed otherwise, the area of ecosystem type in the calculations below is square meters (m²).

### Residential Households (Stock)

For some calculations below, the number of households is needed. The average household size in New York County is available from the US Census.

Households=Residential population (people)/Average household size (people/household) (Eq 2)

Units: number of households

### Worker Population (Stock)

The worker population is the number of people working in the area of interest on a given work day. It is a function of the floor area of an ecosystem type, the percentage uses of an ecosystem type (i.e. the amount of floor space typically dedicated to worker uses), and its workplace density (number of workers/square foot.) Workers are assumed to spend eight hours per day in their workplace block. The unemployment rate is expressed as the fraction (0-1) of potential workers not working.

Worker population=(1−unemployment rate)*Σₑ (area of ecosystem type*FARₑ*proportion of floor use_{e,u}*worker densityᵤ) (Eq 3)

Units: number of workers

### Visitor Population (Stock)

The visitor population is the number of people visiting a block for reasons other than residence or work. The visiting population includes friends, colleagues, customers, students, patients, park-goers, and attendees for events, on a given day, averaged across the year. It does not include people simply transiting an area of interest to get somewhere else.

The visiting population is estimated as a function of people visiting residences and people visiting as a function of use (i.e. retail, office, restaurant, etc.).

Visitor population=visitors per household*households+Σᵤ[floor area of useᵤ*(visitors per floor area/day)ᵤ*annual days of active useᵤ] (Eq 4)

Units: number of visitors

### Daytime Population Density (Stock)

Daytime population refers to the population of the area of interest including residents, workers, and visitors. The daytime population is generally higher than night-time population, which includes only residents. Density is calculated by dividing by the area of interest.

Daytime population density=(Resident population+Worker Population+Visitor Population)/Area of interest (m²)*(2,589,988.11 m²/mi²) (Eq 5)

Units: people/sq mi

### Nighttime Population Density (Stock)

Nighttime population density is calculated by dividing the residential population by the area of interest.

Nighttime population density=Resident population/Area of interest (m²)*(2,589,988.11 m²/mi²) (Eq 6)

Units: people/sq mi

### Carbon

Life on Earth is carbon based. As a result, our bodies, plants, animals, and fossil fuels are all composed of carbon mixed with smaller amounts of other elements. Carbon also resides in the atmosphere in the form of carbon dioxide, which is a greenhouse gas, and which is fixed into plants via photosynthesis and returned to the atmosphere through combustion and respiration. These various transformations make carbon the most complicated of the methods detailed; on the other hand, there are some who might argue that carbon is one of the more important transformations for present purposes, given concerns about climate change. All the carbon estimates are made on an annual basis.

The category of Carbon includes the following sub-categories: Plant biomass (stock), Leaf litter & down wood carbon (stock), Soil organic matter carbon (stock), Animal biomass (stock), Building carbon (stock), Fossil fuel (stock), Food (stock), Solid waste (stock), Net primary production (flux), Litterfall (flux), Leaf litter decomposition (flux), Soil respiration (flux), Plant biomass harvest and herbivory (flux), Animal respiration (flux), Food consumed (flux), Solid waste generation (flux), Fossil fuel consumption (flux), and Fossil fuel consumption total (flux). In addition, the sub-category of Fossil fuel consumption (flux) includes a number of its own sub-categories. Each of these is discussed in turn below.

### Plant Biomass (Stock)

Carbon density of plant biomass is assigned to each ecosystem type (e.g. Mg carbon/m²). Plant biomass includes above- and belowground biomass on an annual basis. Plant biomass carbon is calculated for each ecosystem type by multiplying a plant biomass density by the area of that ecosystem type, and then summing across the area of interest. Densities used in this case refer to amounts per area.

Plant biomass=Σₑ (area of ecosystem type (m²)*density of plant biomassₑ kg dry biomass/m²)) (Eq 7)

where Σₑ means summed across the ecosystem types within the area of interest.

The amount of plant biomass carbon is calculated by multiplying the plant biomass by a carbon content that varies by ecosystem type.

Plant biomass carbon=plant biomass*carbon contentₑ (Eq 8)

Units: Mg carbon

### Leaf Litter & Down Wood Carbon (Stock)

Leaf litter & down wood carbon (litterfall) is estimated by ecosystem type on summed area basis.

Litterfall biomass=Σₑ (area of ecosystem type*biomass density of litterfallₑ) (Eq 9)

Litterfall biomass carbon=litterfall biomass*carbon contentₑ (Eq 10)

Units: Mg carbon

### Soil Organic Matter Carbon (Stock)

Soil organic matter is estimated by ecosystem type on a summed area basis. A 1:1 correspondence is assumed between ecosystem type and soil type. Sanderson (2009) provides a mapping of the 1609 soils, based on analysis of vegetation, topography, and geological parent materials. New York City Soil Survey Staff (2005) have mapped modern day soils at 1:62,500. In the embodiment described herein, these maps are used to assign representative soil types to each ecosystem and use reference database information from the Natural Research Conservation Service.

Soil organic matter=Σₑ (area of ecosystem type*soil organic matter densityₑ) (Eq 11)

Soil organic matter carbon=soil organic matter*carbon content of soil organic matterₑ (Eq 12)

Units: Mg carbon

### Animal Biomass (Stock)

Animal biomass is the sum of the biomass of resident human beings, their cats and dogs, and wildlife. Biomass of human beings is estimated from the residential population calculation, described elsewhere, multiplied by biomass for a human being (60 kg/person). Workers are included fractionally based on an eight work day in 24 hours (i.e. discounted by ⅓^{rd}); visitors are included fractionally based on one hour visits over a 24 hour time span (i.e. discounted by 1/24^{th}). The number of cats and dogs per resident is derived from the lifestyle profile (Appendix 2. See ratios provided by AVMA (2007). Dogs are assumed to have an average biomass of 15 kg/dog; cats, 4.5 kg/cat. Wildlife biomass is assigned based on ecosystem type. Research literature was reviewed to determine wildlife biomass values for natural ecosystems, orchards, farms and parks. All other ecosystem types were assigned a generic urban wildlife biomass value based on literature review. In this embodiment, animal biomass values were converted to carbon assuming that 18% of the biomass was carbon (Frieden, 1972.)

Average annual animal biomass carbon=0.18*[(resident population*60 kg/person)*annual days of active useᵤ/365+(worker population/day*60 kg/person)*0.33*annual days of active useᵤ/365+(resident population*dogs/resident)*average mass of dog+(resident population*cats/resident)*average mass of cat+Σₑ (area of ecosystem type*wildlife biomass densityₑ)]*0.001 (Mg/kg) (Eq 13)

Units: Mg carbon

### Building Carbon (Stock)

Building carbon refers to the carbon in non-living equipment and supplies held within a built structure. It may include furniture, supplies, wood construction materials, and so on.

Building biomass=Σₑ (area of ecosystem type*building biomass densityₑ) (Eq 14)

Building carbon=building biomass*carbon content of building biomass (Eq 15)

### Fossil Fuel (Stock)

The fossil fuel stock is estimated as a percentage of the fossil fuel consumption for buildings for liquid fossil fuels (i.e. fuel oil/diesel and gasoline). See list of fuels covering all aspects of energy use in Appendix 5. The amount of fossil fuel on hand is a function of ecosystem type as estimated for heating and other applications as described below, including transportation uses stored at gas stations, garages, and marine piers. In this embodiment, in-vehicle fuel storage is neglected in the case of vehicles merely passing through an area of interest. For most commercial and residential types, a one-month supply (8.2% of the yearly total) is assumed.

Fossil fuel carbon stored=[Annual consumption of light fuel oil/diesel (gallons/year)*Carbon dioxide emissions from combustion of fuel oil/diesel (g/gallon)*Carbon density of carbon dioxide+Annual consumption of gasoline (gallons/year)*Carbon dioxide emissions from combustion of gasoline (g/gallon)*Carbon density of carbon dioxide]*One month as a fraction of a year*0.0000001 (Mg/g) (Eq 16)

Units: Mg carbon

### Food (Stock)

The food stock is estimated as a percentage of the food consumed flux described below. This embodiment assumes that at any given time the amount of food stored represents 3 days' worth of annual consumption (0.82%).

Food stored=One month as a fraction of a year*(Annual carbon consumption of food (Mg/year)) (Eq 17)

Units: Mg carbon

### Solid Waste (Stock)

The solid waste stock is estimated as a percentage of the solid waste flux. At any time, the amount of solid waste stored is assumed to be approximately 3 days work of annual production (0.82%).

Solid waste stored=One month as a fraction of a year*Annual municipal solid waste generation (tons/year)*(Annual carbon density of municipal solid waste)(Mg/yr))*0.907 (Mg/tons) (Eq 18)

Units: Mg carbon

### Net Primary Production (Flux)

Net primary production represents carbon taken from the atmosphere and fixed into biomass over the course of the year by photosynthesis, minus the carbon released to the atmosphere from plant respiration.

NPP=Σₑ[Area of ecosystem type (m²)*NPP rateₑ (Mg/yr/m²)] (Eq 19)

Units: Mg carbon/year

### Litterfall (Flux)

Litterfall represents dead or senesced plant biomass dropped to the soil surface. Litterfall includes leaf litter as well as downed wood. Litterfall rates are estimated by ecosystem type on an area-weighted average basis. In areas where ecosystems with positive litterfall rates are less than 10% of the area, litterfall is assumed to contribute 50% of its biomass to solid waste.

Litterfall=Σₑ[Area of ecosystem type (m²)*Litterfall rateₑ (Mg/yr)] (Eq 20)

Units: Mg carbon/year

### Leaf Litter Decomposition (Flux)

Decomposition represents leaf litter and down wood becoming part of the soil organic matter. Decomposition is a function of the carbon:nitrogen ratio of the leaf litter and temperature. Decomposition rates are estimated by ecosystem type and climate scenario on an area-weighted average basis.

Decomposition=Σₑ[Area of ecosystem type (m²)*Decomposition rateₑ (Mg/yr)] (Eq 21)

Units: Mg carbon/year

### Soil Respiration (Flux)

Soil respiration represents carbon released to the atmosphere from metabolism of soil microbes. Soil respiration is estimated by ecosystem type and climate scenario on an area-weighted average basis.

Soil respiration=Σₑ[Area of ecosystem type (m²)*Soil respiration rateₑ (Mg/yr)] (Eq 22)

Units: Mg carbon/year

### Plant Biomass Harvest and Herbivory (Flux)

Harvest by people and herbivory by other animals represents animals eating plants. Harvest and herbivory are assigned are estimated by ecosystem type on an area-weighted average basis.

Plant biomass harvest and herbivory=Σₑ[Area of ecosystem type (m²)*Harvest rateₑ (Mg/yr)]+Σₑ[Area of ecosystem type (m²)*Herbivory rateₑ (Mg/yr)] (Eq 23)

Units: Mg carbon/year

### Animal Respiration (Flux)

Animal respiration represents carbon obtained from food and released into the atmosphere through animal metabolism. Respiration rates vary widely across different animal species. For simplicity, this embodiment assumes an average respiration rate per kg of biomass based on human physiology. Human beings breathe out approximately 2.3 kg of carbon dioxide per day (US EPA, 2011.) Assuming an average 60 kg human being, then on average 14 kg of carbon dioxide per day are emitted per kg of biomass. Animal biomass is calculated as described under animal biomass (stock). Carbon dioxide is 30% carbon on a mass basis.

Animal respiration=Animal biomass (Mg)*1000 (kg/Mg)*(14 kg CO2/kg biomass)*0.3*0.001 (Mg/kg) (Eq 24)

Units: Mg carbon/year

### Food Consumed (Flux)

Food consumed is consumed by people for growth and energy. Food consumption is estimated based on the residential, worker and visitor populations and the lifestyle profile, which specifies diet. Average American daily diets are provided in ARS & CDC (2010, Table 1) for men and women by age; Table 9 in the same reference describes percentages of the diet eaten outside residences. Carbon conversion rates are (g C/g source) are 0.5 for protein, 0.43 for carbohydrates, 0.77 for fats and 0.49 for fiber (Baker 2006, citing Klass 2004). Worker and visitor populations are weighted by the number of hours per day spent in the area of interest (8 hours for workers and 1 hour for visitors.)

Food consumed (Mg)=Resident population*[(Protein consumption at home (g/year)*0.50 g C/g protein)+(Carbohydrate consumption at home (g/year)*0.43 g C/g carbohydrate)+(Fat consumption at home (g/year)*0.77 g C/g fat)+(Fiber consumption at home (g/year)*0.49 g C/g fiber)]*0.0000001 Mg/g+(Worker population+Visitor population)*[(Protein consumption out of home (g/year)*0.50 g C/g protein)+(Carbohydrate consumption out of home (g/year)*0.43 g C/g carbohydrate)+(Fat consumption out of home (g/year)*0.77 g C/g fat)+(Fiber consumption out of home (g/year)*0.49 g C/g fiber)]*0.0000001 Mg/g (Eq 25)

Units: Mg carbon/year

### Solid Waste Generation (Flux)

Solid waste arises from discarded household and office waste. Waste generation is estimated according to per capita rates for residential households and area-weighted averages by ecosystem type of worker waste generation rates, based on rates provided by MOAC (2010, Chapter 14, Table 14-1). See also detailed studies of New York City residential waste by Beck (2008), and of New York City commercial waste by Henningson, Durham & Richardson Architecture and Engineering (2004), Table 2.1.2-1. Incineration of one ton of municipal solid waste generates 1100 kg of carbon dioxide (IEA Bioenergy 2003), based on which this embodiment assumes that the carbon content of municipal solid waste contains approximately 0.33 g C/g of solid waste. Visitors are assumed to litter at a rate to be determined weighted by the amount of time spent in the area of interest.

Municipal solid waste (MSW) generated (Mg)=Residents*Residential solid waste generation (kg/person/year)*0.001 (Mg/kg)+Workers*Σₑ[Floor area of use*solid waste generation rateᵤ (excluding residential use)]*0.001 (Mg/kg)+Visitors*Visitor waste generation rate (kg/year)*0.001 (Mg C/kg C) (Eq 26)

Organic portion of MSW=MSW*organic proportion (Eq 27)

Carbon content of MSW=organic portion of MSW*carbon content of organic portion of MSW (Eq 28)

Units: Mg carbon/year

### Fossil Fuel Consumption (Flux)

Fossil fuel consumption represents carbon released to the atmosphere from the combustion of fossil fuels on-site (i.e. within a given block, vision extent, or city as a whole). Fossil fuels are consumed to provide energy for human uses including heating, cooling, cooking, lighting and appliances, and the production of electricity and steam. Estimating transportation fossil fuel use is particularly complicated and is treated in a separate section below. Not all energy production relies on fossil fuels; nuclear energy and various forms of solar, wind, and tidal capture can also generate energy for human uses without releasing carbon.

The energy use profile of any ecosystem is based on the energy consumption of people using the ecosystem and the kinds of infrastructure that the ecosystem provides for satisfying that consumption. To estimate fossil fuel consumption this embodiment first estimates total energy consumption for human uses. Energy consumption is estimated for the following uses: heating, cooling, electricity use, electricity production, and steam production. Energy consumption rates vary by ecosystem type, lifestyle choices, and in some cases, with the climate, as described below. Having estimated energy requirements, those demands are apportioned to different fuel types based on the ecosystem type, use case, or transportation mode. Each energy conversion is assigned an efficiency, which enables calculation of the total amount of each fuel consumed. Finally each fuel type is assigned carbon emissions on combustion.

Fossil fuel consumption includes the following sub-categories: Heating energy consumption, Heating fuel consumption, Cooling energy consumption, Lighting and appliances energy consumption, Cooking energy consumption, Energy consumption for electricity production, Energy consumption for steam production, Electricity production, Personal transportation trips (flux), Distance by personal travel mode (flux), Fuel consumption per personal travel mode (flux), Freight trips (flux), Freight trips per mode (flux), Freight distance per mode (flux), Fuel consumption per freight travel mode (flux), Fossil fuel consumption off-site (flux), and Fossil fuel consumption total (flux). Each of these is discussed in turn, below.

### Heating Energy Consumption

Energy consumption for heating is based ecosystem animal biomass, use type, and climate control, with varies in response to the climate. Bodies and equipment can create heat which can reduce energy consumption for heating. Heating required for climate control is calculated using heating degree days (HDD) determined by the climate scenario (current climate values from NYSERDA 2012) and the heat transmittance factor (U-factor) of the ecosystem (following guidance in the New York City Energy Conservation Code, look up values are available in the ASHRAE 90.1 standard, Appendix A-1). The size of the three-dimensional building envelope is determined by the floor to area ratio and the area of the ecosystem. Because many building ecosystems share walls, this embodiment calculates the area and perimeter of each block of buildings (set of adjacent buildings) and the area-weighted mean U-factor and FAR for that block based on the ecosystem types, to estimate the building envelope and heat loss.

Energy consumption for heating=Building envelope perimeter (ft²)*HDD (deg F)*U-factor_wallₑ (Btu/(h ° F. ft²))+Building roof area (ft²)*HDD (deg F)*U-factor_roofₑ (Btu/(h ° F. ft²))−Human biomass heat-factor (Btu/kg/day)*Human biomass (kg)−Use-heat-factorᵤ (Btu/area/day)*Floor areaᵤ*days_heating/days_per_year (Eq 29)

Units: British thermal unit (Btu)

### Heating Fuel Consumption

Heating energy is typically provided by steam, electricity or wood, which may be produced on-site or offsite. These proportions may vary by lifestyle.

Steam energy consumption for heating=(Proportion of heating energy from steam)*Energy consumption for heating (Eq 30)

Electricity energy consumption for heating=(Proportion of heating energy from electricity)*Energy consumption for heating (Eq 31)

Wood energy consumption for heating=(Proportion of heating energy from wood)*Energy consumption for heating (Eq 32)

Units: British thermal unit (Btu)

### Cooling Energy Consumption

Energy consumption for heating is based on the heat added to ecosystems by people (reflected via animal biomass), equipment and cooling degree days (CDD) determined by the climate scenario (current climate values from NYSERDA 2012) and the heat transmittance factor (U-factor) of the ecosystem (following guidance in the New York City Energy Conservation Code; look up values are available in the ASHRAE 90.1 standard, Appendix A-1).

Energy consumption for cooling=Building envelope area (ft²)*CDD (deg F)*U-factorₑ (BTU/(h ° F. ft²))+Animal biomass heat-generation rate (Btu/kg/day)*Animal biomass*Annual days of active use_{d}/365 days+Use-heat-generation rate (Btu/area/day)*Annual days of active use_{d}/365 days (Eq 33)

Units: British thermal unit (Btu)

### Lighting and Appliances Energy Consumption

Electricity consumption is driven by demand for lighting and appliances such as refrigerators, electronics, and washing machines. Electricity consumption is assigned based on the floor area of different use cases (i.e. residential, commercial, etc.) (Navigant Consulting, 2002; under contract with U.S. DOE, see Tables 5-10, 5-11, 5-14 and 5-20; U.S. EIA, 2008, Residential Energy Consumption Survey; and U.S. EIA, 2009, Commercial Buildings Energy Consumption Survey.)

Energy consumption for electricity=(floor_area)ᵤ*(Annual electricity consumption rate for lighting and appliances)ᵤ (kWh/m²) (Eq 34)

Units: kWh of electricity

### Cooking Energy Consumption

Electricity used for cooking is assumed to be included in the electricity use for lighting and appliance calculations described above. Other fuels, particularly natural gas, are also used for cooking. These rates are to be determined.

Natural gas consumption for cooking=Floor area of residential use*(Natural gas consumption rate for cooking for residences)ᵤ (Btu/ft²/day)*Annual days of active use for residential uses+Floor area of restaurant/commercial kitchen use*Natural gas consumption rate for cooking for restaurant/commercial kitchens (Btu/ft²/day)*Annual days of active use for restaurant/commercial kitchen uses (Eq 35)

Units: cubic feet of natural gas

### Energy Consumption for Electricity Production

Some New York City ecosystems produce their own electricity for internal use or export elsewhere and potentially could do more in the future. Currently, some of the more important sources of electricity production are power plants. The list of current New York City power plants is available from the US EPA (2010) eGrid data, which also provides details on electricity production and fuel consumption for that production. The current electricity generation of the power plant ecosystem is characterized according to this data. In addition, a “solar panel” ecosystem overlay is provided for users to add solar generation. Solar generation rates are estimated using the IMBY (In My Backyard) calculator from NREL (2010).

Energy consumption for electricity production=Area of power plant ecosystem (ft²)*Electricity production rate (kWh/ft²)/energy efficiency of electricity production (%) (Eq 36)

Units: British thermal unit (Btu)

### Energy Consumption for Steam Production

Some New York City ecosystems produce their own steam for internal use or export elsewhere. Typically steam is produced through combustion of fossil fuels. Some data on current steam production in New York City is available in MOEC (2010), Chapter 18. Energy consumption related to steam production is estimated by ecosystem type.

Energy consumption for steam production=Area of power plant ecosystem (ft²)*steam production rate (Btu/ft²)/energy efficiency of steam production (%) (Eq 37)

Units: British thermal unit (Btu)

### Electricity Production

Buildings can generate electricity, either by burning other fuels to turn turbines, or through solar, wind, or tidal energy generation.

Electricity production=Area of power plant ecosystem (ft²)*Electricity production rate (kWh/ft²)+Area of PV solar panels (ft²)*PV solar power generation rate (kWh/ft²/day)*365 days (Eq 38)

Units: British thermal unit (Btu)

Personal transportation—People move around the city using a variety of different transportation modes. Calculating the carbon consequences of these movements requires estimating the number of trips, distance travelled per mode, and the vehicle energy sources deployed in those movements, which are all a matter of the transportation capacity of ecosystems and the lifestyle choices made by New Yorkers. Treated transportation modes are listed in Appendix 6.

### Personal Transportation Trips (Flux)

Personal transportation energy consumption is determined by the number of trips generated as either origins or destinations and the transportation modes people use to travel to and from area of interest. Trip generation rates are assigned by ecosystem type and use case, using trip generation rates for building ecosystems provided in the CEQR Technical Manual (MOEC 2010, chapter 16, Table 16-2). MOEC (2010) also provides percentages of trips by most travelled hours for working days and non-working days (Saturdays, Sundays, holidays, etc.) The user can select trip generation rates in the lifestyle profile. This embodiment estimates that there are 240 week days per year and 125 Saturdays (or Saturday equivalents, including Sundays and holidays) per year.

Total trips=Floor area of use*working day trip generation rate_{d}*working days/year+Floor area of use*non-working day trip generation rateᵤ*non-working days/year (Eq 39)

Units: number of trips/year

### Distance by Personal Travel Mode (Flux)

New Yorkers have many different choices in how to make their trips. Which modes are selected for any given trip is a combination of preference and distance travelled. For this embodiment, aspects of access, which can also influence mode choice, are neglected. Some modes are suitable for short trips, like walking, where longer trips typically require some kind of motorized transport to be time-efficient. Sometimes people use multiple modes on each trip, for example, walking to the taxi to go to the airport; this embodiment focuses only on the major mode used for each trip. The NHTS (2009) provide data for the New York MSA/high density population on transportation mode by trip distance categories (see Appendix 7); similar analysis can reveal nationwide “average American” travel habits. The distance of each trip in each category is estimated by the midpoint distance (i.e. trips of 0-0.5 mile are represented as 0.25 mile trips). In the interface, the proportion of trips taken by distance and mode will be selected in the lifestyle profile. Transportation mode may be important because different transportation modes use different kinds of fuels which have different carbon contents; the amount of fuel they use is a function of the distance travelled.

Personal distance travelled by mode=(proportion of trips in distance category for mode)ₗ*total number of trips (person-trips)*mid-point of distance category (miles/trip)/average vehicle occupancy (persons/vehicle) (Eq 40)

Units: distance travelledₘ (vehicle miles)

### Fuel Consumption Per Personal Travel Mode (Flux)

How much fuel is used per mode is a function of the fuel types used for that mode, the average vehicle occupancy of that mode, and the fuel consumption rates per distance travelled. Fuel type utilization proportions and fuel consumption rates (Btu/mile) for different transportation modes are estimated from analysis of the National Household Travel Survey (CTA 2011) and the National Transit Database (2009). In some cases fuels are mixtures (as in reformulated gasoline), so those mixtures are separated into their component parts. The fuel consumption is then summed across all transportation modes. Fuel consumption units vary by the fuel type—see Appendix 5. Users select transportation mode fuel use through the lifestyle profile. Note that some fuels are mixtures of one or more other fuels (for example, “E85” is 85% ethanol and 15% gasoline; reformulated gasoline is 10% ethanol and 90% gasoline.)

Personal travel fuel consumption=Σₘ[distance travelledₘ (miles)*proportion of fuel useₘ*fuel mileage by mode and fuel (fuel amount/mile)*proportion of fuel in mixture, if fuel is a mixture] (Eq 41)

Units: amount of fuel/year [exact units vary by fuel type]

Freight Transportation—Not only do people move personally through the city, they also move their stuff. Freight transportation refers to only to goods moved by a transportation mode to the final destination in the area of interest.

### Freight Trips (Flux)

Freight represents the stuff that travels to and from the area of interest to support activities there. It includes materials required to make goods and services and export of those goods and services to other areas. Estimating the amount of freight reaching an area as small as a block is problematic because the data on current freight flows is not well resolved enough to make block-level analysis.

Freight trips=Floor area of use*freight trip generation rateᵤ(trips/ft²/year) (Eq 42)

Units: freight trips/year

### Freight Trips Per Mode (Flux)

The estimate of freight trips generated within the area of interest is multiplied by modal breakdowns that vary with lifestyle.

Freight trips by mode=modal share of freight mode {lifestyle}*freight trips (Eq 43)

Units: Freight trips by mode/year

### Freight Distance Per Mode (Flux)

The average freight shipment distance by mode, which varies by lifestyle, is multiplied by the number of trips by freight mode to estimate the total distance travelled by that mode.

Freight distance per mode=average shipment distance{lifestyle}*freight trips by mode (Eq 44)

Units: Freight distance by mode

Fuel Consumption Per Freight Travel Mode (Flux)

Fuel type utilization and fuel consumption rates (Btu/mile) for different transportation modes are estimated from analysis of the National Household Travel Survey (CTA 2011), the National Transit Database (2009, and the Vehicle Use and Inventory Survey (U.S. Census 2002). Transportation fuel consumption from personal and freight transportation is added to the other fossil fuel consumptions described above.

Freight transportation fuel consumption=Σₘ [distance travelledₘ (miles)*proportion of fuel useₘ*fuel consumption rate by mode and fuel_{m,f} (fuel amount/mile)*proportion of fuel in mixture] (Eq 45)

Units: amount of fuel/year [exact units vary by fuel type]

### Fossil Fuel Consumption Off-Site (Flux)

Electricity generated from outside of the area of interest can come from within the city or from outside the city; in either case, electricity is generated from consumption of fuels, some of which are fossil fuels. The lifestyle profile determines the distribution of electricity generation between within the city and outside the city; it also determines the fuel mixed used to generate that electricity. The current electricity generation mix is described the latest inventory of greenhouse gases for New York City (City of New York et al., 2011; particularly Appendices H and J) and through eGrid 2010 version 1.1 (USEPA 2010). It is assumed that transmission losses within the city are negligible. Electricity generated outside of the city is assumed to have a transmission loss of 7% (US EIA 2011).

Fossil fuel consumption for off-site electricity generation by fuel type=(total electricity consumption (kWh)−on-site electricity production (kWh))*(proportion of electricity generation within the city)*(proportion fuel source for city electricity generation)/efficiency of electricity production/energy content of fuel (kWh/amount)+electricity consumption (kWh)−on-site electricity production (kWh))*(1−proportion of electricity generation within the city)*(proportion fuel source for outside of the city electricity generation)/efficiency of electricity generation for fuel type/transmission loss*energy content of fuel (amount) (Eq 46)

Units: fuel amount/year (exact units will vary by fuel type)

### Fossil Fuel Consumption Total (Flux)

Once all the energy source (fuel) amounts are computed for heating, cooling, cooking, lighting and appliances, electricity consumption, electricity production, steam production, personal and freight transportation have been calculated in terms of fuel amounts, then those fuel amounts can be translated into carbon emissions generated on-site using known carbon contents (Davis et al. 2011; MOEC 2010, Chapter 18, Table 18-2).

Carbon emissions=Σ_{f}(fuel amount/CO₂ emissions (kg per amount for fuel)*carbon mass content of carbon dioxide)*0.001 Mg/kg (Eq 47)

Units: Mg carbon/year

### Water

Analysis of the water balance will be made for a set of pre-defined precipitation events or design storms (designated by the subscript “s”) of one day duration, as prescribed for the city in DEP (2006) and MOEC (2010; Chapter 13), using typical conditions specified on a monthly average basis and varying by climate scenario (Appendix 8). The magnitude of the precipitation events and the temperatures associated with them varies by the user selected climate scenario. Each precipitation event will describe an average precipitation intensity and duration. Snowfall is not treated. Note that metrics of the water balance can be expressed either as water depths (i.e. inches or millimeters) over a given area, or in volume units (e.g. gallons, liters).

### Potential Evaporation (Flux)

Potential evaporation will be estimated using the Hamon (1963) method as described in Vörösmarty et al. (1996). The Hamon (1963) method depends on the average daylength and the saturated vapor pressure, which itself is a function of the mean temperature. Baseline temperatures on a monthly basis are available from TWC (2012); predications of future climatic conditions are available from Horton et al. (2009). Daylength is available from US Naval Observatory (2012). Saturated vapor pressures can be calculated using the formula below or are available in standard meteorological texts and on-line—for example, CSGNetwork.com (2012).

Potential evaporation=(715.5*Λ*SVP(T))/(T+273.2) (Eq 48)

Where,

Λ=daylength measured as fraction of day (unitless, ranges 0-1)

T=average temperature (deg C)

SVP(T)=saturated vapor pressure at temperature T (kPA), which in the model used here is equal to e^{(77.3450+0.0057 T-7235/T)/T*8.2}

Units: mm

### Precipitation (Flux)

The amount of precipitation depends on the user selected precipitation event and climate scenario. Precipitation is assumed to fall evenly across the area of interest at a continuous rate for the duration of the event.

Precipitation=precipitation rate or intensity_{s,c} (mm/hr)*precipitation duration_{s,c} (hr) (Eq 49)

Units: mm/day

### Piped Water Demand (Flux)

The piped water demand is how much potable water is required for human use. This embodiment estimates water use rates on a per capita basis for residents and on a per area basis for other use cases. Water use rates are provided in the CEQR Table 13-2. Visitor use is neglected. Piped water demand is expressed as a water depth (mm) over the area of interest. Gray water recycling is reflected in the reuse rate.

Piped water demand={[number of residents*residential water use rate (gallons/person/day)]+Σₑ[floor area of use*water consumption rate of use per area per day (gallons/ft²/day)]}−Σₑ [graywater reuse rateₑ (gallons/day)]*(0.134 cubic feet/gallon)/(area of interest (ft2))*(12 inches/foot)*(2.54 mm/inch) (Eq 50)

Units: mm/day

### Outdoor Water Use (Flux)

Some of the piped water supply is used for outdoor uses like watering plants and washing cars and sidewalk surfaces. Each ecosystem type is assigned a proportion of water use used for outdoor applications. For the area of interest, this embodiment calculates an area-weighted average of the outdoor use proportion and applies that proportion to the piped water demand.

Outdoor water use=(Σₑ[Area of ecosystem type (m²)*proportion of outdoor water useₑ]/Area of interest (m²))*Piped water demand (mm) (Eq 51)

Units: mm

### Indoor Water Use (Flux)

The proportion of piped water not used outdoors is assumed to be used indoors.

Indoor water use=Piped water demand (mm)−outdoor water use (mm)−Σₑ (gray water reuse rateₑ (mm)) (Eq 52)

Units: mm/day

### Sewerage (Flux)

The amount of water entering the sewers is assumed to be the same as the indoor water use.

Sewerage=indoor water use (mm) (Eq 53)

Units: mm/day

### Piped Water Leakage (Flux)

Piped water systems typically leak 20-25% and in some cases can leak up to 50% of water being transported (Lerner 1986). This embodiment estimates the fraction of piped water leakage from two sources due to consumption in the area of interest from two flows: piped water demand and stormwater drainage (as described below.) The piped water leakage is assumed to go entirely into the groundwater.

Piped water leakage=proportion of water leaking*[piped water demand (mm)+sewerage (mm)+storm water drainage (mm)](Eq 54)

Units: mm

### Impervious Water Storage (Stock)

Impervious surfaces do not allow water to pass through to the soil. These surfaces can hold only a small amount of water unless they are designed with special water holding structures, like cisterns. It is assumed that cisterns are designed to increase the impervious water holding capacity by 25 mm (1 inch). In addition, it is assumed that the impervious water store can store up to 3 mm of water in puddles, cracks, etc., however at the beginning of the precipitation event these are assumed to be empty. The difference between the water store capacity and its current store is called the impervious water deficit. To calculate water volumes, the total amount of impervious surface in the area of interest is needed. A proportion of impervious surface is assigned according to ecosystem type. Over the area of interest the total amount of impervious surface is calculated on an area weighted average basis.

Impervious water store capacity=3 mm+(cistern present?)*25 mm (Eq 55)

Impervious water store initial conditions=0 mm (Eq 56)

Impervious water store deficit=3−0=3 mm (Eq 57)

Units: mm

Area of impervious surface=Σₑ [Area of ecosystem type (m²)*proportion of impervious surfaceₑ] (Eq 58)

Units: m²

### Pervious Water Storage (Soil Water Storage) (Stock)

The soil also holds water. The water holding capacity of the soil is sometimes called the field capacity. This embodiment estimates the soil water holding capacity on an average area-weighted basis for the pervious surface, based on the soil types associated with the ecosystem types. It assumes that the beginning of precipitation event the soil is at half of its field capacity. The difference between the soil water store capacity and its current store is called the soil water deficit. The amount of soil exposed to the atmosphere is the previous surface, calculated as the difference between the area of interest and the impervious surface.

Area of soil surface (or pervious surface)=area of interest (m²)−area of impervious surface (m²) (Eq 59)

Units: m²

Soil water store capacity=Σₑ[Area of ecosystem type (m²)*(1−proportion of impervious surfaceₑ)*(soil field capacityₑ (mm)]/Area of pervious surface (m²) (Eq 60)

Soil water store initial conditions=soil water store capacity (mm)/2 (Eq 61)

Soil water deficit=soil water store capacity (mm)−soil water store initial conditions (mm) (Eq 62)

Units: mm

### Actual Evaporation (Flux)

When potential evaporation is greater than the sum of precipitation and outdoor water use (herein called the “surface inputs”), then actual evaporation will equal the surface inputs. Additionally the pervious surfaces may provide water for evaporation to top off evaporation. In some applications, the evaporative draw from soil water is treated with a soil drying function that limits the amount of water available (c.f. Vörösmarty et al. (1998)), but in testing, this was found to make only a small difference, such that this embodiment neglects the soil drying function for Manhattan. When surface inputs are greater than or equal to potential evaporation, then actual evaporation is equal to the potential evaporation.

Surface inputs=Outdoor water use (mm)+Precipitation (mm) (Eq 63)

If (Potential evaporation>=Surface inputs), then Actual evaporation=Surface inputs (mm)+; Else Actual evaporation=Potential evaporation (Eq 64)

Units: mm

### Change in Impervious Water Store (Flux)

If the difference between the surface water inputs and actual evaporation is less than the impervious water deficit, then change in the impervious water store will be equal to that difference. (In other words, the water store will collect any surface water inputs not already evaporated away.) If the difference is greater than the impervious water store deficit, then the change in the impervious water store will be equal to the deficit. (It will fill up.)

If (Impervious water deficit>=Surface inputs−Actual evaporation), Then Change in Impervious water store=Surface inputs−Actual evaporation, Else Change in impervious water store=Impervious water deficit (Eq 65)

Units: mm

### Change in Soil Water Store (Flux)

The soil water store is assumed to be half full at the beginning of the precipitation event. If the difference between the surface water inputs and actual evaporation is equal to or less than the soil water deficit, then the change in the soil water store will be equal to that difference. (In other words, the water store will collect any surface water inputs not already evaporated away.) If the difference is greater than the soil water deficit, then the change in the soil water store will be equal to the deficit. (It will fill up.)

If (Soil water deficit>=Surface inputs−Actual evaporation) Then change in Soil water store=Surface inputs−Actual evaporation), Else change in Soil water store=Soil water deficit (Eq 66)

Units: mm

### Runoff (Flux)

For both pervious and impervious surfaces, runoff is calculated as the difference between the surface water inputs and the sum of actual evaporation and the change in the soil water store. The total runoff across the area of interest is calculated as the area weighted average.

Runoff from impervious surfaces=Surface inputs (mm)−(Actual evaporation (mm)+Change in the impervious water store (mm)) (Eq 67)

Note: if soil water deficit >0, then allow runoff from impervious surface to fill that deficit and revise runoff from impervious surface estimate.

Runoff from soil surfaces=Surface inputs (mm)−(Actual evaporation (mm)+Change in the soil water store (mm)) (Eq 68)

Runoff=(Area of impervious surface (m²)*Runoff from impervious surface (mm))+(Area of soil surface (m²)*Runoff from soil surface (mm))/(Area of interest) (m²) (Eq 69)

Units: mm

### Stormwater Drainage (Flux)

Stormwater drainage capacity is an estimated as a function of ecosystem type, calculating an area-weighted average. Each ecosystem type is assigned a stormwater drainage water depth per area value, based on the Rational Method requirement for a 5.65 in storm, which is the New York City Department of Environmental Protection recommendation for stormwater sizing (DEP 2006). If the stormwater drainage capacity is greater than the runoff, then the stormwater drainage is equal to the runoff. If runoff is greater than stormwater drainage capacity, then the stormwater drainage is equal to the capacity.

Stormwater drainage capacity=Σₑ (Area of ecosystem type*Stormwater drainage capacity per area (mm/m²)/(Area of interest m²) (Eq 70)

If (Stormwater drainage capacity>Runoff), then stormwater capture=runoff, Else stormwater capture=stormwater drainage capacity (Eq 71)

Units: mm

### Stream Flow (Flux)

The stream flow is equal to the runoff that is not drawn into the stormwater drainage. It is assumed to flow into a stream or pond if those ecosystems exist within the area of interest; otherwise it represents sheet flow from the area of interest to an adjacent area of interest.

Stream flow=Runoff (mm)−stormwater drainage (mm) (Eq 72)

Units: mm

Infiltration into Groundwater (Flux)

This embodiment assumes that the change in the groundwater is equal to the leakage from the water mains and stormwater drains. Other groundwater fluxes into and out of the area of interest are neglected.

Groundwater flow=Piped water leakage (mm) (Eq 73)

Units: mm

Note: estimate proportion groundwater flow from surface flow in an ecosystem to the ground water, then average across ecosystems to estimate groundwater flows from surface into ground.

### Biodiversity

The diversity of species is a primary measure of the ecological health of a place. In 1609 Manhattan Island was remarkable for its species diversity. The following 400 years have changed that species diversity dramatically, both through loss of some native species and by introduction of species from other parts of the world. Human beings interact with these species in urban environments through direct control measures and indirectly by providing regular food supplies. There is also some evidence of relaxed predation pressure in cities. These factors tend to favor strong competitors whose abundance may lead to competitive exclusion of other species (Faeth et al. 2005; Marzluff 2008; Melles et al. 2003; Chance & Walsh 2006). Finally the built environment substitutes habitats like buildings and pavement for ecosystems like forests and wetlands. There is some evidence that the built environment has species associations most closely related to cliff habitats and secondarily grasslands (c.f. Lundhom & Richardson 2010). Through the method below, an attempt is made to include all of these factors to make some predictions about spontaneously occurring species (i.e. not agriculture or garden species). First an estimate is made for the potential species richness based on area-climate proxy relationships, and then a suggestion is made for a species composition that fills that diversity based on the habitat qualities of the area of interest. Habitat types are listed in Appendix 9. Species are assigned by probability of occurrence, with higher probabilities associated with strongly competitive species in each taxon. This embodiment suggests species compositions for the following taxa: plants, fish, birds, reptiles, amphibians, and mammals (Appendix 10).

### Potential Species Richness (Stock)

This embodiment estimates the biodiversity of the area of interest using species-area curves. The species-area relationship is one of the best documented relationships of community ecology. Across many different kinds of plants and animals, and in many different locations, scientists have shown that the number of species increases as the area sampled increases. An equally well-known principle of community ecology is for the number of species in a region to increase the closer the area is to the equator. Over the last decade scientists have also been studying how the species-area relationship changes with latitude.

The general form of the species-area curve is

Potential species richness=c*A^{z} (Eq 74)

Where c=coefficient of the species-area curve

z=exponent of the species-area curve

A=area of interest

Both c and z vary by taxa.

This embodiment uses latitude as a proxy for climate. By inputting latitudes for other cities that have climates today like Manhattan will have in the future, climate-specific species-area curves can be approximated. For example, the New York City Panel on Climate Change report (Horton et al., 2009) says: “The temperature changes shown in Table 1 indicate that by the 2080s, New York City's mean temperatures throughout a ‘typical’ year may bear similarities to a city like Raleigh, N.C. or Norfolk, Virginia today.” The climate-adjusted species-area curve provides a potential species richness for the area based on the size of the area of interest.

In this embodiment, the species-area relationships described by Qian et al. (2007) is used for plants; that of Solymos & Lele (2012) is used for birds and non-volant mammals (non-volant means non-flying, which excludes bats); that of Angermeier & Schlosser (1989) is used for fishes in streams; and that of Griffiths (1997) is used for fishes in ponds. Species-area relationship descriptions individualized for reptiles, amphibians, and marine fishes appropriate may also be used, though general forms may also apply (see Adler et al. (2005)) or may be estimated from the Mannahatta Project data.

Potential species richnessₜ=antilog (log cₜ+zₜ*log (area of interest)+bₜ*latitude) (Eq 75)

Where cₜ=intercept of the species area relationship on a log-log scale, specific to taxa

zₜ=slope of the species area relationship on a log-log scale, specific to taxa

bₜ=the coefficient of the latitude term (there may also be other interaction terms), specific to taxa

latitude=latitude of New York City in the baseline climate scenario (40.766 deg N), or other locations farther south future climate scenarios

Units: number of plant, fish, reptile, amphibian, or mammal species

Note: some relationships are analyzed by the natural logarithm, others by the logarithm base 10; different equations also use different units of area when describing the relationship. See the reference source for the correct form.

### Habitat Type (Stock)

Habitat type is assigned based on ecosystem type. The habitat types are a shorter list of major ecosystem types (see Appendix 9); in this classification most of the building and transportation types are recoded as a “buildings and pavement” habitat type, or combinations of the “buildings and pavement” habitat and “garden” habitat. For the area of interest, the area of each habitat type is calculated.

Area of habitat typeₕ=Σₑ (Area of ecosystem type (m²)*proportion of habitat type_{e,h}) (Eq 76)

Units: areas of habitat types (m²)

### Potential Species List (Stock)

A species list will be developed for each habitat type. Each species will be qualified by a probability of occurrence within that habitat based on ecological studies from New York City and nearby areas. The potential species list for the area of interest will be compiled from the habitat types of the area. In this embodiment, the probability of occurrence of the species is weighted by the percentage habitat in the area of interest. Species with very low probabilities after weighting will be removed from the list. The potential species lists are then sorted from highest weighted probability to lowest for each taxon. Species will also be coded as potentially unwanted because they are invasive or destructive in urban environments. The probability of these species will be reduced based on the level of effectiveness of unwanted species control, which varies from 0 (no effective control) to 1 (complete control).

Units: species list with probabilities (0-1)

### Species List (Stock)

Species will be assigned to the area of interest working down the potential species list, summing the probabilities of occurrence until the sum equals the potential species richness. In some cases, there may not be sufficient species on the species list to reach the potential species richness because the habitat types support only a limited list of species. Native species lists with probabilities in habitat already exist from the Mannahatta Project data. Non-Mannahatta habitat types plus introduced species may be added to these lists. Species will be labeled as native or introduced.

Units: species list

### Predicted Species Richness (Stock)

After making the species assignments, the number of species in each of the taxa is counted and is counted across taxa to estimate the species richness.

Units: number of species for plants, fish, reptiles, amphibians, and mammals

### % Native Species (Stock)

This embodiment calculates the percentage of native species based on the predicted species list.

Units: proportion % (0-100)

% Introduced species (stock)

In addition, the percentage of introduced species is calculated based on the predicted species list.

Units: proportion % (0-100)

### Ecosystem Modifiers

In this embodiment, five kinds of subpixel ecosystem modifiers are contemplated. These “modifiers” are add-ons which do not completely occupy a 10 m cell, but which affect the ecosystem properties of the ecosystems, as described below.

The ecosystem modifiers include the following: Eelgrass meadows, Streams, Street trees, Green roofs, PV solar panels, Solar heating panels, Cisterns, Bike shares, Bike lanes, Sidewalks, and Trails. Each is discussed in turn below.

Eelgrass meadows modify estuary ecosystems. They represent eelgrass plants and the associated biotic community. Eelgrass meadows: (i) add to the plant biomass density; (ii) add to the photosynthetic rate; (iii) add to the wildlife biomass density; (iv) add eelgrass habitat; and (v) add eelgrass species.

Streams modify a variety of natural ecosystem types. They represent surface conduits for the flow of water. It is assumed that they are perennial when mapped by the user, fed either by groundwater or surface runoff. Ignored is the transport of materials within streams. In the model according to the embodiment herein, streams: (i) enable streamflow, (ii) decrease surface runoff, (iii) add stream habitat, and (iv) add stream species.

Street trees modify sidewalks and parking lot ecosystems. They represent trees planted into small openings in the otherwise impervious surface of these ecosystem types. Street trees: (i) add to the plant biomass density, (ii) add to the photosynthetic rate, (iii) add to the wildlife biomass density, (iv) decrease the impervious surface, and (v) add to the “garden” habitat type.

Green roofs modify all “building” ecosystem types. They represent small herbaceous plants planted into a thin layer of soil or soil-like media on the otherwise impervious surface of buildings. Green roofs affect the following parameters: (i) add to the plant biomass density, (ii) add to the photosynthetic rate, (iii) add to the wildlife biomass density, (iv) add to the “garden” habitat type, (v) increase the impervious water storage capacity, and (vi) increase the roof U-factor.

PV solar panels modify all “building” ecosystem types. They represent photovoltaic panels placed on top of buildings. PV solar panels: Add to the electricity production (flux).

Solar heating panels modify all “building” ecosystem types. They represent solar heating water installations on to pof buildings. Solar heating panels: Reduce heating energy consumption (flux).

Cisterns modify all “building” ecosystem types. They represent small herbaceous plants planted into a thin layer of soil or soil-like media on the otherwise impervious surface of buildings. Cisterns: Add to the impervious storage capacity

Bike shares modify sidewalks and parking lots. They present facilities to store bicycles when not in use. Bike shares: (i) Add to the transportation modal share for bicycling, and (ii) Reduce the transportation modal share for other modes.

Bike lanes modify transportation ecosystems. They represent dedicated areas for bicycles along transportation paths. Bike lanes: (i) Add to the transportation capacity for bicycling, and (ii) Reduce transportation capacity for other modes.

Sidewalks modify transportation ecosystems. They represent dedicated areas for pedestrian movements. Sidewalks: (i) Add to the transportation capacity for sidewalks, (ii) Reduce transportation capacity for other modes.

Trails modify all natural ecosystem types except pond and estuary. They represent improved footpaths where people can walk single file. Trails: Add to the transportation capacity for walking and bicycling.

### Extrapolation to Larger Geographic Areas

It may in some circumstances be desirable to understand the results not only over a single block or the area of interest, but in terms of larger geographic areas. Understandably most users will not be sufficient time or interest to remodel, for example, an entire city, so to satisfy the urge for a city-wide view this embodiment allows for the ability to extrapolate the results from the limited area of interest covered by the extent of the user's vision to a larger geographic area. In particular, this embodiment uses a simple method for extrapolation: extrapolation by area. If for example the area of interest represents 1% of Manhattan, then the results are extrapolated by 100 times to generate ecosystem stocks and fluxes for Manhattan as a whole. This may produce some unexpected results, especially if the area of interest is selected and/or remapped in a non-representative way. For example, if the user creates a series of high-rise ecosystems and pushes to extrapolate to city, high rises will fill up Central Park. Only if the user added some parkland to his or her area of interest, would some park land be included in the estimate for the city as a whole. There also may be some important scale dependent effects, which this extrapolation method will not treat and may lead to some incongruous results.

### Validation

Some embodiments may include validation. Validation in general is difficult because the ecosystem flow information required for validation is generally unavailable and very expensive to collect. For some geographic areas, such data may nevertheless be available in forms more readily usable than for other areas. As one example, for Manhattan Island, the detailed work of the Mannahatta Project is available for comparison of results in the form of a baseline scenario of the 1609 reference. The Mannahatta Project provides detailed block level summaries of species probabilities, measures of hydrological condition like the presence of surface water (e.g. streams, springs), and the distribution of forest types. Validation in a broad sense may also be obtained against modern ecosystem flows in undisturbed or protected sites. Although no site is a perfect analogy, extensive work has been conducted at Harvard Forest, Petersham, Mass.; Hubbard Brook Experimental Forest, North Woodstock, N.H.; Plum Island, Woods Hole, Mass.; and Hutcheson Memorial Forest, New Brunswick, N.J. Also interesting in this regard is the work of the Baltimore Ecosystem Study, an urban ecological research site.

For the modern city, results may be validated against various rules of thumbs and summary methods used by city agencies for measuring aspects of the ecosystem flows. These include: Population, Carbon, Water, and Biodiversity. They are detailed below in turn.

Population—In some ways population is easiest to validate. The 2010 US Census provides population estimates of the residential population at the block group level (i.e. typically several blocks). Residential population estimates may be compared to the Census estimates for corresponding areas. The working population is more difficult to estimate, especially at the block level. From studies of the commute an estimate can be obtained on how many people enter and leave the city, and therefore an estimate can likewise be obtained on an approximate island-wide day time population. Department of City Planning also has some estimates of the day-time population of parts of Manhattan, though the data is somewhat out of date.

Carbon—For the carbon model some of the rules of thumb can be used, such as those from the CEQR Technical Manual (MOEC 2010), and these rules of thumb can be used as benchmarks. For example Table 15-1 provides overall energy consumption figures for different building types on a per square foot basis. Because the model of this embodiment estimates the different subcomponents of energy consumption, these estimates can be added together to compare with these guidelines. Similarly Table 18-3 provides carbon intensity values (greenhouse emissions) for different building types within New York. Overall estimates of greenhouse emissions can also be compared to the New York City Greenhouse Inventory.

Water—New York City DEP uses the “Rational Method” for estimating stormwater runoff. The rational method is a simplified hydrological model that lumps evapotranspiration, infiltration, and storage as “losses.” The Rational Method runoff predictions can be compared to the predictions obtained by the embodiment herein for the design storms at scales of one to a few blocks. A slightly more sophisticated runoff model is provided by the National Resource Conservation Service (NRCS method). Runoff estimates can also be compared to estimates determined through the NRCS method.

Biodiversity—For some taxa, there are contemporary studies of species richness within Manhattan, including the plants of Central Park, Audubon Christmas Counts and birds striking large buildings. Other taxa are generally poorly studied in the city except in parklands (e.g., mammals, reptiles, amphibians).

### User Notifications and Think Again Alerts

The methods described above do not proscribe any changes, in the sense that a user is permitted to make whatever changes he or she wants to the map using the ecosystem tools. This means that some changes may be ill-advised. To provide some timely advice about actionable items, this embodiment displays notifications and alert boxes that provide automated text messages to the user in the “alert box” of the website interface.

These automated messages are tied to the methods, so that if some condition is exceeded, a message is generated. Since there might be a large number of potential advisory messages, display of these notices is limited as a matter of use satisfaction, focusing only on the most extreme cases that the user should be cognizant of. As embodiments evolve over time, it is expected that the list might change.

### Population

No one knows for sure what the absolute limits to population are. Typically density-dependent negative feedbacks (i.e. disease, war, shortages of food and water) typically kick in before absolute limits are reached. Fletcher (1995), an anthropologist, wrote an interesting cross-culture comparative analysis exploring these issues, suggesting there may be some limits related to interaction density on the high side, and communication density on the low. “I-limits” work out to about 640,000 people/square mile for hunting and gathering societies, and about 64,000 people/square mile in modern industrial ones. Note that some New York neighborhoods already exceed this limit. “C-limits” are less clearly defined and are approximately 640 people/square mile. These values may be compared to residential densities calculated by the embodiment herein.

If (Residential population/area of interest (square miles))>64,000, then send alert: “Residential density (XX) exceeds maximum settlement density interaction limit estimated by Fletcher (1995).”

If (Residential population/area of interest (square miles))<640, then send alert: “Residential density (XX) is less than minimum settlement density communication limit estimated by Fletcher (1995).”

Another arbitrary but significant population threshold is the urban population density defined by the U.S. Census Bureau. According to the Census, population densities less than 1000 people per square mile are considered rural; densities greater than 1000 people per square mile are considered urban.

If (Residential population/area of interest (square miles))<1000, then send alert: “Residential density (XX) has dropped below the definition of ‘urban areas’ defined by the U.S. Census Bureau.”

A relative difference might focus on changes from the current population. For example,

If (Residential population/area of interest (square miles))<0.5*Current residential population, then send alert: “Residential density (XX) is less than 50% of the current residential density.”

If (Residential population/area of interest (square miles))>2*Current residential population (persons/square mile), then send alert: “Residential density (XX) is more than 2 times the current residential density.”

Alerts may also be given when floor to area ratios exceed current levels. For this purpose, the Map-PLUTO data is analyzed to determine current maximum FAR values for each ecosystem type. Alerts may then be generated as follows:

If (FARₑ>FAR maximumₑ), then send alert: “The current floor to area ratio for this ecosystem type (XX) exceeds the maximum observed in the city today (YY).”

### Carbon

Current limits to energy use appear to be economic, rather than physical or moral, and so are outside the scope of this embodiment. Some alerts may be given about relative changes in energy use. For example,

If (Total energy consumption >2*Current energy consumption, then send alert: “Energy consumption (XX) is more than 2 times the current residential density.”

For transportation some feedback can be provided about demand relative to capacity. For the area of interest, its transportation capacity can be estimated for different modes and then that capacity can be compared to the predicted demand. Fortunately MOEC (2010) provides methods for estimating the number of trips in the busiest hour of the day. After distributing those trips by mode using the lifestyle parameters, they can be compared to the transportation capacities based on the ecosystems (i.e. infrastructure) in the area of interest.

If (Number of driving trips>driving trip capacity), then send alert: “Demand for trips by personal motor vehicle (XX) exceeds the transportation capacity for personal motor vehicles (YY).”

### Water

Because so much about the way that precipitation depends on the amount of impervious surface, this embodiment sends an alert when the amount of impervious surface exceeds 90%.

If (Impervious Surface >0.9), then send alert: “Impervious surface greater than 90%.”

This embodiment also sends alerts when there is positive stream flow, suggesting that the capacity of the stormwater system and ground infiltration system has been exceeded.

If (Stream flow >0), then send alert: “Streams and ponds are receiving surface flow. If there are no streams and ponds, then XX gallons of water are flowing downhill into adjacent areas.”

### Biodiversity

Finally, this embodiment will send alerts notifying the user of large relative changes to the species richness of the area of interest. These comparisons will be made relative to the current city and the 1609 Mannahatta condition.

If (Total species richness >2*current species richness), then send alert: “Species richness (XX) is more than 2 times the current species richness.”

If (Total species richness >0.75*Mannahatta species richness), then send alert: “Species richness (XX) is within 25% of Mannahatta species richness.”

### Other Embodiments

Based on the embodiment described herein, and informed by this disclosure, those of ordinary skill will recognize that the claims contemplate other and alternative embodiments, including embodiments enhanced with respect to data, metrics, models and so forth. For example, based on the embodiment herein, other embodiments may add on other metrics of urban life, for example, related to health (e.g. air pollution, heat indexes, biophillia) and quality of life (e.g. walkability indices, distance parks, viewsheds). Some economic measures might also be calculable, for example, by estimating relative costs of construction for various ecosystem types, estimating the cash valuation of ecosystem services related to carbon, water, etc., and examining real estate prices relative to access to parkland, jobs, transportation, etc.

Other embodiments may impose constraints on how much a user can actually change the form of the city and the lifestyles of the people that live there. The embodiment described herein, for example, allows the user to make modifications to the geographic location without regard to economic, political, legal or other “practical” limitations which very much influence the current landscape and use of the geographic location. In other embodiments, however, these kinds of limitations could be included by extending the model to take in the idea of constraints. For example, users could select to operate in a “zoning code” constrained mode, where only ecosystem changes compatible with existing zoning codes would be allowed. Users might select to only allow a limited number of changes, to simulate the pace at which the city actually changes. Users might select to operate in private property mode, where they could only change properties they owned (which might severely limit interactions for most users.) In any case an “unconstrained” mode would be retained, allowing unfettered imagination.

Other embodiments may extend the model to allow users to customize their own lifestyle, climate, and ecosystem types. Architects for example might create an “ecosystem” that corresponds with a project design they have developed and then could drop it into the city, pitching to a client how their design will result in quantitative changes in water, carbon, biodiversity and population. A group of school children might pursue a study of how different lifestyles, modeled on the student body, would result in different water, carbon, biodiversity, and population changes for their neighborhood. Emergency management professionals might be interested in particular extreme storm events. Such embodiments may advantageously generate a wide range of uses and extend the utility of the website greatly.

### <Computer Implementation>

The example embodiments described herein may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage. From a software standpoint, a CPU typically includes software resident on a storage media (e.g., a disk drive or memory card), which, when executed, directs the CPU in performing transmission and reception functions. The CPU software may run on an operating system stored on the storage media, such as, for example, UNIX or Windows (e.g., NT, XP, Vista), Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, that may include an article of manufacture on a machine accessible or non-transitory computer-readable medium (i.e., also referred to as “machine readable medium”) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

### APPENDICES

### Appendix 1

### Mannahatta 2409 Metrics

| Ecological | | Stock/ | | |
|---|---|---|---|---|
| aspect of city | Metric | Flux | Units | Detailed by |
| Population | Residential population | Stock | number of people | |
| Population | Worker | Stock | number of people | by use case |
| Population | Visitors | Stock | number of people | by use case |
| Carbon | Plant biomass | Stock | Mg C | |
| Carbon | Leaf litter & down wood | Stock | Mg C | |
| Carbon | Soil organic matter | Stock | Mg C | |
| Carbon | Animal biomass | Stock | Mg C | by animal type |
| Carbon | Fossil fuels | Stock | Mg C | by energy use |
| Carbon | Food | Stock | Mg C | by food type |
| Carbon | Solid waste | Stock | Mg C | by use case |
| Carbon | Net primary productivity | Flux | Mg C/year | |
| Carbon | Litterfall | Flux | Mg C/year | |
| Carbon | Decomposition | Flux | Mg C/year | |
| Carbon | Harvest | Flux | Mg C/year | |
| Carbon | Herbivory | Flux | Mg C/year | by animal type |
| Carbon | Soil respiration | Flux | Mg C/year | |
| Carbon | Animal respiration | Flux | Mg C/year | by animal type |
| Carbon | Food consumption | Flux | Mg C/year | by food type |
| Carbon | Solid waste generation | Flux | Mg C/year | by use case |
| Carbon | Energy use | Flux | kWh/year | by energy use |
| Carbon | Renewable energy % | Flux | % | by energy use |
| Carbon | Total trips | Flux | trips/year | by mode |
| Carbon | Transportation capacity | Flux | trips/hour | by mode |
| Carbon | Total distance travelled | Flux | miles/year | by mode |
| Carbon | Freight moved | Flux | ton-miles/year | by mode |
| Carbon | Fossil fuel consumption | Flux | Mg C/year | by energy use |
| Water | Precipitation | Flux | mm/day | |
| Water | Outdoor water use | Flux | mm/day | |
| Water | Indoor water use | Flux | mm/day | |
| Water | Graywater re-use | Flux | mm/day | |
| Water | Sewerage | Flux | mm/day | |
| Water | Piped water leakage | Flux | mm/day | |
| Water | Potential evaporation | Flux | mm/day | |
| Water | Actual evaporation | Flux | mm/day | |
| Water | Change in impervious water storage | Flux | mm/day | |
| Water | Change in pervious water storage | Flux | mm/day | |
| Water | Runoff | Flux | mm/day | |
| Water | Stormwater drainage | Flux | mm/day | |
| Water | Stream flow | Flux | mm/day | |
| Water | Groundwater flow | Flux | mm/day | |
| Water | Impervious water storage | Stock | mm | |
| Water | Pervious water storage | Stock | mm | |
| Biodiversity | Potential species richness | Stock | number of species | by taxa |
| Biodiversity | Area of habitat | Stock | ha | by habitat type |
| Biodiversity | Predicted species richness | Stock | number of species | by taxa |
| Biodiversity | Predicted species | Stock | [list of species] | by taxa |
| Biodiversity | % Introduced species | Stock | % | by taxa |
| Biodiversity | % Native species | Stock | % | by taxa |

### Appendix 2

### Mannahatta 2409 Parameters

| Method | Varies by: | and also by: | Parameter Name | Model units |
|---|---|---|---|---|
| Population | Ecosystem | Use case | Use fraction | proportion (0-1) |
| Population | Ecosystem | | Maximum floor to area ratio | unitless (>=1) |
| Population | Ecosystem | | Floor to area ratio | unitless (>=1) |
| Population | Lifestyle | | Residential density | people/m2 |
| Population | Lifestyle | Use case | Worker density | people/m2 |
| Population | Lifestyle | Use case | Visitor ratio | visitor/person |
| Population | Lifestyle | | Residential vacancy rate | proportion (0-1) |
| Population | Lifestyle | | Unemployment rate | proportion (0-1) |
| Population | Lifestyle | | Average household size | people/household |
| Carbon | Climate | | Annual cooling degree days | ° F. |
| Carbon | Climate | | Annual heating degree days | ° F. |
| Carbon | Ecosystem | Mode | Hourly peak transportation | vehicles/hour |
| | | | capacity | |
| Carbon | Ecosystem | | Carbon density of leaf litter & | Mg/m2 |
| | | | down wood | |
| Carbon | Ecosystem | | Carbon density of plant | Mg/m2 |
| | | | biomass | |
| Carbon | Ecosystem | | Carbon density of soil organic | Mg/m2 |
| | | | matter | |
| Carbon | Ecosystem | | Wildlife biomass density | kg/m2 |
| Carbon | Ecosystem | | Annual decomposition rate | g/m2/yr |
| Carbon | Ecosystem | | Annual litterfall rate | g/m2/yr |
| Carbon | Ecosystem | | Annual harvest rate | g/m2/yr |
| Carbon | Ecosystem | | Annual herbivory rate | g/m2/yr |
| Carbon | Lifestyle | | Annual protein consumption | kg |
| | | | per person at home | |
| Carbon | Lifestyle | | Annual carbohydrate | kg |
| | | | consumption per person at | |
| | | | home | |
| Carbon | Lifestyle | | Annual fat consumption per | kg |
| | | | person at home | |
| Carbon | Lifestyle | | Annual fiber consumption per | kg |
| | | | person at home | |
| Carbon | Lifestyle | | Annual protein consumption | kg |
| | | | per person away from home | |
| Carbon | Lifestyle | | Annual carbohydrate | kg |
| | | | consumption per person away | |
| | | | from home | |
| Carbon | Lifestyle | | Annual fat consumption per | kg |
| | | | person away from home | |
| Carbon | Lifestyle | | Annual fiber consumption per | kg |
| | | | person away from home | |
| Carbon | Global | | Food protein carbon content | kg C/kg food |
| Carbon | Global | | Food carbohydrate carbon | kg C/kg food |
| | | | content | |
| Carbon | Global | | Food fat carbon content | kg C/kg food |
| Carbon | Global | | Fiber fat carbon content | kg C/kg food |
| Carbon | Ecosystem | Use | Days of active use | days |
| Carbon | Global | Fuels | CO₂ emissions per fuel type | kg/[fuel amount] |
| Carbon | Global | Fuels | Efficiency of power | proportion (0-1) |
| | | | generation | |
| Carbon | Global | Fuels | Energy content of fuel | Btu/[fuel amount] |
| Carbon | Global | Fuels | Fuel composition in terms of | proportion (0-1) |
| | | | other fuels | |
| Carbon | Global | Pets | Average pet biomass | Kg |
| Carbon | Global | | Carbon content of CO2 | proportion (0-1) |
| Carbon | Global | | Carbon density of animal | kg/kg |
| | | | biomass | |
| Carbon | Global | | Average floor height | ft |
| Carbon | Global | | Saturdays | Days |
| Carbon | Global | | U-factor, roof | Btu/(h ° F. ft²) |
| Carbon | Global | | U-factor, wall | Btu/(h ° F. ft²) |
| Carbon | Ecosystem | | Possible shared wall | Binary (0/1) |
| Carbon | Global | | Animal biomass heat factor | Btu/kg/day |
| Carbon | Lifestyle | Use | Use heat factor | Btu/ft²/day |
| Carbon | Lifestyle | | Working Days | Days |
| Carbon | Lifestyle | | Proportion of electricity | proportion (0-1) |
| | | | generation within the city | |
| Carbon | Lifestyle | Fuels | City electricity fuel mix | proportion (0-1) |
| Carbon | Lifestyle | Fuels | Cooking energy fuel mix | proportion (0-1) |
| Carbon | Lifestyle | Fuels | Cooling energy fuel mix | proportion (0-1) |
| Carbon | Lifestyle | Fuels | Extra-city electricity fuel mix | proportion (0-1) |
| Carbon | Lifestyle | Fuels | Heating energy fuel mix | proportion (0-1) |
| Carbon | Lifestyle | Fuels | Lighting and appliances fuel | proportion (0-1) |
| | | | mix | |
| Carbon | Lifestyle | Pets | Household pet ratio | pets/household |
| Carbon | Lifestyle | Mode x fuel | Fuel mileage | [fuel amount]/mile |
| Carbon | Lifestyle | Mode | Vehicle occupancy | People |
| Carbon | Lifestyle | Mode x fuel | Transportation fuel mix | proportion (0-1) |
| Carbon | Lifestyle | Distances | Trip distance profile | proportion (0-1) |
| Carbon | Lifestyle | Distances x | Trip distance modal splits | proportion (0-1) |
| | | mode | | |
| Carbon | Lifestyle | Use case | Energy for cooking | Btu/ft2 |
| Carbon | Lifestyle | Use case | Energy for lighting and | Btu/ft2 |
| | | | appliances | |
| Carbon | Lifestyle | Use case | Maximum percentage of trips | proportion (0-1) |
| | | | in any one hour | |
| Carbon | Lifestyle | Use case | Saturday trip generation rates | trips/area |
| Carbon | Lifestyle | Use case | Weekday trip generation rates | trips/area |
| Carbon | Lifestyle | | Average human biomass | kg |
| Carbon | Lifestyle | | City electricity generation | proportion (0-1) |
| | | | ratio | |
| Water | Global | Month | Mean Monthly Day Length | proportion (0-1) |
| Water | Climate | Month | Mean Monthly Temperature | deg C. |
| Water | Climate | Ppt event | Precipitation Duration | hr |
| Water | Climate | Ppt event | Precipitation Intensity | mm/hr |
| Water | Ecosystem | | Daily commercial water use | gallons/day |
| Water | Ecosystem | | Impervious surface fraction | proportion (0-1) |
| Water | Ecosystem | | Outdoor water use fraction | proportion (0-1) |
| Water | Ecosystem | | Rational Method coefficient | unitless |
| Water | Global | | Impervious surface water | mm |
| | | | storage depth | |
| Water | Global | | Leakage fraction | proportion (0-1) |
| Water | Lifestyle | | Daily residential water use | gallons/person |
| Water | Lifestyle | | Daily visitor water use | gallons/person |
| Water | Lifestyle | | Daily worker water use | gallons/person |
| Biodiversity | Climate | Habitat x | Species lists | proportion (0-1) |
| | | taxa | | |
| Biodiversity | Climate | | Latitude | degrees |
| Biodiversity | Ecosystem | | Habitat proportions | proportion (0-1) |
| Biodiversity | Global | | Latitudinal extent | degrees |
| Biodiversity | Lifestyle | | Unwanted species control | proportion (0-1) |
| All | Global | | Conversion: Btu to kWh | Btu/kWh |
| All | Global | | Conversion: deg F. to deg C. | deg F./deg C. |
| All | Global | | Conversion: gallons to liters | gallons/liters |
| All | Global | | Conversion: hours to days | hr/day |
| All | Global | | Conversion: inches to feet | in/ft |
| All | Global | | Conversion: inches to mm | in/mm |
| All | Global | | Conversion: minutes to hours | min/hr |
| All | Global | | Conversion: seconds to | sec/min |
| | | | minutes | |

### Appendix 3

### Use Cases

Uses

Residential use
Office use
Retail use
Restaurant use
Hotel use
Public assembly use
Garage/storage use
Factory/industrial use
Transportation use
Hunting and gathering use
Agriculture/Horticulture use
Hospital use

### Appendix 4

### Pets

Pets

Dogs
Cats

### Appendix 5

### Fuels

| Fuels | Fuel units |
|---|---|
| Biodiesel | gallons of biodiesel |
| Coal | tons of coal |
| Diesel/light fuel oil | gallons of diesel |
| Electricity | kWh |
| Ethanol | gallons of ethanol |
| Gas-electric hybrid | gallons of gasoline |
| Gasoline | gallons of gasoline |
| Hydroelectric | kWh |
| Hydrogen | cubic feet |
| Jet fuel | gallons of jet fuel |
| Kerosene | gallons of kerosene |
| Municipal solid waste | tons of MSW |
| Muscle | hours of effort |
| Natural gas | cubic feet of natural gas |
| Natural gas, compressed | cubic feet of compressed natural gas |
| (CNG) | |
| Natural gas, liquefied | gallons of liquefied natural gas |
| (LNG) | |
| Nuclear material | grams of nuclear material |
| Propane/LPG | cubic feet of natural gas |
| Residual fuel oil | gallons of residual fuel oil |
| Solar | kWh |
| Steam | cubic feet of steam |
| Wind | kWh |
| Wood | tons of wood |

### Appendix 6

### Transportation Modes

Transportation modes

Airplane
Bicycle
Bus
Ferry
Personal motor vehicle
Streetcar
Subway
Taxi
Train
Walking

### Appendix 7

### Trip Distance Categories

```
Trip distances (miles)
0.0-0.5
0.51-1.0
1.1-2.0
2.1-5.0
  5.1-10.0
10.1-20.0
20.1-50
  50.1-100.0
100.1-200.0
>200.0
```

### Appendix 8

### Precipitation Events for Baseline Climate

| Precipitation Events | Precipitation Intensity (mm/hr) | Duration (hr) |
|---|---|---|
| Clear day | 0 | 24.0 |
| Showers | 3 | 3.8 |
| Rainy day | 3 | 11.3 |
| Soaking storm | 4 | 19.5 |
| Thunderstorm | 64 | 0.75 |
| Severe storm | 144 | 2.5 |

Footnote to Appendix 8: Based on designs storms described in MOEC (2010) Chapter 13 and DEP (2006). The names are assigned for ease of use.

### Appendix 9

### Habitat Types

Habitat Types

Beach
Cliffs
Conifer forest
Cultivated field
Disturbed Land
Eelgrass meadow
Estuary
Forested swamp
Herbaceous marsh
Garden
Lawn
Meadow
Mixed deciduous forest
Oyster bed
Pavement and buildings
Pond
Salt marsh
Shrubland
Riparian streamside

### Appendix 10

### Biological Taxa

Taxa

Amphibians
Birds
Fish
Mammals
Plants
Reptiles

### Appendix 11

### Animal Type

Animal Type

Human
Pets
Wildlife

### Appendix 12

### Freight Transportation Mode

Freight Transportation Mode

Truck
Barge
Train
Pipeline
Airplane
Bicycle

### Appendix 13

### Possible Combinations of Ecosystems and Modifiers

Note for Appendix 13: Numbers in the “can be modified by” column refer to the ide_ecosystem numbers in the first column of the table. For example, the ecosystem “estuary” can be modified by “eelgrass meadow” (ide_ecosystem=2) and “pier” (ide_ecosystem=62).

| ide_ecosystem | type | Ecosystem or modifier name | Can be modified by |
|---|---|---|---|
| 1 | nature | Estuary | 2, 62 |
| 2 | modifier | Eelgrass meadow | — |
| 3 | nature | Beach | 7, 15, 48 |
| 4 | nature | Salt marsh | 7, 15, 48 |
| 5 | nature | Freshwater marsh | 7, 15, 48 |
| 6 | nature | Hardwood swamp | 7, 15, 48 |
| 7 | modifier | Stream | — |
| 8 | nature | Pond | 48 |
| 9 | nature | Disturbed Land | 7, 15, 48 |
| 10 | nature | Meadow | 7, 15, 48 |
| 11 | nature | Shrub land | 7, 15, 48 |
| 12 | nature | Oak hickory forest | 7, 15, 48 |
| 13 | nature | Hemlock - northern hardwood | 7, 15, 48 |
| | | forest | |
| 15 | modifier | Trail | — |
| 16 | other | Camp | 35, 48 |
| 17 | buildings | Cottages/Mobile home | 35, 37, 38, 48 |
| 18 | buildings | Single family home | 35, 37, 38, 48 |
| 19 | buildings | Apartment building | 35, 36, 37, 38, 48, 80 |
| 20 | buildings | Retail building | 35, 36, 37, 38, 48, 80 |
| 21 | buildings | Office building | 35, 36, 37, 38, 48, 80 |
| 22 | buildings | Mixed use: retail/residential | 35, 36, 37, 38, 48, 80 |
| | | building | |
| 23 | buildings | Mixed use: retail/office building | 35, 36, 37, 38, 48, 80 |
| 24 | buildings | Hotel | 35, 36, 37, 38, 48, 80 |
| 25 | buildings | Hospital | 35, 36, 37, 38, 48, 80 |
| 26 | buildings | School or university | 35, 36, 37, 38, 48, 80 |
| 27 | buildings | Factory | 35, 36, 37, 38, 48, 80 |
| 28 | buildings | Public assembly hall | 35, 36, 37, 38, 48, 80 |
| 29 | buildings | Warehouse | 35, 36, 37, 38, 48, 80 |
| 30 | buildings | Computer data center | 35, 36, 37, 38, 48, 80 |
| 32 | buildings | Greenhouse/vertical farm | 35, 48, 80 |
| 33 | buildings | Garage | 35, 36, 37, 38, 48, 80 |
| 34 | buildings | Stadium | 35, 36, 37, 38, 48, 80 |
| 35 | modifier | Cistern/rain barrels | — |
| 36 | modifier | Green roof | — |
| 37 | modifier | Photovoltaic panels | — |
| 38 | modifier | Solar heating panels | — |
| 39 | transportation | Alley | 7, 48, 52, 53, 79 |
| 40 | transportation | Street (collector) | 7, 46, 47, 48, 52, 53, 79 |
| 41 | transportation | Boulevard (arterial) | 7, 46, 47, 48, 52, 53, 79 |
| 43 | transportation | Highway | 7, 46, 47, 48, 52, 53, 79 |
| 44 | transportation | Traffic slowed street | 7, 46, 47, 48, 52, 53, 79 |
| 45 | transportation | Pedestrian street/plaza | 7, 46, 47, 48, 52, 53, 79 |
| 46 | modifier | Elevated train | — |
| 47 | modifier | Streetcar line | — |
| 48 | modifier | Subway | — |
| 49 | transportation | Parking lot | 7, 48, 52, 53, 79 |
| 50 | transportation | Airfield | 48 |
| 52 | modifier | Bike lane | — |
| 53 | modifier | Street trees | — |
| 54 | transportation | Sidewalk | 7, 48, 53, 76, 79 |
| 55 | other | Agricultural field/ | 7, 15, 48 |
| | | vegetable garden | |
| 56 | nature | Orchard | 7, 15, 48 |
| 57 | nature | Ornamental garden | 7, 15, 48 |
| 58 | nature | Lawn | 7, 48 |
| 59 | nature | Swimming pool | 48 |
| 60 | nature | Paved ball field/court | 48 |
| 61 | nature | Cemetery | 48 |
| 62 | modifier | Pier | — |
| 63 | other | Water treatment plant | 35, 36, 37, 38, 48, 80 |
| 64 | other | Sewage treatment plant | 35, 36, 37, 38, 48, 80 |
| 65 | other | Solid waste transfer plant | 35, 36, 37, 38, 48, 80 |
| 66 | other | Waste energy power plant | 35, 36, 37, 38, 48, 80 |
| 67 | other | Natural gas power plant | 35, 36, 37, 38, 48, 80 |
| 68 | other | Diesel power plant | 35, 36, 37, 38, 48, 80 |
| 69 | other | Wind farm | 35, 36, 37, 38, 48, 80 |
| 70 | other | Tidal energy facility | 35, 36, 37, 38, 48, 80 |
| 71 | other | Solar energy facility | 35, 36, 37, 38, 48, 80 |
| 72 | other | Steam generation plant | 35, 36, 37, 38, 48, 80 |
| 73 | other | Landfill | 35, 36, 37, 38, 48, 80 |
| 74 | other | Utility yard | 35, 36, 37, 38, 48, 80 |
| 75 | other | Gas station | 35, 36, 37, 38, 48, 80 |
| 76 | modifier | Compost bin | — |
| 77 | transportation | Light rail line | 46, 48 |
| 78 | transportation | Heavy rail line | 46, 48 |
| 79 | modifier | Bioswale | — |
| 80 | modifier | Geothermal pump | — |

1. A method for developing a vision for a geographic location, comprising:
defining vision parameters for a vision for the geographic location;
accessing a database of ecosystem data; and
calculating an environmental performance indicator for the geographic location based on the vision parameters of the defined vision and based on the database of ecosystem data,
wherein the environmental performance indicator includes metrics for ecologically significant performance indications for the vision applied to the geographic location.

2. The method according to claim 1, further comprising modifying the vision based on the environmental performance indicator.

3. The method according to claim 1, wherein the vision is defined by:
modifying one or more vision parameters associated with a predefined vision, thereby generating one or more modified vision parameters, respectively; and
generating a modified vision based on the one or more modified vision parameters.

4. The method according to claim 1, further comprising the step of sharing the vision over a computer network.

5. The method according to claim 4, further comprising the steps of storing retrieving, searching and displaying the vision and the calculated environmental performance indicators.

6. The method according to claim 4, further comprising the step of collaborating with others in defining modifications of the vision.

7. The method according to claim 1, wherein the one or more vision parameters is any one or a combination of (i) a geographic boundary, (ii) a distribution of one or more ecosystems, (iii) an associated lifestyle, and (iv) an associated climate scenario.

8. The method according to claim 1, wherein the geographic location is defined by using a tool to select boundaries for regions superimposed over a display of map data.

9. The method according to claim 8, further comprising the steps of:
selecting any one or a combination of a lifestyle and a climate associated with the selected region; and
generating quantities of qualities using the lifestyle or climate selected.

10. The method according to claim 8, further comprising the step of modifying any one or a combination of (i) a geographic region of the selected region, (ii) a distribution of ecosystems of the selected region, (iii) a selection of a lifestyle of the selected region, or (iv) a selection of a climate.

11. The method according to claim 8, wherein the geographic location is subdivided into a plurality of cells arranged in a pattern, each of the plurality of cells representing a subregion with a plurality of vision parameters.

12. The method according to claim 11, wherein vision parameters for a subregion are defined by selecting one or more tools.

13. The method according to claim 12, further comprising the steps of:
interacting with one or more of the plurality of cells by selecting, using a tool, a selected ecosystem and replacing selected ones of the one or more ecosystems with the selected ecosystem on a cell-by-cell basis.

14. The method according to claim 12, further comprising the steps of:
interacting with one or more of the plurality of cells by selecting, using a tool, a selected modifier and modifying one of the one or more ecosystems with the selected modifier on a cell-by-cell basis.

15. The method according to claim 1, wherein at least some of the vision parameters define lifestyle of people living in the geographic location.

16. The method according to claim 1, wherein at least some of the vision parameters define climate of the geographic location.

17. The method according to claim 1, further comprising:
calculating an environmental performance indicator for the geographic location using vision parameters that defined a baseline ecosystem; and
displaying the environmental performance indicator for the vision for comparison with the environmental performance indicator for the baseline ecosystem.

18. The method according to claim 1, further comprising the step of calculating a plurality of performance metrics associated with the vision.

19. The method according to claim 18, wherein the plurality of performance metrics are calculated based on any one or a combination of the vision parameters and modified vision parameters associated with any one or a combination of (i) a distribution of ecosystems, (ii) a distribution of ecosystem modifiers, (iii) a distribution of ecosystem number of stories, (iv) a lifestyle selection, (v) a climate selection, and (vi) a precipitation event selection in thematic areas of (a) geography, (b) water, (c) carbon, (d) biodiversity and (e) population.

20. The method according to claim 18, wherein the plurality of performance metrics include one or more than one of a social metric, an economic metric, and a livability metric.

21. The method according to claim 1, further comprising the steps of:
saving any one or a combination of a distribution of ecosystems, a lifestyle, a climate, a precipitation event, performance metrics, and other user inputs (creator user name, vision name, vision date, identify of the original vision) associated with the modified geographic location;
retrieving any one or a combination of the distribution of ecosystems, lifestyle, climate, precipitation event, performance metrics, and other user inputs (creator user name, vision name, vision date, identify of the original vision) associated with the modified geographic location;
searching for visions by any one or a combination of the distribution of ecosystems, lifestyle, climate, precipitation event, performance metrics, and other user inputs (creator user name, vision name, vision date, identity of the predefined vision); and
displaying visions including any one or a combination of the distribution of ecosystems, lifestyle, climate, precipitation event, performance metrics, and other user inputs (creator user name, vision name, vision date, identify of the predefined vision).

22. The method according to claim 1, wherein the database of ecosystem and entity parameter data is delivered to a client web browser from one or more web servers.

23. The method according to claim 22, wherein an ecological performance model is delivered to the client web browser from one or more web servers.

24. The method according to claim 23, wherein the ecological performance model is comprised of JavaScript scripts, wherein the client web browser is comprised of a JavaScript-enabled web browser, and wherein the environmental performance indicator is calculated by the JavaScript-enabled web browser by executing the JavaScript scripts using the vision parameters of the defined user vision and using the database of ecosystem and entity parameter data delivered by the web server.

25. The method according to claim 23, wherein the ecological performance model is calculated at a server side machine by using the vision parameters of the defined user vision and by using the database of ecosystem and entity parameter data, and the calculated ecological performance model is delivered to the client web browser.

26. The method according to claim 1, wherein the database of ecosystem and entity parameter data combines a scientifically robust calculation of metrics given a unified set of natural ecosystems and anthropogenic ecosystems.

27. A system for developing a vision for a geographic location, comprising:
at least one database;
a graphical user interface; and
at least one processor coupled to a memory storing instructions, which, when executed by the at least one processor, cause the at least one processor to perform the steps according to claim 1.

28. A non-transitory computer-readable medium storing instructions,
which, when executed by a processor, cause the processor to perform the steps according to claim 1.
